(19) United States
(12) Patent Application Publication
(10) Pub. No.: US 2018/0204281 A1
(43) Pub. Date: Jul. 19, 2018

(54) Data Processing System and Method for Transaction Facilitation for Inventory Items

(71) Applicant: FAIR IP, LLC, Santa Monica, CA (US)

(72) Inventors: Scott Edward Painter, Los Angeles, CA (US); Craig Michael Nehamen, Sherman Oaks, CA (US); David Luan Nguyen, Playa Vista, CA (US); Serge Madenian, Northridge, CA (US); Ryan James Naughton, Santa Monica, CA (US); Mason Grey McLead, Redondo Beach, CA (US); Matthew Donavan Cragin, Los Angeles, CA (US); Gilad Ashpis, Playa del Rey, CA (US); Bowen Li, Redondo Beach, CA (US)

(21) Appl. No.: 15/873,536

(22) Filed: Jan. 17, 2018

Related U.S. Application Data
(60) Provisional application No. 62/596,007, filed on Dec. 7, 2017.
(60) Provisional application No. 62/447,349, filed on Jan. 17, 2017.
(60) Provisional application No. 62/447,353, filed on Jan. 17, 2017.
(60) Provisional application No. 62/447,355, filed on Jan. 17, 2017.
(60) Provisional application No. 62/447,357, filed on Jan. 17, 2017.
(60) Provisional application No. 62/447,362, filed on Jan. 17, 2017.
(60) Provisional application No. 62/447,365, filed on Jan. 17, 2017.
(60) Provisional application No. 62/447,366, filed on Jan. 17, 2017.

(51) Int. Cl. G06Q 40/02; G06Q 20/10; G06Q 20/40; G06Q 30/02; G06Q 30/06; G06F 15/18

(52) U.S. Cl. CPC G06Q 40/025; G06Q 20/102; G06F 15/18; G06Q 30/0206; G06Q 30/0641; G06Q 20/4014

(57) ABSTRACT

A system comprising a server coupled to a data store storing a set of approval rules, a set of APIs specifically configured for a plurality of remote information data provider systems. The system comprising a mobile device comprising the mobile application executable to provide a low friction user interface to allow a user to enter a limited amount of personally identifiable information and an image of an identification document, enhance the limited amount of personally identifiable information with personally identifiable information extracted from the identification document to create an enhanced set of personally identifiable information. The server configured to approve a user application based on the enhanced set of personally identifiable information and other application data received from the mobile application. The server and mobile application cooperating to allow the user to complete a transaction via the server based on the approval.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### RELATED APPLICATIONS

This application claims priority under 35 U.S.C. § 119(e) to U.S. Provisional Application No. 62/596,007, entitled “Data Processing System and Method for Managing Location Independent Transactions,” filed Dec. 7, 2017, U.S. Provisional Application No. 62/447,349, entitled “Networked Vehicle Data System,” filed Jan. 17, 2017, U.S. Provisional Application No. 62/447,353, entitled “System and Method For Low Friction Mobile Device User Interface,” filed Jan. 17, 2017; U.S. Provisional Application No. 62/447,355, entitled “Networked Computer System and Method for Rules/Model-Based Approval of a User to Participate in Transactions Using Distributed Information,” filed Jan. 17, 2017; U.S. Provisional Application No. 62/447,357, entitled “Computer System and Method for Electronic Documents/Agreements,” filed Jan. 17, 2017, U.S. Provisional Application No. 62/447,362, entitled “Networked Data System and Method for Filtering Electronic Records,” filed Jan. 17, 2017, U.S. Provisional Application No. 62/447,365, entitled “Computer System and Method for Rules/Model-Based Pre-Analysis of Data for Electronic Document Generation,” filed Jan. 17, 2017 and U.S. Provisional Application No. 62/447,366, entitled “Computer System and Method for Facilitating Transactions Using a Mobile Device,” filed Jan. 17, 2017, each of which is fully incorporated herein by reference for all purposes.

### TECHNICAL FIELD

The present disclosure relates generally to the field of managing transactions in distributed and networked computer systems. More particularly, embodiments relate the use of a networked computer system to facilitate transactions through a mobile device.

### BACKGROUND

In recent years, Internet-based systems and other computer systems that facilitate purchasing (buying or leasing) automobiles have become increasingly important tools for both consumers and dealers. For example, vehicle search services provided through the Internet have revolutionized the process of searching for a vehicle and dealer management systems (DMS) have transformed the management of finance, sales, parts, inventory and administration of other aspects of running a dealership. Despite the prevalence of these tools, the purchase process remains highly fractured.

The purchase process through a dealership typically involves several distinct steps including: i) vehicle search and selection, ii) a test drive, iii) price negotiation, iv) third party loan approval, v) selection of financing and insurance (F&I) options, vi) document generation and execution. In a typical scenario, a consumer looking to purchase a vehicle wanders dealer lots or uses disparate web sites provided by dealers and third parties to locate vehicles of interest. If the consumer chooses to finance the vehicle, the consumer may also go to a bank or use the bank's web site to apply for a loan. In addition or in the alternative, the consumer may choose to finance the vehicle through a loan process facilitated by the dealer's sales desk or F&I department, in which case the dealer will interact with one or more loan providers to submit loan applications for the consumer.

When the consumer finds a vehicle of interest, the consumer may schedule a test drive with the dealership and, if the consumer chooses to purchase the vehicle, negotiate a price with the dealer. In some cases, technology may facilitate the negotiation. For example, several third-party vehicle search sites are available that allow consumers to research market prices. This can give the consumer confidence walking into the dealership, but serves largely as a negotiation tool. The negotiated price still relies on back and forth negotiation until, optimally, both the consumer and dealer reach the subjective belief that they came to a fair deal.

After negotiating a price with the salesperson, the consumer then goes to the F&I office to workout payment through cash, a loan arranged by the consumer or a loan arranged through the sales desk or F&I office. Prior to finalizing the deal, the F&I office typically tries to sell the consumer additional options such as warranties, paint protection packages, VIN etching or other “insurance” products. This may be the most confusing part for the consumer as the consumer must quickly balance the risk of damage, theft or malfunction with the price of the product being offered.

After the consumer selects the F&I products, the F&I employee enters the final data in the dealer management system. This may require entering information received from the salesperson, consumer, or financial institution and, some cases, reentering information already entered in other systems. Based on these inputs, the dealer management system generates and prints the relevant documents for signature. Often, this is the first time the consumer sees the final contract terms and price, which often includes additional fees, such as document fees or other dealer added fees. Thus, conventional systems are dealer-centric because documents are generated and controlled by a dealer management system (DMS) controlled by the dealer and to which the customer has no access.

Despite the high information disadvantage faced by consumers, consumers often give the documents presented by a dealer little more than a cursory review because it is difficult for consumers to back out of the deal at this point due to the high transaction costs. For example, if a consumer decides to cancel a deal after all the documents are finalized, the consumer must go back and repeat the vehicle selection, negotiation, selection of F&I options and, in some cases, the third party loan approval process. These costs are exacerbated if the consumer elects to go to another dealership.

The high transaction costs result in part from the fragmented and incomplete technologies used in the vehicle purchase process. Typically, the consumer must use one system to search for inventory and then another system to request a loan. There is often limited or no coordination between these systems and the consumer may have to setup separate accounts with the systems, provide duplicative information and interact with the systems through different web sites or mobile apps. Furthermore, the dealer may track or otherwise manage sales, finance, parts, service, inventory and back office administration using a dealer management system that has little or no interaction with the inventory search systems or the loan provider systems. Consequently, the consumer must provide duplicative information to the dealer for the dealer to enter into the DMS. Moreover, the consumer or dealer may have to coordinate with a loan provider so that the dealer can enter loan information. Thus, there are significant breaks in data flow that can lead to errors and substantial data duplication. Furthermore, the breaks in dataflow and control of documents by the dealer's system make it difficult, if not impossible, for a consumer to review documents prior agreeing to final terms.

Moreover, because online financial transactions are not face-to-face, online loan applications often have numerous fields for personally identifiable information that the loan provider can use for determining credit worthiness and the loan amount/terms. Consequently, such forms are typically browser-based forms designed for desktop and laptop computers. While smart phones support browsers, it is a tedious and error prone process to fill out the forms on a smart phone screen. Moreover, because of the significant amount of time it takes to approve conventional loans, the approval process does not occur in the context of a single session and, instead, requires the user to log into the loan provider's web site multiple times.

### SUMMARY

One embodiment comprises a networked system comprising a server computer coupled to a network. The server computer comprises a processor and set of computer instructions stored on a non-transitory computer readable medium. The server computer is coupled to a data store storing a set of approval rules, a set of application programming interfaces (APIs) specifically configured for a set of remote information provider systems and a set of vehicle inventory records for a plurality of vehicles, each vehicle inventory record comprising a pre-calculated payment schedule associated with a corresponding vehicle from the plurality of vehicles.

The set of computer instructions can be executable to retrieve information provider data from a the set of information provider systems using the APIs and based on an enhanced set of personally identifiable information about a user included in application data received from a mobile application. Further, based on the application data, information provider data and approval rules, the server can determine an affordability score representative of a periodic payment for which the user is approved, determine eligible vehicles for the user, the eligible vehicles having a payment schedule with periodic payments that are less than the affordability score, and return a list of eligible vehicles to the mobile application.

The server can receive, from the mobile application, an indication of a purchase decision with respect to a selected vehicle from the eligible vehicles and provide, via a dealer portal for a dealer associated with the selected vehicle, access to an order corresponding to the purchase decision, the order comprising vehicle information for the selected vehicle and consumer information, the dealer portal configured to allow the dealer to update order data.

The server can automatically generate an electronic document for electronic execution, the electronic document comprising the updated order data, and send the electronic document to the mobile application,

The server can receive an electronic signature from the mobile application and based on receiving the electronic signature from the mobile application, initiating an electronic transfer of funds.

The system can also comprise mobile device having a mobile application executable to provide a low friction user interface to allow a user to input an image of an identification document and a limited set of personally identifiable information and financial information. The mobile application can be configured to enhance the limited set of personally identifiable information with personally identifiable information extracted from the image of the identification document to create an enhanced set of personally identifiable information. The mobile application can send the enhanced set of personally identifiable information and financial information to the server.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a high level block diagram of one embodiment of a network topology.

FIG. 2 is a block diagram of one embodiment of a software architecture of an automotive data processing system.

FIG. 3 is a flow chart of one embodiment of a method corresponding to a user application stage.

FIGS. 4A, FIG. 4B, FIG. 4C, FIG. 4D, FIG. 4E, FIG. 4F, FIG. 4G, FIG. 4H and FIG. 4I depict one embodiment of a series of mobile application pages that may be displayed in a user application stage.

FIG. 5 is a block diagram illustrating one embodiment of a process to approve a user application.

FIG. 6 is a flow chart illustrating one embodiment of a fraud detection and identity verification process.

FIG. 7 is a flow chart illustrating one embodiment of a credit check process.

FIG. 8 is a flow chart illustrating one embodiment of an income verification process.

FIG. 9A and FIG. 9B are flow charts illustrating another embodiment of an income verification process.

FIG. 10 is a flow chart illustrating one embodiment of an affordability determination.

FIG. 11 depicts rules for determining a monthly debt obligation from a credit report.

FIG. 12 is a diagrammatic representation of a set of decisions and prediction models according to one embodiment.

FIG. 13 is a block diagram illustrating one embodiment of inventory processing.

FIG. 14 is a block diagram of one embodiment of a process for developing a pricing model and depreciation models.

FIG. 15 is a flow chart illustrating one embodiment of determining payment schedules for a vehicle.

FIG. 16 is a flow chart illustrating one embodiment of performing a transaction.

FIG. 17A, FIG. 17B, FIG. 17C, FIG. 17D, FIG. 17E, FIG. 17F, FIG. 17G, FIG. 17H, FIG. 17I, FIG. 17J, FIG. 17K, FIG. 17L, FIG. 17P, FIG. 17Q, FIG. 17R, FIG. 17S, FIG. 17T illustrate one embodiment of a series of mobile application pages corresponding to a purchase process and FIG. 17M, FIG. 17N and FIG. 17O illustrate example dealer portal pages corresponding to a purchase transaction.

FIG. 18A, FIG. 18B, FIG. 18C, FIG. 18D, and FIG. 18E illustrate one embodiment of a structured document containing order data that can be transformed into a contract.

FIG. 19 is a flow chart illustrating another embodiment of performing a transaction.

FIG. 20 illustrates one embodiment of a mobile application page presenting an activation code.

FIG. 21 depicts a diagrammatic representation of a distributed network computing environment.

### DETAILED DESCRIPTION

The invention and various features and advantageous details thereof are explained more fully with reference to the exemplary, and therefore non-limiting, embodiments illustrated in the accompanying drawings and detailed in the following description and appendices. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

The present disclosure relates in general to a comprehensive rules/model-based data processing system for automating and facilitating a purchase process, including financing qualification, inventory selection and document generation. In an example embodiment, a networked computer system is provided which allows a consumer user to submit a limited set of consumer information. The computer system can leverage a variety of distributed data systems to enhance the consumer information and apply rules specific to the data obtained from the data systems and processed data generated from the obtained data to determine or verify a user's income and ability to pay an obligation with a high degree of certainty, very quickly (e.g., within five minutes, in some cases in less than a minute and, even more preferably, in less than ten seconds from a request to approve an application). The process of financing approval therefore can be achieved through a simple interface on a mobile device and, in some embodiments, in a single client session in real-time.

The computer system provides a program pool of vehicles that reduces the large number of vehicles that a consumer must typically search through to vehicles that are fairly priced. According to one aspect of the present disclosure, the computer system receives inventory records from remote sources, enhances the inventory records with information from other, distributed sources, and applies “fair value” rules to the inventory records to filter the inventory items down to a program pool of inventory items that have a “fair value” based on the fair value rules. In accordance with one embodiment, the fair value rules are selected such that each inventory item (e.g., vehicle) in the program pool is priced close to its wholesale value or other value at the time of sale and can be accurately and competitively priced based on selected metrics.

The computer system applies pricing rules/models (including, in some embodiments, machine learning models) to the program pool of inventory records to accurately determine an initial payment and monthly (or other periodic) payments for each inventory item. The payments may be selected to meet particular metrics. In one embodiment, the computer system determines a plurality of payment schedules for an inventory item corresponding to different combinations of values of application, order or other parameters. As one example, the computer system can be configured to determine prices for various combinations credit risk, usage and option parameter values. The payments for an inventory item can be pre-calculated before an inventory item is presented to a consumer making the system more efficient, particularly over a large number of inventory records.

The pricing rules/models may be selected to facilitate a new type of ownership, referred to herein as “micro-ownership,” that allows the consumer the flexibility to walk away from the purchase after a short period of time or no time at all. As such, an ownership agreement can be structured to allow the consumer to return the vehicle at any time in a return period (within limits). The return period may be limited by one, all or neither of a minimum term, maximum term or a termination date. The micro-owner may thus own the vehicle on essentially a month-to-month basis with the ability to return the vehicle at any time in the return period (which may be unlimited if the consumer continues to make payments).

The inventory items made available for selection by the user in the client application may be specifically curated for that user by the computer system based on the user's ability to afford the inventory items. As noted above, the computer system can pre-calculate the payment schedules for each inventory item and independently “pre-approve” financing for the consumer. The computer can thus limit the inventory items presented to the user based on the user's approved payment amount.

When a user selects a vehicle via a client application, the computer system may thus already have the payment information for an inventory item, consumer information, and seller information. In accordance with some embodiments, the computer system may provide the consumer with independent access to view a set the documents associated with purchasing an inventory item. The computer system can automatically generate previews of the purchase documents as the purchase process progresses, generate final purchase documents and provide the purchase documents (e.g., ownership agreement, registration form, liability release of seller) to the user for digital execution.

Thus, the computer system can pre-calculate the initial payment and monthly payments for each inventory item and may curate a set of inventory items for presentation to the user for purchase. Furthermore, the computer system may “pre-approve” financing for the consumer (e.g., up to $X amount per month or $Y amount total). The computer system can further automatically generate purchase documents and provide the consumer with access to documents the consumer will sign when he or she goes to purchase a vehicle (e.g., ownership agreement, registration form, liability release of dealer). In this way, there can be both “pre-approval” for financing and documents generated in real-time as requested by the consumer. According to one embodiment, the consumer has no need to sign any paper forms at the seller's place of business. In the context of an automobile purchase, this can remove the wait for the F&I office to prepare documents that can often take hours and as well remove the need for the consumer to store any physical forms. Consequently, the consumer, prior to going to the seller, can be familiar with the documents that he or she is going to execute. As such, the consumer may have greater confidence that the purchase is above board.

The computer system may provide a seller portal (e.g., a dealer portal) to allow a seller to enter information associated with orders. The dealer portal may be connected to the client application via a server such that changes to an order through the dealer portal or client application can be synchronized by the computer system.

According to one embodiment, the computer system may provide the consumer with an activation code that is associated with a consumer profile and can be used by the dealer to initiate a transaction. The consumer or the computer system can provide the activation code to the dealer and the dealer can use the dealer portal to enter the activation code, information about a vehicle-of-interest, dealer bank account information or other information. Based on the activation code, the computer system can provide the dealer with access to the consumer profile associated with the activation code to view information about the consumer, such as compliant personally identifiable information, a copy of the consumer's driver's license or a picture of the consumer, and financing information (e.g., approval amount). Furthermore, the dealer may also access, via the dealer portal, a set of documents associated with the transaction and finalize any additional items required for finalization, like vehicle odometer at the moment of sale.

When a user approves an order (e.g., after reviewing one or more versions of an “order review” interface), the computer system can generate a final copy of the ownership agreement and other documents associated with the order and push the document(s) to the client application for signature on a client computing device (e.g., a mobile device). Upon receiving a digital signature by the consumer, the computer system can interact with the consumer's bank's computer system to withdraw an initial payment from the consumer's bank account and transfer funds to purchase the vehicle from the financing provider's bank to the seller's bank.

As discussed above, the rules/models based data processing system may apply approval rules/models to approve a user application and determine an affordability score for the user and independently apply pricing rules/models to determine payment schedules for inventory items. The approval rules/models and payment rules/models are configured so that the computer system can automatically generate affordability scores and payment schedules. The affordability scores and payment schedules can then be used in a search process to identify vehicles that the user is eligible purchase. Furthermore, the application process can collect information about the user which can be combined with vehicle information, including a pre-calculated payment schedule, to automatically generate documents. The rules/model-based data processing system can eliminate many of the complications and delays of previous solutions by providing an interoperable system that approves financing, determines vehicle payment schedules, searches inventory and automatically generates documents.

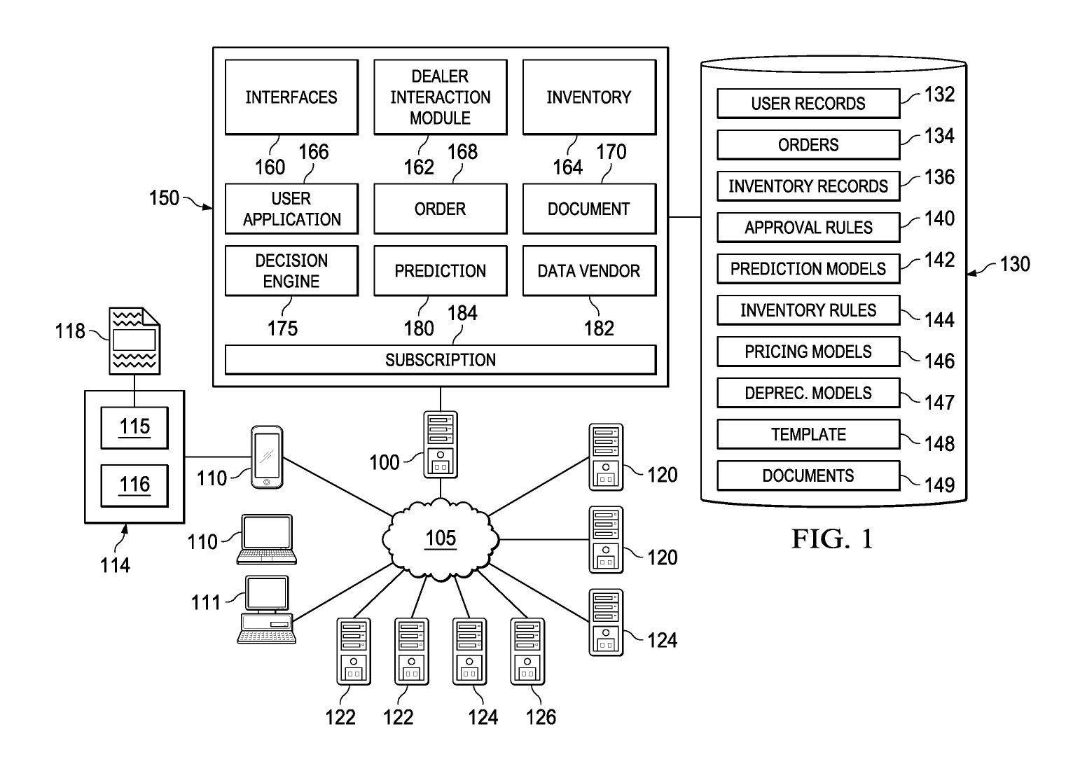

Embodiments of a system for facilitating transactions may be implemented in a network topology. FIG. 1 is a high level block diagram of one embodiment of an example topology. The network topology of FIG. 1 comprises an automotive data processing system 100 which is coupled through network 105 to client computing devices 110 (e.g. computer systems, personal data assistants, smart phones or other client computing devices). The topology of FIG. 1 further includes one or more information provider systems 120, one or more dealer management systems (DMS) 122, inventory systems 124, department of motor vehicles (DMV) systems 126 or other systems. Network 105 may be, for example, a wireless or wireline communication network such as the Internet or wide area network (WAN), publicly switched telephone network (PSTN) or any other type of communication link.

In accordance with one aspect of the present disclosure, automotive data processing system 100 provides a comprehensive computer system for automating and facilitating a purchase process including financing qualification, inventory selection, document generation and transaction finalization. Using a client application 114 executing on a client device 110, a consumer user may apply for financing, search dealer inventory, select a vehicle of interest from a dealer and review and execute documents related to the purchase of the vehicle, and execute automated clearing housing (ACH) transactions through automotive data processing system 100 to purchase the vehicle from the dealership. The automotive data processing system 100 may initiate the consumer's fee payments through various payment methods. Automotive data processing system 100 may be provided by or behalf of an intermediary that finances the purchase of a vehicle by a consumer from the dealer. In this context, a “consumer”, is any individual, group of individuals, or business entity seeking to purchase a vehicle (or other asset) via the system 100.

Turning briefly to the various other entities in the topology FIG. 1, dealers may use a dealer management system (“DMS”) 122 to track or otherwise manage sales, finance, parts, service, inventory and back office administration needs. Since many DMS 122 are Active Server Pages (ASP) based, data may be obtained directly from a DMS 122 with a “key” (for example, an ID and Password with set permissions within the DMS 122) that enables data to be retrieved from the DMS 122. Many dealers may also have one or more web sites which may be accessed over network 105, where inventory and pricing data may be presented on those web sites.

Inventory systems 124 may be systems of, for example, one or more inventory polling companies, inventory management companies or listing aggregators which may obtain and store inventory data from one or more of dealers (for example, obtaining such data from DMS 122). Inventory polling companies are typically commissioned by the dealer to pull data from a DMS 122 and format the data for use on web sites and by other systems.

DMV systems 126 may collectively include systems for any type of government entity to which a user provides data related to a vehicle. For example, when a user purchases a vehicle it must be registered with the state (for example, DMV, Secretary of State, etc.) for tax and titling purposes. This data typically includes vehicle features (for example, model year, make, model, mileage, etc.) and sales transaction prices for tax purposes. Additionally, DMVs may maintain tax records of used vehicle transactions, inspection, mileages, etc.).

Information provider systems 120 may be systems of entities that provide information used in approving a user or purchase. Examples of information provider systems 120 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 120 may comprise any number of other various sources accessible over network 105, which may provide other types of desired data, for example, data used in identity verification, fraud detection, credit checks, credit risk predictions, income predictions, affordability determinations, residual value determinations or other processes.

Automotive data processing system 100 may comprise one or more computer systems with central processing units executing instructions embodied on one or more computer readable media where the instructions are configured to perform at least some of the functionality associated with embodiments of the present invention. These applications may include a vehicle data application 150 comprising one or more applications (instructions embodied on a computer readable media) configured to implement one or more interfaces 160 utilized by the automotive data processing system 100 to gather data from or provide data to client computing devices 110, information provider systems 120, DMS 122, inventory systems 124, DMV systems 126 and processing modules to process information.

Automotive data processing system 100 utilizes interfaces 160 configured to, for example, receive and respond to queries from users at client computing devices 110 interface with information provider systems 120, DMS 122, inventory systems 124, DMV systems 126, obtain data from or provide data obtained, or determined by automotive data processing system 100 to any of information provider systems 120, DMS 122, inventory systems 124, DMV systems 126. It will be understood that the particular interface 160 utilized in a given context may depend on the functionality being implemented by automotive data processing system 100, the type of network 105 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Vehicle data application 150 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, vehicle data application 150 includes a dealer interaction module 162 which can provide a service to allow dealers to register with automotive data processing system 100 to allow vehicles to be purchased through automotive data processing system 100. To onboard a dealer, a dealer account may be established at automotive data processing system 100. Various pieces of information may be associated with the dealer account. Once a dealer is on-boarded, dealer interaction module 162 may provide a dealer portal (e.g., a web site, web service) through which the dealer may access and update information for transactions using, for example, a browser at a dealer client computer 111. The dealer portal may also include a history of previously completed deals and other information.

As part of onboarding, automotive data processing system 100 can be provided with credentials or other information to allow automotive data processing system 100 to access dealer inventory information from the dealer's DMS 122 or an inventory system 124. In addition or in the alternative other channels may be established to retrieve inventory information (e.g., email, FTP upload or other channel).

The dealer may provide any forms that are required during a sales transaction. For example, state DMVs often mandate specific disclosures and some dealers have their own required disclosure documents that go beyond what is required by the government. The dealer may also provide bank account information to allow funds to be transferred to the dealer to purchase vehicles.

Inventory module 164 receives inventory feeds from remote sources via the channels established with the dealers, enhances the inventory records with information from other, distributed sources, and applies inventory rules 144 to the inventory records to filter the inventory items down to a program pool of inventory items that have a fair value (in this context, whether an inventory item has a “fair value” is objectively determined based on the rules applied). In accordance with one embodiment, the rules are selected such that each inventory item (e.g., vehicle) in the program pool is priced close to its wholesale value, current market value or other value at the time of sale and can be accurately and competitively priced based on selected metrics.

Inventory rules 144 may further include rules for pricing vehicles based, for example, on a pricing model 146. Automotive data processing system 100 uses the model, or, more particularly, depreciation models 147 derived from the model 146, to accurately determine an initial payment and monthly (or other periodic) payments for each inventory item. The payments may be selected to meet particular metrics. As discussed below, the payments for each vehicle may include payments to cover the modeled depreciation of the vehicle in addition to other products.

In some embodiments, system 100 may determine an array of payments for each vehicle, the array containing payments for multiple mileage and credit risk bands. Inventory module 164 may store an inventory record 136 for each vehicle in the vehicle pool, the inventory records containing data obtained from inventory feeds, enhanced data from information provider systems 120 and payment schedules. Inventory module 164 may further search inventory records 136 in response to search criteria received from client application 114 or other modules and returns responsive results.

User application module 166 is configured to interact with consumer users accessing system 100 via client applications 114 to obtain appropriate input information from the users to populate user applications for financing. User application module 166 further manages the user applications through an application approval lifecycle. Applications may be persisted as application records (user records) 132.

A decision engine 175 applies approval rules 140 to user application data provided by user application module 166 to approve or deny the application. Examples of approval rules 140 include, but are not limited to, fraud detection rules, identity verification rules, credit check rules, income verification rules and affordability rules. If an application is not approved, decision engine 175 may return the reason that the application was not approved. A failure to pass the approval rules may result in any configured action, such as withholding further information or services from the consumer, requesting the consumer re-enter information or provide additional information, and/or alerting an authority that of the failed check. If an application is approved, the decision engine may return one or more scores including, for example, an affordability score and a credit risk score, which can be added to the application for the user. The scores may be automatically used as search criteria for searching inventory records 136.

The application of approval rules 140 or other processes may leverage predictions. Prediction module 180 can apply prediction models 142 to data associated with the user application to generate prediction scores that may be used in processing the approval rules 140 or to enhance an application. By way of example, but not limitation, automotive data processing system 100 may apply an income prediction model to generate a prediction of a user's income that can be used by an affordability rule to determine an affordability score for the user. As another example, automotive data processing system 100 may apply a credit risk prediction model to generate a credit risk score for a consumer.

Approval rules 140 and prediction models 142 may require obtaining information from a number of third party distributed systems. As an example, application of an identity verification rule may require gathering information from an identity verification service provided by an information provider system 120. As another example, an income prediction model may require interacting with the computer systems of the user's bank to verify the consumer's current and recent income, as well as other relevant banking data.

Based at least in part on some of the user application data, a data vendor module 182 may perform interaction with one or more third party sources to obtain various types of information used in applying approval rules 140 and prediction models 142. For example, data vendor module 182 may interact, via appropriate APIs, with information provider systems 120 to collect fraud detection data, identity verification data, credit reports, income estimation data, income projection data and other data.

Order module 168 is configured to interact with consumer users accessing system 100 via client applications 114. Order module 168 is configured to obtain appropriate input information from the users, e.g., via one or more interactive GUIs, other modules or third party systems to populate order profiles and orders that contain data for purchase decisions. Order module 168 may further interact with the dealer portals to alert dealers of orders involving that dealer and allow dealers to update and approve orders. Order module 168 can manage the user orders 134 through an order lifecycle. Orders 134 may be persisted as records in data store 130.

A document module 170 can receive order data from order module 168. Document module 170 may access a template of a contract from a library of templates 148, generate an HTML, PDF or other version of the contract by populating the template with data from the order and return the generated contract to the order module 168. The generated document can be provided to client application 114 to allow the user to preview a contract or execute a finalized contract. Automotive data processing system 100 may also maintain a library of other documents 149, such as wear and tear contracts, warranty information, insurance policy documents that may be returned to a user.

System 100 can store or generate documents that may be required by the intermediary, dealers, governmental organizations or others during the purchase process. Consequently, a consumer can review digital copies of, for example, an ownership agreement and any other ancillary documents that the consumer will likely have to execute in the purchase process. In some cases, some of the documents may be dealer specific or may be optional and may only become available to the consumer after he or she has selected a vehicle of interest or specific F&I options. In any case, in some embodiments, the consumer, prior to the consumer going to the dealership, may review, on his or her client computing device 110, all or a selected portion of the documents that will or may require execution.

System 100 and mobile application 114 may cooperate to present a list of vehicles to the consumer based on the payments determined for the vehicles, the consumer's affordability score as well as filter criteria provided by the user and vehicle payment parameters provided by the consumer or determined by system 100, while excluding vehicles that do not fit these criteria.

Subscription module 184 may receive a payment schedules and financial information from orders and interact with financial institutions to execute the payment schedules.

Furthermore, automotive data processing system 100 may include data store 130 operable to store obtained data, processed data determined during operation and rules/models that may be applied to obtained data or processed data to generate further processed data. In one embodiment, automotive data processing system 100 maintains user applications, orders and inventory objects. Further, in the embodiment illustrated, data store 130 is configured to store rules/models used to analyze application data, order data and inventory data, such as application approval rules 140, inventory rules 144, prediction models 142, pricing models 146. Data store 130 may comprise one or more databases, file systems or other data stores, including distributed data stores managed by automotive data processing system 100.

Client computing devices 110, 111 may comprise one or more computer systems with central processing units executing instructions embodied on one or more computer readable media where the instructions are configured to interface with automotive data processing system 100. A client computing device 110, 111 may comprise, for example, a desktop, laptop, smart phone or other device. According to one embodiment, a client computing device 110 is a mobile device that has a touchscreen display and relies on a virtual keyboard for user data input. Client application 114 may be a mobile application (“mobile app”) that runs in a mobile operating system (e.g., Android OS, iOS), and is specifically configured to interface with automotive data processing system 100 to generate application pages for display to a user. In another embodiment, the client application 114 may be a web browser on a desktop computer or mobile device. A client computing device 111 may run an application through which a dealer portal can be accessed.

In accordance with one embodiment, a user can utilize client application 114 to register with automotive data processing system 100, apply for financing, view inventory, select a vehicle, review documents and finalize a sales transaction through a low friction mobile app running on a smart phone. Client application 114 can be configured with an interface module 115 to communicate data to/from automotive data processing system 100 and generate a user interface for inputting one or more pieces of information or displaying information received from automotive data processing system 100. In some embodiments, the application 114 may comprise a set of application pages through which application 114 collects information from the user or which client application 114 populates with data provided via an interface 160.

Any type of information may be received from the consumer user in accordance with embodiments of the present disclosure, including consumer information, (such as personally identifiable information (PII) and financial information for that user), order parameters, such as vehicle features (such as the make, model, year, mileage, trim, or other characteristics of a specific vehicle or group of vehicles in which the consumer is interested) and order payment parameters (other parameters that affect the monthly payment, such selections of additional products, an indication of expected usage or other parameters) or other information.

As discussed above, a user may apply for financing via client application 114. To this end, client application 114 may be configured with a series of application pages configured to collect user application data and display user application data. The data may be maintained at the client device 110 in a local representation of a user application 118 (a data structure configured to hold user application data). The local representation 118 may include application data to be sent to automotive data processing system 100 or received from automotive data processing system 100.

Client application 114 can be configured to request a minimum amount of user identification information and financial information from a consumer to allow automotive data processing system 100 to make a determination of whether the user is approved to purchase a vehicle and the vehicles for which the user is approved. Preferably the mobile application pages are configured to minimize the number of fields that the user must populate for an approval determination to be made. The user supplied user identification information can be used to obtain additional consumer information from a variety of information provider systems 120.

Information provided by the user can correlated with information from various databases (e.g., credit reporting agencies, financial institutions) to build profile of customer. Client application 114 or data application 150 can, for example, receive a first, limited set of user record information from a first source (e.g., from the user), correlate the user record information with additional PII and accounting information from additional sources and use the additional PII and accounting information to enhance the user record (e.g., to produce an enhanced user record). The system may use the information from the (enhanced) user record to approve financing.

In one embodiment, an application page of mobile application 114 is configured to allow a user to input an image of an identification document for the user. Client application 114 may access a mobile device's picture roll or include an imaging module 116 that can access a camera of the client computing device 110 (for example, a smart phone camera) to take an image of a user identification document (for example, a scan or photograph of a driver's license, passport or other user identification document). The image of the user identification document is used to obtain PII for the user using an internal library or a remote information provider system 120. Automotive data processing system 100 may use the PII input directly by the user, obtained using the user identification document image, or otherwise obtained to obtained additional consumer information, including financial information, associated with the consumer from information provider systems 120.

If the user application is approved, system 100 and mobile application 114 may cooperate to present a list of vehicles to the consumer based on the payments determined for the vehicles, the consumer's affordability score as well as filter criteria provided by the user and order payment parameters provided by the consumer or determined by system 100, while excluding vehicles that do not fit these criteria.

In response to a selection of a vehicle from the list, mobile application 114 and system 100 may cooperate to present additional details of a vehicle to the user. In some embodiments, system 100 may provide the array of payments associated with the vehicle to mobile application 114. Mobile application can be configured to display a default payment as well as provide payment parameter controls to adjust order payment parameters. Responsive to user input using the payment parameter controls, the mobile application can update the payment displayed. In this example, the mobile application does not have to request additional data from system 100 to update the displayed payment in response to the inputs because the payment array is resident at mobile application 114. Thus, the number of network calls can be reduced compared to web based systems that required a browser to call back to the server each time a user adjusted some parameter that affected payment. In other embodiments, the mobile application may call back to system 100 to receive an updated payment amount each time the user adjusts a payment parameter.

When the user is satisfied with his/her selections, the user can select to complete an order via mobile application 114. Prior to finalizing the order, the system 100 may use consumer information to conduct an additional credit check. A failure to pass the credit check may result in any configured action, such as withholding further information or services from the consumer, requesting the consumer re-enter information or provide additional information, and/or alerting an authority that of the failed identification verification.

System 100 can notify the dealer selling the vehicle subject to an order of the order and the dealer can access the order via a dealer portal for review. The dealer may be required to add additional information to the order, such as current odometer reading. System 100 electronically generates the purchase contract for and sends the purchase contract to mobile application 114 for electronic signature by the user.

It should be noted here that not all of the various entities depicted in the topology are necessary, or even desired, in embodiments of the present invention, and that certain of the functionality described with respect to the entities depicted FIG. 1 may be combined into a single entity or eliminated altogether. Additionally, in some embodiments other data sources not shown in FIG. 1 may be utilized. FIG. 1 is therefore exemplary only and should in no way be taken as imposing any limitations on embodiments of the present invention.

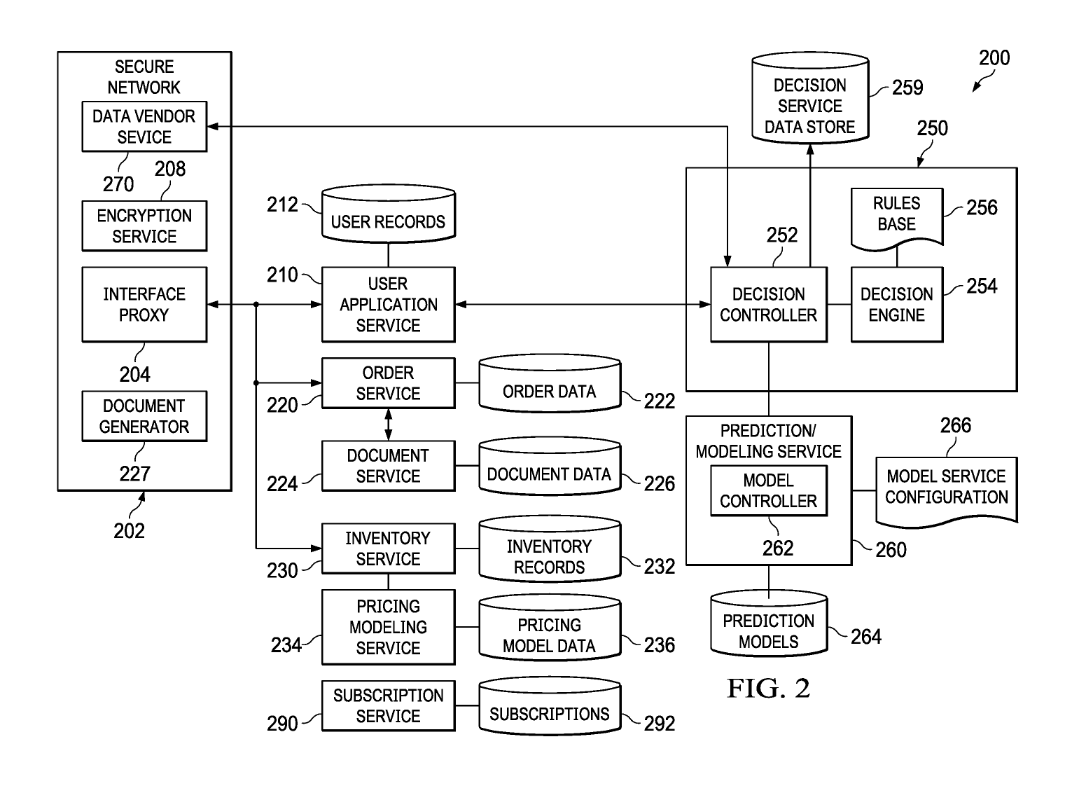

According to one embodiment, various modules discussed above can be implemented as a set of services at one or more servers. FIG. 2 is a block diagram of one embodiment of a software architecture of an automotive data processing system such as automotive data processing system 100. In the illustrated embodiment, the software architecture 200 comprises a number of services (which may be independently executing services) including secure network services 202, a user application service 210, an order service 220, an inventory service 230, a document service 224, a decision service 250, a prediction and modeling service 260, a price modeling service 234, a data vendor service 270 and a subscription service 290. Each of user application service 210, decision service 250, prediction and modeling service 260, price modeling service 234, order service 220, inventory service 230, document service 224, data vendor service 270 and subscription service 290 may also include interfaces, such as APIs or other interface, so that other services can send calls and data to and receive data from that service.

The services may utilize various data stores operable to store obtained data, processed data determined during operation, rules/models that may be applied to obtained data or processed data to generate further processed data and other information used by the services. In the embodiment illustrated user application service 210 stores user application records in user application service store 212, decision service 250 stores data in data store 259, order service 220 stores order data in order service data store 222, document service utilizes data stored in document service data store 226, inventory service 230 stores inventory records in inventory service data store 232, price modeling service 234 uses price model data in data store 236, predication and modeling service 260 and uses prediction models stored in data store 264. The various services may utilize independent data stores such the data store of each service is not accessible by the other services. For example, each of user application service 210, decision service 250, order service 220, inventory service 230, document service 224, price modeling service 234 and prediction and modeling service 260 may have its own associated database.

Secure network services 202 include interfaces to interface with client computing devices and information provider systems 120. The interfaces can be configured to, for example, receive and respond to queries from users at client computing devices, interface with information provider systems 120, obtain data from or provide data obtained, or determined by architecture 200 to client computing devices or information provider systems. It will be understood that the particular interface utilized in a given context may depend on the functionality being implemented, the type of network utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context. Secure network services 202 provide a walled off segment of the system the system. Certain unencrypted information, such as PII, is not available to other components of the software architecture outside of secure network services 202.

In the embodiment illustrated, secure network services 202 include an interface proxy service 204 that receives calls and data from client applications (e.g., client application 114 or web browser accessing a dealer portal) or services of architecture 200, routes calls and data to the services of architecture 200 and routes responses to the client application or calling service as appropriate. Interface proxy service 204 can provide authentication services, assigning unique user ids to new users, authenticating users when they log back in to automotive data processing system 100 and providing other functionality. Once a user has authenticated, interface proxy service 204 can provide context (such as a user id) that can be passed with requests to other services.

Secure network services may also include data vendor service 270 configured to communicate with information provider systems 120 to request information from the information provider systems 120. For example, data vendor service 270 may include APIs for services at information provider systems 120, such as 3rd party services, that provide data incorporated in decisions. Data vendor service 270 may include APIs dedicated to each information provider system 120.

Encryption services 208 are provided to internally encrypt/decrypt sensitive information, such as personally identifiable information (PII), and other information received via data vendor service 270 and interface proxy service 204.

At least some data communicated between automotive data processing system 100 and a client computing device may be encrypted beyond encryption generally used to encrypt communications (such as HTTPs). For example, PII provided by a client application (e.g., mobile application 114) may be encrypted according to a first encryption protocol. Interface proxy service 204 may forward the encrypted PII for use by other services, such as user application service 210, which cannot decrypt the information.

Information provider systems 120 may require PII to return information about a consumer (e.g., the API for a credit reporting agency information provider systems 120 may require inputting a name, address, social security number or other PII to receive a credit report). When data vendor service 270 receives encrypted PII from another service to send to an information provider system 120, data vendor service 270 can call encryption service 208 to decrypt the PII from the internal format and then data vendor service 270 can then encrypt the PII in the encryption format used for the API call to information provider system 120. Similarly if PII is received from information provider system 120 via data vendor service 270, data vendor service 270 can decrypt the PII according to the encryption/decryption used by the particular data vendor, call encryption services 208 to encrypt the PII according to the internal format and forward the encrypted PII to another service. Thus, PII is highly secure because, in some embodiments, it is only ever decrypted at secure network services 202 to be re-encrypted for forwarding to other services.

Interface proxy service 204 and data vendor service 270 may thus be configured with rules regarding which PII is to be encrypted by encryption service 208. Examples of information that can be considered PII based on the rules includes, but is not limited to: first name, last name, middle name, date of birth, email address, government id numbers (social security numbers, driver's license number), address, driver's license bar code scan, driver's license image, phone numbers, signature, insurance card information, bank account number, bank account name, bank account balance, employment information or other information. In some embodiments, the rules will specify which fields of data in an input from a client application or response from an information provider system 120 are to be internally encrypted according to the internal encryption format.

User application service 210 is configured to receive user requests to register with the data processing system, manage user applications and communicate with client applications regarding user applications for approval. In particular, user application service 210 can receive requests to apply for financing along with associated consumer data.

According to one embodiment, a request to initiate an application along with registration information (e.g., an email address) is received via an API call to interface proxy service 204 from client application 114. Interface proxy service 204 route the call and consumer data (for example, including the encrypted PII) to user application service 210. User application service 210 creates a user application having a unique application id for the user. User application service 210 returns the application id to client application 114 (via interface proxy service 204) for use in future communication regarding the application.

The user application may be managed as an object that proceeds through multiple states. The user application may be persisted in user application service data store 212 as a user application record, which may be one example of a user record 132. User application service 210 can further receive additional consumer information from client application 114 and enhance the user application record.

In an exemplary embodiment, user application service 210 is configured to receive an API request routed by interface proxy service 204 for an approval decision for a user application. User application service 210 generates a decision request to decision service 250 requesting a pre-approval decision and provides the decision input attributes required for a decision. User application service 210 is configured to receive a decision result from decision service 250 and generate a response to client application 114. User application service 210 may also take other specified actions based on the decision result. When a user application is approved, user application 210 may pass context information to order service 220. Such context information may include, for example, consumer PII, user id, application id, an affordability score, a credit risk score or other information used by order service 220.

As consumers search and view vehicles, order service 220 maintains order profiles for the users containing order context information. An order profile can contain information about a consumer (consumer context data received from user application service 210) and vehicle context data (data about a vehicle currently being viewed). Order service 220 can receive requests to search or view vehicles, add consumer context to the request and forward the request to inventory service 230 to search inventory records. When a user selects to view a vehicle, order service 220 can maintain a record of the vehicle viewed to allow order service 230 to send requests to document service 224 to generate previews of contracts and other documents.

Order service may manage order profiles that hold information about consumers and any vehicle the consumer has selected view. According to one embodiment, when a user application is approved, order service 220 receives consumer context information from user application service 210 and creates an order profile. Further, when a user selects particular vehicles to view, order service 220 receives the vehicle information from inventory service 230. When a user indicates that he/she wishes to finalize a purchase, inventory service 230 can create an order, which may be managed as an object that proceeds through multiple states and may be persisted in order service data store 222.

Document service 224 is configured to generate previews of documents and final documents. In particular, if a user selects to preview a contract or finalize a contract, the order service 220 forwards context data, including consumer information and vehicle information, to order to document service 224 and requests that document service 224 generate a preview of an order or final documents for the order. Document service data store 226 may include multiple templates, such as templates for different geographic regions and document service 224 may apply template selection rules to the order data to select a template from multiple templates from which generate a document. Using a template of a contract from document service data store 226, document service 224 may generate an HTML, PDF or other version of the contract by populating the template with data from the order service and return the generated contract to the order service 220. The order server 220 can then respond to the user's request to view a preview of the contract or the final contract.

Some of the information provided by order service 220 to document service 224 may be encrypted and thus the populated template may include encrypted data. According to one embodiment secure network services 202 may include a document generator 227. When interface proxy service 204 receives a response to pre-view a document or review a final copy of the document, interface proxy service 204 may send the populated template to document generator 227, which can use encryption service 208 to decrypt the encrypted data and complete the preview or final document using the decrypted data. The completed preview or final document is then returned to client application 114.

Inventory service 230 is configured to ingest and enhance inventory records, filter the inventory records, determine pricing information, publish inventory records to inventory service data store 232 and search inventory records. As part of filtering inventory records and determining pricing, inventory service 230 may use depreciation models generated by price modeling service 234 that correspond to year/make/model/trim and mileage bands. If a depreciation model does not exist for a year/make/model/trim, inventory service 230 can filter out the inventory feed record. If a depreciation model does exist for the year/make/model/trim, inventory service 230 can use the depreciation model to determine payments for a vehicle. A data store 236 may store a pricing model, depreciation models or other data used by price modeling service 234.

Decision controller 252, according to one embodiment, is the main application layer of decision service 250 that routes calls between services and is responsible for logging actions. Decision controller 252 is configured to receive requests for decisions from other services and return decision results. Decision controller may assign a decision request a unique decision identification and return the decision identification to the requesting service. Decision controller 252 may pass a request for a decision along with relevant input data to decision engine 254 and pass the decision result to a requesting service.

Decision engine 254 is a rules-based software system that provides a service that executes decisions on decision inputs in a runtime production environment to generate a decision output. Executing a decision can include applying a set of decision rules to the data to approve/disapprove the action and/or take some responsive action, such as generate an output.

A decision input defines the set of data for which a decision will be made. In automotive data processing system 100, the decision input may be some minimum set of information needed to approve a user and/or a particular transaction, such as the user's name, address, social security number, driver's license number or other information used in the decision process. These values may be encrypted and/or tokenized when passed to decision controller 252. At least a portion of the data to be included in a decision output may be specified by the decision executed.

A decision may have an associated “kind” that indicates the type of decision being implemented. The decision “kind” can be used by other services (e.g., user application service 210) to request a decision or other decisions to reference that decision (to create a tree of decisions). Decision base 256 specifies, for each decision type, rules on how to interpret data to approve/disapprove users or transactions, determine products to offer or make other decisions consistent with regulations, business policy or other constraints. For example, the decision base 256 may specify the approval rules 140 to be applied.

In general, decision engine 254 executes a decision to determine if a set of data meets conditions specified in the decision rules for the decision type and generates an output based on the application of conditions to the data. The data to which the conditions are applied may or may not include the decision inputs. Decisions may reference data sources from defined by decision service 250, predictions from data modeling services and prediction services 260 and sub-decisions and contain rules that are applied to data obtained from information provider systems 120, prediction scores from prediction and modeling service 260, sub-decisions, decision inputs or other data.

If a decision references a prediction, decision engine 254 can generate a prediction request to prediction and modeling service 260. Prediction and modeling service 260 can apply a prediction model to a set of prediction inputs to return a prediction score. A prediction model may be a set of user defined prediction rules or a machine learning model.

According to one embodiment, prediction and modeling service 260 comprises a model controller 262 that receives prediction requests and delegates the request to the correct prediction model 264 based on rules or to a specific model if the specific model is specified with the prediction request. For example, model controller 262 can be configured to delegate a request for an income prediction to a currently active income prediction model if the income prediction request does not specify a particular income prediction model. In this case, prediction and modeling service 260 can process the request using the currently active income prediction model. Modeling service configuration data 266 specifies what models are used and what models are active.

Decisions and prediction models may require data from information provider systems 120. Data vendor service 270 can be used to collect data from information provider systems 120. According to one embodiment, decision service 250 can define and manage data sources, data source versions, data source arguments, and data source records. A data source specifies a set of data from one or more information provider systems 120 (e.g., 3rd party services provided by information provider systems 120) that can be passed to other services. For example, a data source may be a report containing data gathered from one or more information sources 120. The decision service 250 can maintain a definition of the arguments needed to collect the data for an instance of a data source version, receive argument values from other services, collect the data via data vendor service 270 and pass the data source instance to the requesting service or use the data source instance in executing a decision. Decision service 250 may further cache data source instances for faster retrieval in response to a subsequent request for the data source instance.

According to one embodiment, when decision controller 252 receives a request for a decision, decision engine 254 confirms what data is required to retrieve a data source instance from an information provider system 120 to execute the decision prior to executing an API call to data vendor service 270. For example, if decision engine 254 requires “Report A version 1” data source when processing a request to qualify a user, and a social security number is required to fetch that report, decision engine 254 can cross reference the required arguments for fetching said data source with the arguments provided to decision service 250 for the generating the decision and assess whether the dependencies have been met, resulting in a fetching of the data source report, or not, resulting in decision service 250 responding to the user application service 210 with what further arguments are needed. In response to a complete set of arguments, i) decision engine 252 passes the arguments (which may be encrypted or tokenized) to data vendor service 270, ii) data vendor service 270 collects the Report A version 1 instance from an information provider system 120 via the API for system (which may use encryption service 208 to decrypt/encrypt PII) and iii) data vendor service 270 provides the Report A version 1 instance to decision engine 254. Furthermore, decision service 250 may cache the report instance so that it can respond to requests for the report within a specified time window with cached data rather than fetching the data again from the information provider system. In some cases, the decision may specify a ‘force’ fetch of a data source, such that decision service 250 fetches a fresh report from data vendor service 270 (e.g., from the third party vendor) rather than using a cached report instance.

Similarly, according to one embodiment, when the decision engine 254 receives a request for a decision, the decision engine 254 may not know what data is required to make a prediction required by the decision. The decision engine can call over to the prediction and modeling service 260 and prediction and modeling service 260 informs the decision engine 254 of the data needed for the prediction. For example, if decision engine 254 makes a call to prediction service 260 for an “Income Prediction version 1”, the prediction service can inform decision engine 254 of the data sources or other data needed to make the prediction. In response, i) decision engine 254 communicates with data vendor service 270 to collect the data sources as described above; ii) passes the data source instances or other data to the prediction service 260; iii) receives the results of the requested prediction from the prediction service 260.

Any data sources required and the data from the data sources used by particular rules in decision making can be specified in the decision rules in decision base 256 or prediction models 262 stored in modeling service configuration data 262 rather than the decision engine code. From the perspective of decision engine 254, gathering data sources and receiving the results of predictions is simplified as decision engine 254, in some embodiments, need only be able to request a data source instance from and pass arguments to data vendor service 270 to receive a data source instance and request a prediction from and pass arguments to prediction service 260 to receive prediction results from service 260.

Thus, based on the decision type and decision input attributes for the decision that decision engine 254 is being requested to make, decision engine 254 can access the appropriate rules (e.g., from decision base 256), retrieve the required data sources and/or prediction scores, process the decision rules to generate a decision result and return the decision result to the requesting service. The decision result may include the id of the decision and metadata about the decision including, for example, an indication of whether the decision result was a pass or a fail, prediction scores generated when making the decision, decline codes indicating why the decision failed or other decision metadata.

Decision controller 252 returns the decision result to the calling service (e.g., user application service 210). Decision controller 252 may also store data associated with the decision in decision service data store 259 (such as, but not limited to, decision type, decision inputs, model identifier, prediction inputs, prediction scores, data source instances, decision result metadata).

User application service 210 is configured to update the appropriate user application record with the decision result data to update the state of the user application. User application service 210 further includes rules to map decision results to actions. According to one embodiment, if the decision result indicates a pass, user application service 210 can generate a response to the preapproval requesting from client application 114 including data, such as the affordability score, and send the response to the client application 114 via interface proxy service 204. Client application client application 114 can be configured to proceed to a next stage in the purchase process by, for example, displaying an application page corresponding to the next stage on the client computing device 110.

User application service 210 can categorize decline codes as soft and hard declines. Soft decline codes may be mapped to responses to request additional information or provide instructions to the user to take some action, such as call a customer service representative. Based on the soft decline code, user application service 210 can generate the appropriate response and send the response to the client application 114 via interface proxy service 204. Based on the decline response, client application 114 can display the appropriate application page to allow the user to input additional information or provide instructions to the user on how to continue the application stage. In response to receiving the requested additional information from the user, user application service 210 can request that the preapproval decision be reevaluated by decision service 250.

A hard decline, on the other hand, terminates the application stage. User application service 210 may send a hard decline response to client application 114 and client application 114 can display an application page indicating that the user application has been denied and the reasons for the denial. In some cases, user application service 210, responsive to a hard decline code, may send the user application record data to a service configured to report the decline to a credit reporting agency, generate a letters to report the hard decline or take other actions.

Subscription service 290 may receive a payment schedules and financial information from orders, store subscriptions (e.g., in subscription service data store 292) containing the payment schedule and financial information necessary to interact with a consumer's financial institution and interact with financial institutions to execute the payment schedule.

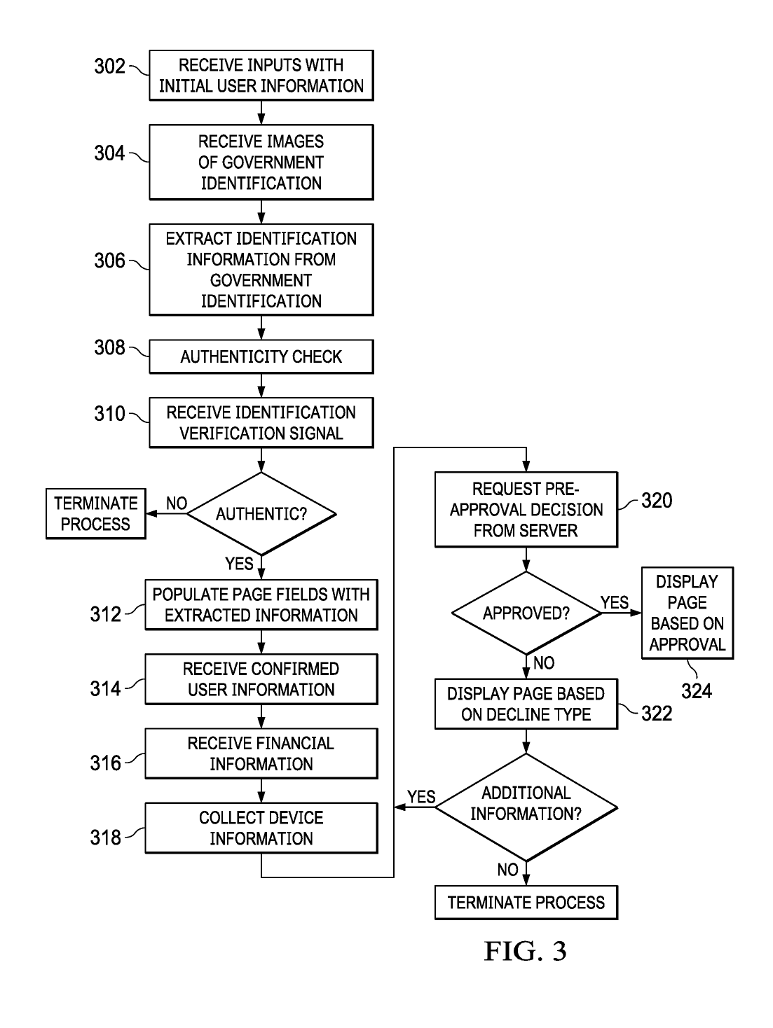

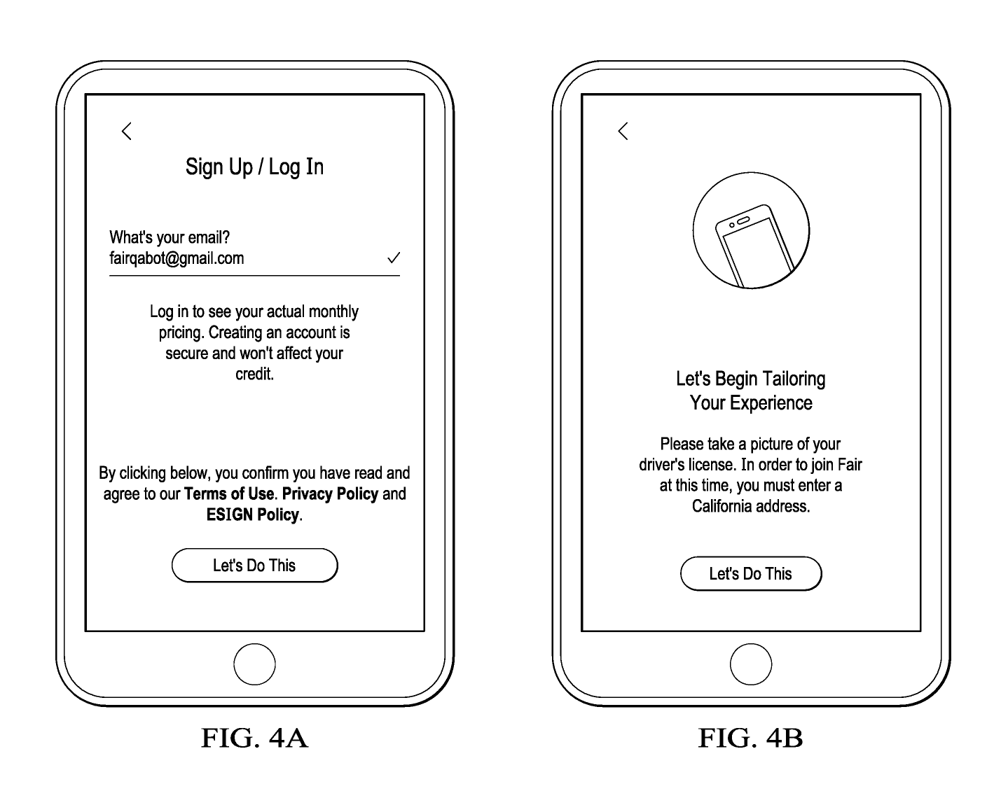

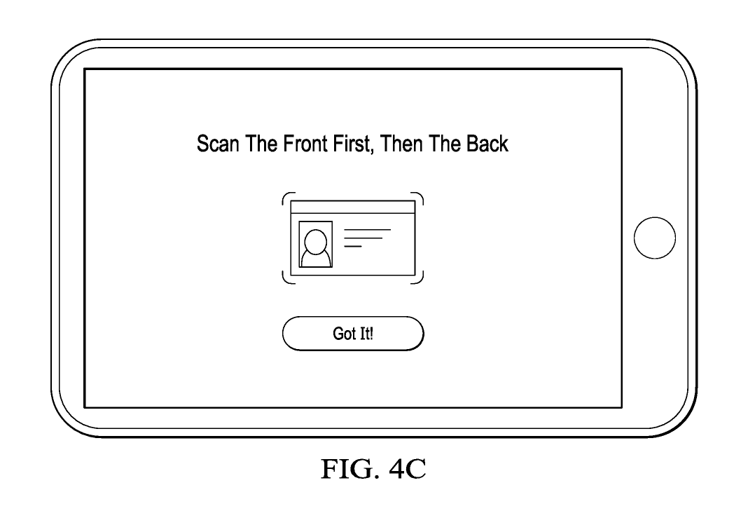

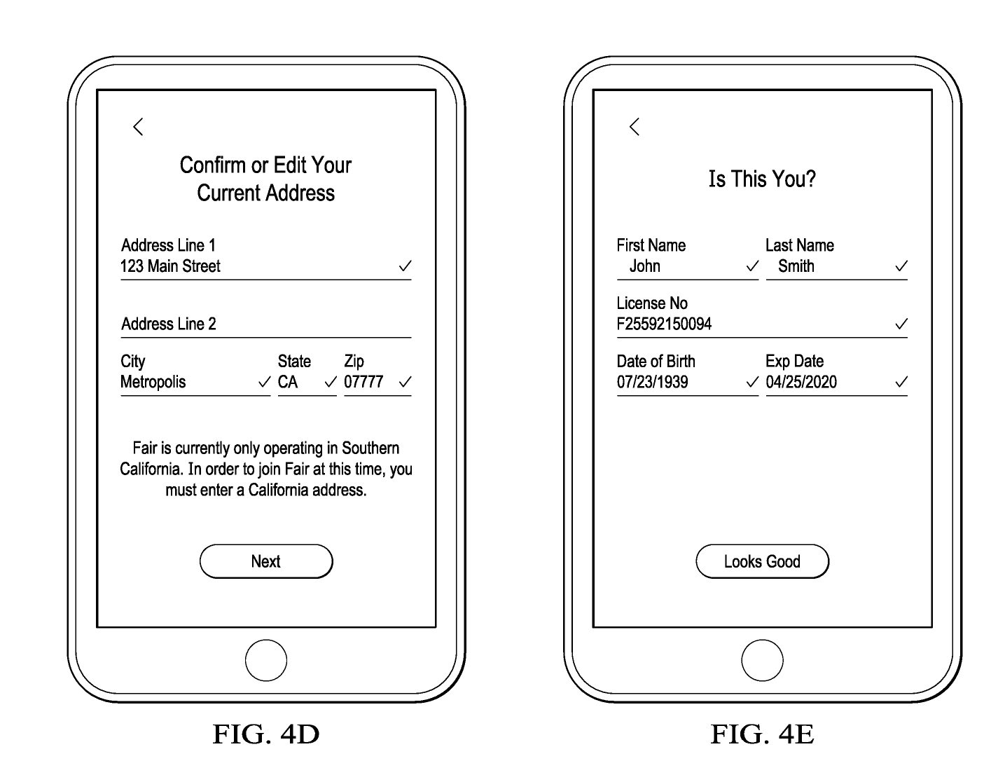

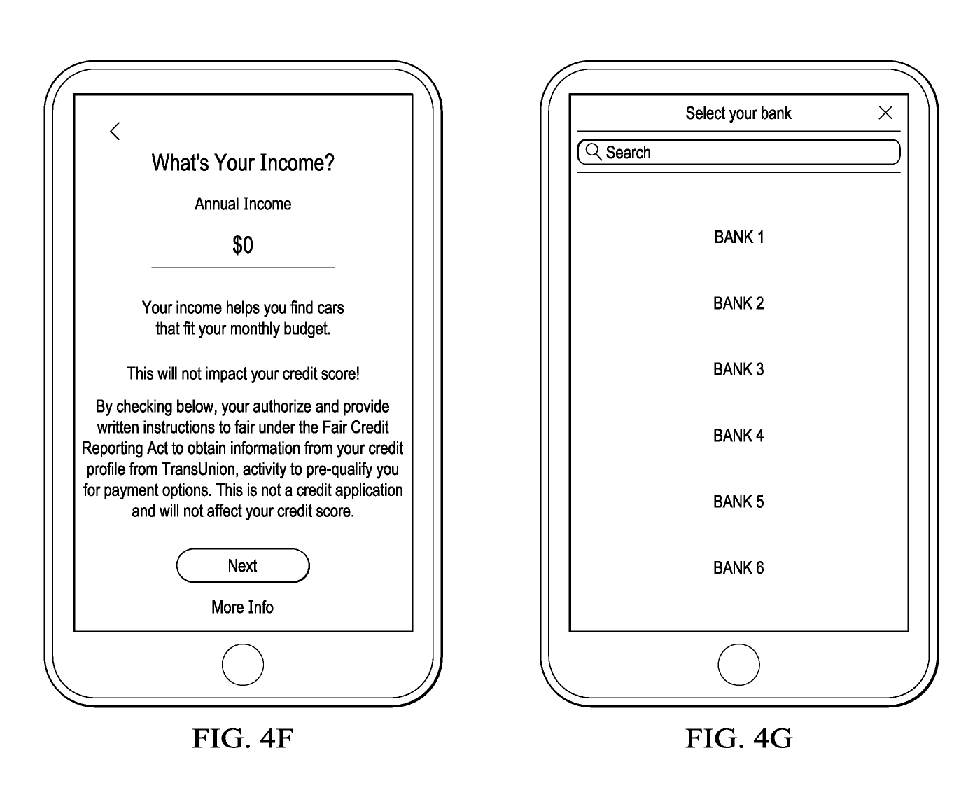

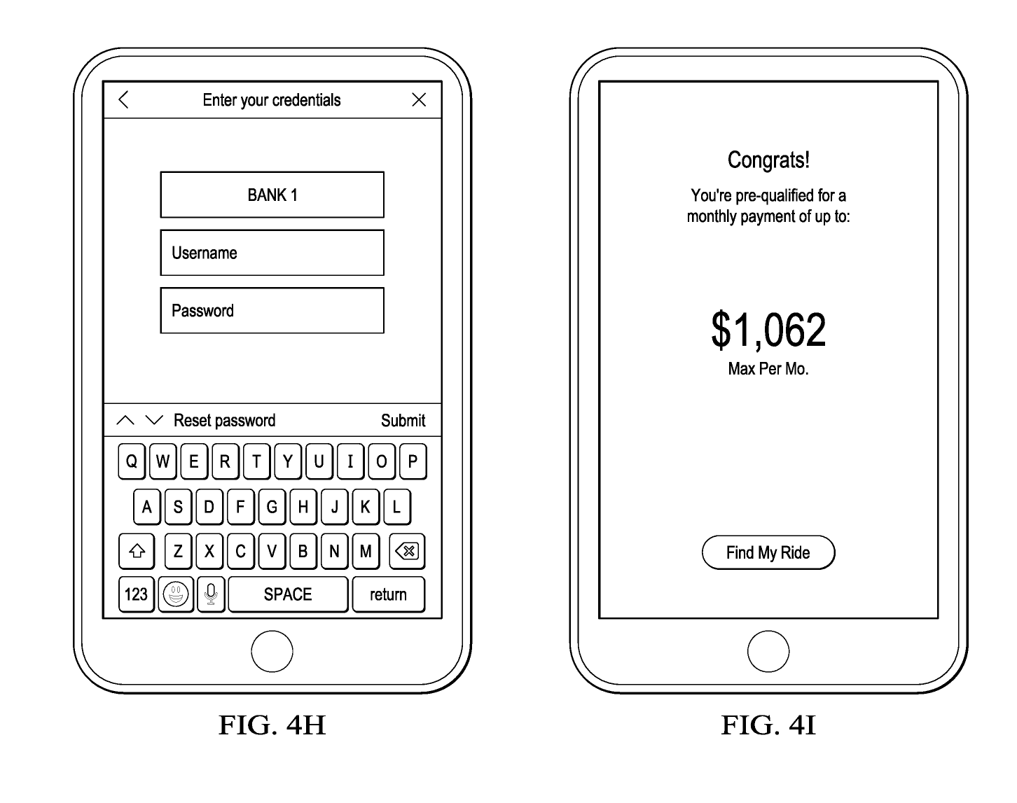

FIG. 3 is a flow chart of one embodiment of a method corresponding to a user application stage. FIGS. 4A-4I are diagrammatic representations of application pages displayed by one embodiment of a client application 114 on a mobile device.

The application approval process relies on personally identifiable (PII) information provided by the consumer to automotive data processing system 100. In some embodiments, a user many manually enter all of the PII used in the approval process. In accordance with other embodiments, however, client application 114 is configured to provide a low friction interface that contains few, if any, form fields for the explicit input of PII. In a low friction implementation, automotive data processing system 100 can determine PII (or other information) used in the approval process from the limited information provided by the user. In other words, client application 114 can provide an interface that asks the consumer a set of thin questions and automotive data processing system 100 can build a robust user profile for the consumer.

To make the experience convenient for the consumer, the system can gather a large portion, if not all, necessary information for the initial financial approval from an image scan of the consumer's driver's license (or other government identification document) taken directly on the mobile device. The consumer has the ability to then confirm data.

A user may download the application and register for an account on automotive data processing system 100 and provide personally identifiable information (PII) to automotive data processing system 100. To this end, client application 114 can be configured with an interface module 115 to generate a user interface for inputting one or more pieces of PII and financial information, which can be temporarily stored in representation of the user application 118. At various points in the application process, client application 114 can forward information from representation of the user application 118 to automotive data processing system 100.

PII collected may include, but is not limited to, the user's full name, driver's license number, home address, date of birth, social security number, email address, telephone number, driver's license expiration date, license plate number, bank account numbers or other PII. Accounting information may include information such as weekly, monthly, or annual income, debts owed by the user and other financial information that can be verified against information from other sources of financial information.

According to one embodiment, the user only supplies a small amount of PII and the system enhances the user record with additional information from distributed sources. For example, in one embodiment, client application 114 prompts the user to provide only a limited number of inputs, such as a portion of the following:
Registration Information: information sufficient to create a user account or access an existing user account at automotive data processing system 100. The registration information may include, for example, email, password;
Image of driver's license or other government id;
Phone number of mobile device;
Self-reported Income (e.g., yearly, monthly, weekly);
Bank account access information.

Client application 114 may also prompt the user to log into his or her bank account so that automotive data processing system 100 may access the consumer's financial information.

At step 302, client application 114 presents a page to collect an initial set of user information used to initiate the user application process. As illustrated in FIG. 4A, client application 114 provides an application page through which a user may provide an email address. In some cases, the user may also provide an account password. Based on a signal indicating that the user wishes to proceed with the application process—for example, based on the user's selection of the “Let's Do This” virtual button in FIG. 4A, client application 114 can submit a request to initiate an application to automotive data processing system 100. Automotive data processing system 100 can assign a unique user id to the user and user application identifier to the application, which can be returned to client application 114.

Furthermore, an image (a scan or digital photograph) of the user's government identification can be used to enhance PII without requiring explicit field inputs for each piece of information. To this end, client application 114 can receive an image of a government identification (step 304). For example, client application 114 can be configured to access a mobile device's picture roll to allow a user to select images of the user's government id already present on the camera roll. In another embodiment, client application 114 can include an imaging module 116 that can access a camera of the client computing device 110 (for example, a smart phone camera) to take an image of a user identification document (for example, a scan or photograph of a driver's license, passport or other user identification document). As illustrated in FIG. 4B and FIG. 4C, client application 114 presents a series of application pages to prompt the user to image one or both sides of the user's driver's license, including the driver's license barcode and provide controls to allow the user the capture the images. According to one embodiment, client application 114 may forward the images of the government document to automotive data processing system 100. In the example of FIG. 2, user application service 210 can update the user application record with the images. In other embodiments, the images may be stored in representation of the user application 118 and forwarded to automotive data processing system 100 at a later time.

Additional PII can be obtained from the images of the government id through OCR recognition and machine symbol recognition techniques. For example, a variety of information may be extracted from a driver's license barcode including, but not limited to, the user's full name, home address, date of birth, driver's license number and driver's license expiration date. Thus, at step 306, additional PII can be extracted from the image of the government identification. In some embodiments, client application 114 or vehicle data application 150 may include code to OCR the government identification or read symbols (e.g., driver's license barcode) to extract the encoded information. In another embodiment, client application 114 or vehicle data application 150, at step 306, may leverage third-party services to extract information from the images of the government identification. For example, a number of data vendors including, but not limited to, Confirm Inc. of Boston, Mass. and Mitek of San Diego, Calif. provide Internet-based services that allow an application to submit an image of a driver's license and return extracted information. Client application 114 or vehicle data application 150 may therefore include an interface (e.g., API, library) to provide the image of the government identification to an information provider system 120 that extracts information from images of government identifications (e.g., services that read encoded information from driver's license barcodes) and receive the extracted information in return. Whether the information is extracted by client application 114, vehicle data application 150 or a third-party service, the user application record can be enhanced to include PII determined from the information explicitly provided by the user.

At step 308 the authenticity of the government identification may be checked. Client application 114 or vehicle data application 150 may include code to verify the authenticity of the identification or may leverage third party identification verification services. According to one embodiment, client application 114 or vehicle data application 150 may, for example, include an interface (e.g., API, library) to provide the image of the driver's license to an identification verification service. For example, Confirm Inc. of Boston, Mass. (https://www.confirm.io/confirm-id), Mitek of San Diego, Calif. and a number of other data vendors provide services that extract data from an images of a driver's license, analyze the scanned identification and return identification verification signals indicating if a scanned identification is authentic (pass) or fraudulent (fail). Thus, for example, client application 114 may include an interface for an identification verification service and be configured to send the images input at step 304 to the identification verification service.

Client application 114 (or vehicle data application 150) may therefore receive an identification verification signal in response to sending the scan of the consumer's driver's license to the identification verification service (step 310). In some cases, the identification verification signal and the extracted data are requested from the same service and are received in the same response. A failure for the identification to verify may result in any configured action, such as withholding further information or services from the consumer, requesting the consumer re-enter information or requesting that the consumer provide additional information. For example, if the identification verification service indicates that the identification fails, client application 114 or vehicle data application 150 can terminate the application process.

Client application 114 can pre-fill a number of fields in an application for the consumer based on the extracted government identification information (step 312) and give the consumer the option to confirm/update information that may have changed since the identification document issued (e.g., the user may update the residence address if the user has moved, but not yet updated his or her driver's license). At step 314, client application can receive confirmed user information that may include the same values that were pre-populated in the fields of the application page or updated (edited) values. Client application 114 can upload the confirmed user information to automotive data processing system 100. For example, FIG. 4D and FIG. 4E illustrate example application pages with data extracted from the user's driver's license populated in editable fields. The user may edit the information and interact with a control (e.g., “Looks Good” virtual button in FIG. 4E) to submit the user information as originally populated or updated by the user. In response to an input signal based on user interaction in the GUI (e.g., in response to the user tapping the “Looks Good” virtual button), client application 114 can send the additional user information to automotive data processing system 100 to update the user application record. In the example of FIG. 2, user application service 210 may update the user application record in user application service data store 212 with the received information. In other embodiments, the confirmed user information may be stored in representation of the user application 118 and forwarded to automotive data processing system 100 at a later time.

Client application 114 may also receive financial information used in the application process (step 316). FIG. 4E, for example, illustrates an embodiment of an application page that allows a user to submit a self-reported income. In response to an input signal based on user interaction in the GUI (e.g., in response to the user tapping the “Next” virtual button), client application 114 can send the financial information to automotive data processing system 100 to update the user application record. In the example of FIG. 2, user application service 210 may update the user application record in user application service data store 212 with the received information. In other embodiments, the received financial information may be stored in representation of the user application 118 and forwarded to automotive data processing system 100 at a later time.

At step 318, client application 114 collects a set of device information, such as GPS location of the mobile device, operating system, mobile device ID or other information of the device on which client application 114 is executing. Client application 114 can send the device information to automotive data processing system 100 to update the user application record. In the example of FIG. 2, user application service 210 may update the user application record in user application service data store 212 with the received information. In other embodiments, the received financial information may be stored in representation of the user application 118 and forwarded to automotive data processing system 100 at a later time.

In response to an input signal based on user interaction in the GUI (e.g., in response to the user tapping the “Next” virtual button in FIG. 4F) client application 114 can send a request to automotive data processing system 100 for an approval decision (step 320). Client application 114 may also send any data in representation of the user application 118 that has not yet been forwarded to automotive data processing system 100 to automotive data processing system 100.

In response to a request for an approval decision, client application 114 receives a decision response. The decision response may include an indication of whether the decision result was a pass or a fail, prediction scores generated when making the decision, decline codes indicating why the decision failed or other decision metadata. If the decision response indicates a “fail” (i.e., the application was not approved), the application may display a page associated with the decline code to the user (step 322). For example, if the decline code indicates that the user's income could not be verified, as discussed below, client application 114 may display a series of pages indicating the reason the application was declined and a page requesting that the user provide bank account information so that the user's self-reported income can be verified against the user's financial transactions. For example, FIG. 4G and FIG. 4H illustrate embodiments of pages that allow a user to select his/her bank and provide information to link to the bank account. In response to an input signal based on user interaction in the GUI (e.g., in response to the user tapping the “Submit” virtual button), client application 114 can send the user's bank information to automotive data processing system 100 to update the user application record. In some cases, the information to link to the bank account may include an account number. In the example of FIG. 2, user application service 210 may update the user application record in user application service data store 212 with the received information. In other embodiments, the bank information may be stored in representation of the user application 118 and forwarded to automotive data processing system 100 at a later time. If the user provides the requested information, client application 114 can forward the information to automotive data processing system 100 and re-request the approval decision.

If the decline code indicates a hard decline, client application 114 may display an application page indicating that the user application has been declined and terminate the process. If the decline code indicates a pass, client application 114 displays a page associated with the approved status (step 324). For example, client application 114 may display a page that indicates an amount for which the user has been approved. FIG. 4I, for example, illustrates one embodiment of an application page indicating that the user has been approved for a particular payment amount. The amount displayed can be populated with data received from automotive data processing system 100. In response to an input signal based on user interaction in the GUI (e.g., in response to the user tapping the “Find My Ride” virtual button), client application 114 can display an application corresponding to a next stage in the purchase process.

In the example of FIGS. 4A-4F the user is only required to enter an email address, an image of his/her driver's license and a self-reported income to receive an approval response that indicates a pass, assuming the user application is approved based on the first request for approval (step 320). The user only has to enter bank account information prior to initial approval if the user application fails to pass the approval. In other embodiments, the user may be required to enter additional information before requesting or receiving approval.

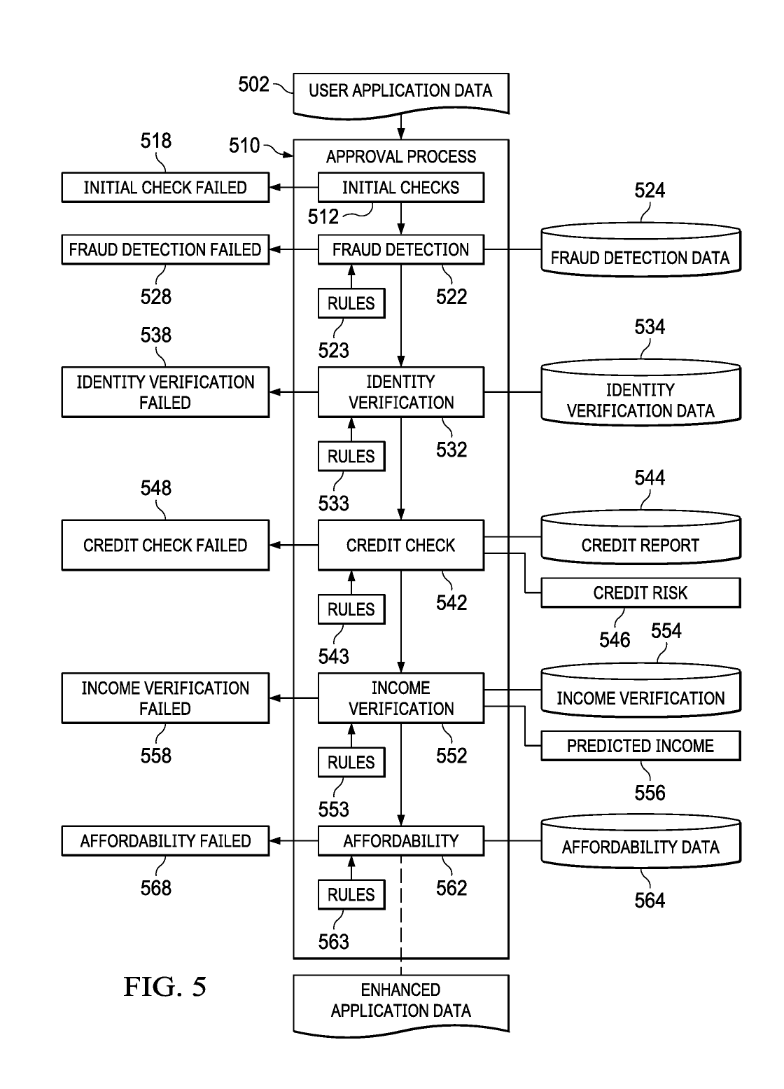

FIG. 5 is a block diagram illustrating one embodiment of an approval process 510 to approve a user application 502. As discussed above, automotive data processing system 100 may receive a request to approve application 502 from client application 114. In the embodiment of FIG. 5, vehicle data application 150 applies approval rules comprising initial checks, fraud detection rules 523, identity verification rules 533, credit check rules 543, income verification rules 553 and affordability rules 563. In one embodiment, the approval rules may be implemented as one or more decisions executed by decision service 250.

Vehicle data application 150 can apply rules 140 to the fraud detection data 524, identity verification data 534, credit report 544, credit risk score 546, income verification data 554, predicted income 556, affordability data 564 and other data. Depending on the results at various steps of the registration and approval process, client application 114 may prompt the user to supply additional information. For example, the user may be prompted to supply additional bank account login information if the user's identity and income level cannot be verified against information provided by a credit bureau or if the user's income is below a threshold based on available bureau information. Thus, the approval interface may have different degrees of friction for different consumers, depending on the results of applying rules 140.

The approval rules may incorporate one or more predictions. For example, credit check rules 543 may reference credit risk score 546 provided by a credit risk predication model and income verification rules 553 may reference a predicted income 556 provided by an income predication model.

The prediction models and approval rules may reference data from information provider systems 120 to which the rules/predictions apply. For example, approval rules or predictions may reference a data source defined by decision service 250. Automotive data processing system 100 can obtain an instance of the data source from the appropriate information provider system 120 using an API. Automotive data processing system 100 can determine the data from an information provider system 120 required to execute a rule and obtain the specified information corresponding to the application 502 from the appropriate information provider system 120 (or cache).

At step 512, vehicle data application 150 applies a series of initial checks to prevent further processing if it is known that a user will not be approved for financing. When processing approval rules to evaluate a particular application, the initial checks 512, according to one embodiment, are checks applied prior to vehicle data application 150 obtaining information from information provider systems 120 referenced by subsequent approval rules. For example, vehicle data application 150 may be configured with minimum self-reported income limits (e.g., self-reported monthly gross income >‘x’), a minimum age (e.g., DOB before ‘y’), only be available to users in certain jurisdictions. For example, if the self-reported income collected at step 316 is less than a threshold, say $3000 or other threshold set in the rules, the application 502 may not pass initial checks 512. While $3000 is used as the example, the threshold may be set based on rules. In some embodiments, a machine learning model may be used to set the threshold minimum income.

If the user application 502 fails the initial checks, vehicle data application 150 can generate a decision result 518 indicating the reason that the application was not approved. The decision result may be stored in application 502. Further, vehicle data application 150 may send a decision response to client application 114 indicating that the application was not approved and the reason the application was not approved. Client application 114 can display one or more pages indicating why the application was not approved and, in some cases, request additional information. Failure of an initial check may result in any configured action, such as withholding further information or services from the consumer, requesting the consumer re-enter information or requesting that the consumer provide additional information.

At step 522, vehicle data application 150 applies online fraud detection rules 523 to determine if the application data indicates online fraud. In one example, vehicle data application 150 can determine if the device attributes stored in application 502 (e.g., device attributes collected at step 318) indicate an instance of online fraud, such as indication that the client device 110 is being fraudulently used. Fraud detection rules 523 may leverage data from distributes sources. A number of fraud data vendors provide online fraud detection services that, in response to receiving particular input parameters, provide online fraud detection signals indicative of a risk of online fraud. Some examples of fraud data vendors include, but are not limited to, Iovation of Portland, Oreg. (iovation.com) or ThreatMetrix, Inc. of San Jose, Calif. provide online fraud detection services. The fraud detection rules 523 may be tailored for the specific online fraud detection parameters 524 returned by the fraud data vendor information provider systems 120.

Vehicle data application 150 processes fraud detection rules 523, determines the fraud detection data 524 from fraud data vendors required to execute the fraud detection rules 523, makes a call to the online fraud detection service (e.g., an information provider system 120), provides information from application 502 to the online fraud detection service, receives responsive fraud detection data 524 and applies fraud detection rules 523 to the fraud detection data 524.

As an example, a fraud detection rule may apply a condition to a threatmetrix_review_status value. The threatmetrix_review_status parameter is a pass/fail flag that is based on an aggregate of GPS location, and device profile attributes associated with the applicant provided by Threatmetrix. Vehicle data application 150 can be configured to supply the GPS, location and device profile attributes from application 502 to the information provider system 120, receive the threatmetrix_review_status value and apply the conditions specified in the fraud detection rules. For example, a rule may specify that the threatmetrix_review_status returned in response to a particular set of application must indicate a pass for application 502 to pass device fraud detection rules 522.

If the user application 502 fails to pass the fraud detection rules 523, vehicle data application 150 can generate a decision result 528 indicating the reason that the application was not approved. The decision result may be stored in application 502. Further, vehicle data application 150 may send a decision response to client application 114 indicating that the application was not approved and the reason the application was not approved. Client application 114 can display one or more pages indicating why the application was not approved and, in some cases, request additional information. Failure to pass step 522 may result in any configured action, such as withholding further information or services from the consumer, requesting the consumer re-enter information or requesting that the consumer provide additional information.

At step 532, vehicle data application 150 applies identity verification rules 533 to determine if the user identification information from application 502 can be verified against other sources of data or if any of the user information is indicative of fraud. In particular, the application data can be verified against data from one or more identity fraud vendors. A number of providers provide online services that, in response to receiving particular input parameters, provide data that can be used to verify identity according identity verification rules 533. One example of an information provider system 120 that provides an identity verification service is Innovis of Columbus, Ohio. Innovis maintains a database of financial information, including information from public sources, credit bureaus and other sources. The Innovis system allows other systems (e.g., automotive data processing system 100) to provide information such as names, home addresses, email addresses and phone numbers and returns an indication of whether the information provided matches other records in the Innovis database. Innovis may check for records that match, for example, a name, address, name and phone number, name and date of birth, provided by automotive data processing system 100. Furthermore, Innovis maintains a high risk database indicating information that suggests a higher risk of fraud (for example, a database of addresses that are more likely to be associated with fraud). In addition, Innovis returns an indication if an address falls in the United States Department of Treasury's Office of Foreign Assets Control (OFAC) list. The Innovis system can further return an indication of whether device information indicates fraud (e.g., return fraud detection data 524). Innovis is just one example of an identity fraud vendor.

Vehicle data application 150 processes the identity verification rules 533, determines the identity verification data 534 required to execute the identity verification rules 533, makes a call to the identity verification service (e.g., an identity fraud vendor information provider system 120), provides information from application 502 to the identity verification service, receives responsive identity verification data 534 and applies the identity verification rules 533 to the identity verification data 535. For example, according to one embodiment, vehicle data application 150 provides the consumer's name, address, email address and other information to Innovis and applies the identity verification rules 533 to the verification information 534 provided by Innovis in response. In one embodiment, hits in the non-high risk databases of Innovis can be considered positive and hits in the high risk database or OFAC list can be considered negative. For example, the rules may specify that a minimum number of positive hits are required to pass or that a maximum number of negative hits are permitted to pass. Furthermore, some hits may be considered fatal. For example, a rule can be configured such that a single hit in the high-risk address database or on the OFAC list is considered fatal. In any case, identity verification rules 533 can be tailored for the identity verification data 534 returned by one or more identity fraud vendor information provider systems 120.

If the user application 502 fails to pass identity verification rules 532, vehicle data application 150 can generate a decision result 538 indicating the reason that the application was not approved. Further, vehicle data application 150 may send a decision response to client application 114 indicating that the application was not approved and the reason the application was not approved. Client application 114 can display one or more pages indicating why the application was not approved and, in some cases, request additional information. Failure to pass identity verification rules 532 may result in any configured action, such as withholding further information or services from the consumer, requesting the consumer re-enter information or requesting that the consumer provide additional information.

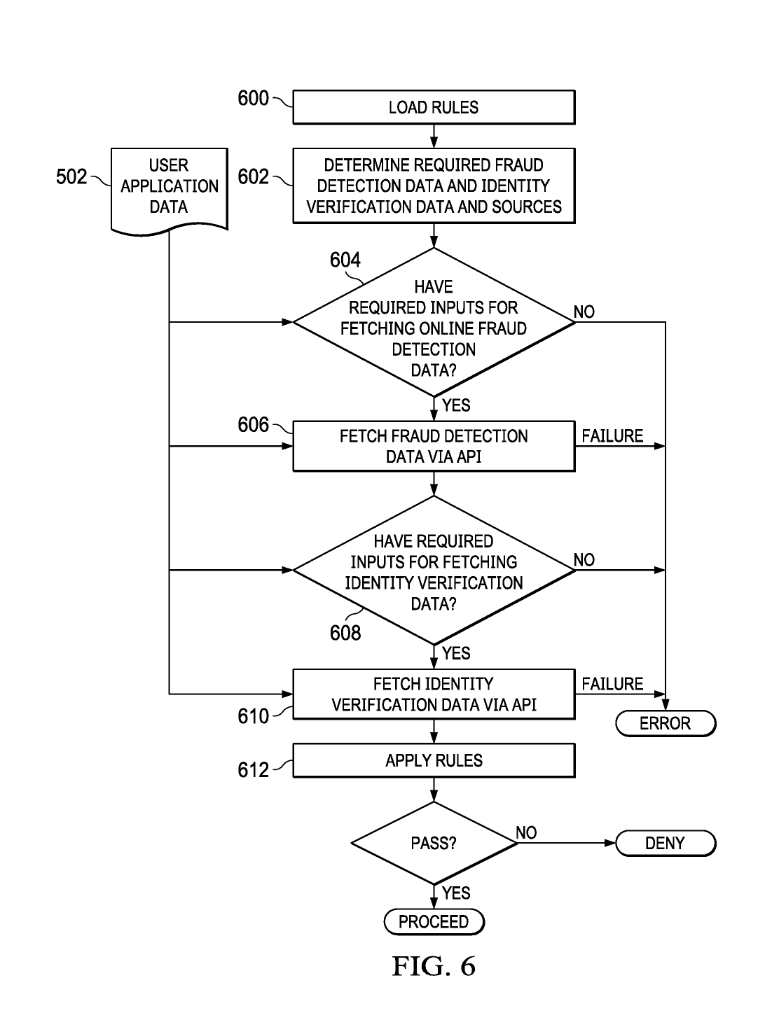

FIG. 6 is a flow chart illustrating one embodiment of steps 522 and 532. Vehicle data application 150 can load fraud detection rules 523 and identity verification rules 533 (step 600) and determine the data from information provider systems 120 needed to execute the rules (step 602). Vehicle data application 150 can provide PII (e.g., user name, user address, user phone number, user email address, date of birth, driver's license number or other PII) from the user application record to one or more fraud detection services and identity verification services (e.g., via data vendor service 270), receive responsive fraud detection and verification signals and apply fraud rules to the information from the fraud detection and verification signals to determine whether a user or device passes fraud detection rules 523 and identity verification rules 533.

At step 604, vehicle data application 150 determines if the application includes the inputs required to fetch the fraud detection data from an information provider system 120. If not, an error can be generated. Vehicle data application 150 may generate a decision response to client application 114 to cause client application 114 to request the additional information necessary to fetch the fraud detection data.

If vehicle data application 150 has the information necessary to fetch the fraud detection data corresponding to the application, vehicle data application 150 may use the API for the service providing the fraud detection data to submit user application data and fetch the fraud detection data (step 606). As one non-limiting example, vehicle data application 150 can supply the GPS, location and device profile attributes from application 502 to the information provider system 120, receive the threatmetrix_review_status value. If the attempt to fetch the fraud detection data fails, vehicle data application 150 can generate an error. Vehicle data application 150 may generate a decision response to cause the client application to prompt the user to try again later or take another action.

At step 608, vehicle data application 150 determines if the application includes the inputs required to fetch the identity verification data from an information provider system 120. If not, an error can be generated. Vehicle data application 150 may generate a decision response to client application 114 to cause client application 114 to request the additional information necessary to fetch the identity verification data.

If vehicle data application 150 has the information necessary to fetch the identity verification data corresponding to the application, vehicle data application 150 may use the API for the service providing the identity verification data to submit application data from application 502 and fetch the fraud detection data (step 610). As one non-limiting example, vehicle data application 150 can supply PII from application 502 to retrieve an Innovis report corresponding to the consumer user. If the attempt to fetch the identity verification data fails, vehicle data application 150 can generate an error. Vehicle data application 150 may generate a decision response to cause the client application to prompt the user to try again later or take another action.

At step 612, vehicle data application can execute the fraud detection and identity verification rules on the fraud detection data and identity verification data provided by the remote systems. Fraud detection rules and identity verification rules may apply to a variety of fraud detection data and identity verification data. The following provides one example of a set of fraud detection rules and identity verification rules using the example of Innovis verification data and threatmetrix fraud detection data:

if (CANAME>=1 and CANAME!=98) and
(CAADR!=98) and
(CAHRA==0) and
(CAWATCHLIST==0) and
(threatmetrix_review_status==1)
pass

else:
fail

Under these rules, the consumer's name must have at least one hit in the Innovis database, but zero hits in the Innovis high risk/OFAC database, the consumer's address must have zero hits in the high risk address database and the device information must return a threatmetrix_review_status of 1 in order for a consumer to be approved.

If the application passes, the approval process proceeds. If the application does not pass the rules, vehicle data application 150 can deny the application. Vehicle data application 150 can update the application with the reason for the denial and generate a decision response to client application 114 to cause client application 114 to request additional information or terminate the approval process.

As can be seen from the foregoing examples of fraud detection rules 523 and identity verification rules 533, vehicle data application 150 may leverage information from various information provider systems 120 to verify the identity of the user or otherwise and detect fraud. The fraud detection rules may be complex and rely on data from additional or alternative source. Furthermore, automotive data processing system 100 may include an arbitrarily complex fraud prediction model to predict if a consumer is a fraudulent user or not. Thus, one or more of device fraud detection rules 523 and identity verification rules 533 may apply rules to a fraud prediction score generated by a fraud prediction model. The fraud prediction model may rely on data from additional or alternative sources. The income predication model may comprise a machine learning model trained over sets of data and that becomes increasingly accurate with additional data or adjusts as data trends change.

The fraud prediction model can be trained over sets of data through machine learning and may become increasingly accurate with additional data. The fraud prediction model may generate a score and fraud decision rules may apply conditions to the score to approve or reject the consumer (or take other action).

A fraud prediction model may contextualize data analysis. For example, one piece of information (or combination thereof) may be analyzed differently depending on the results of analyzing another piece of information (or combination thereof). The data returned by one information provider system 120, for example, may be analyzed differently based on the results of evaluating data from another information provider system 120.

Returning to FIG. 5, at step 542 vehicle data application 150 applies credit check rules 543 to determine if the user has sufficiently good credit to be approved for financing. According to one embodiment, vehicle data application 150 may provide the user name, user address, user phone number, user email address, date of birth, driver's license number or other information from application 502 to credit reporting agency systems, which can be examples of information provider systems 120. In response, the credit reporting agency can provide a credit report 544 for a consumer. For example, Experian Information Solutions, Inc. of Costa Mesa, Calif., Equifax of Atlanta, Ga., and other credit reporting agencies provide online systems through which credit reports can be pulled. In addition to providing a FICO score, a credit report 544 can provide status codes indicating various types of events such bankruptcies, delinquent accounts, repossessions, foreclosures, etc. across accounts. According to one embodiment, all the credit pulls performed in the pre-approval process are soft pulls.

The credit check rules 543 may apply to one or more the credit score and status codes returned by the credit reporting agencies. Moreover, credit check rules 543 may reference a credit risk score 546 generated by a credit risk prediction model. The credit risk prediction model may generate a credit risk score and credit check rules 543 may apply conditions to the score to approve or reject the application 502 (or take other action). The credit risk score may be, for example, a score that predicts the risk of default.

If the user application 502 fails to pass credit check rules 543, vehicle data application 150 can generate a decision result 548 indicating the reason that the application was not approved. Further, vehicle data application 150 may send a decision response to client application 114 indicating that the application was not approved and the reason the application was not approved. Client application 114 can display one or more pages indicating why the application was not approved and, in some cases, request additional information. Failure to pass credit check rules 543 may result in any configured action, such as withholding further information or services from the consumer, requesting the consumer re-enter information or requesting that the consumer provide additional information.

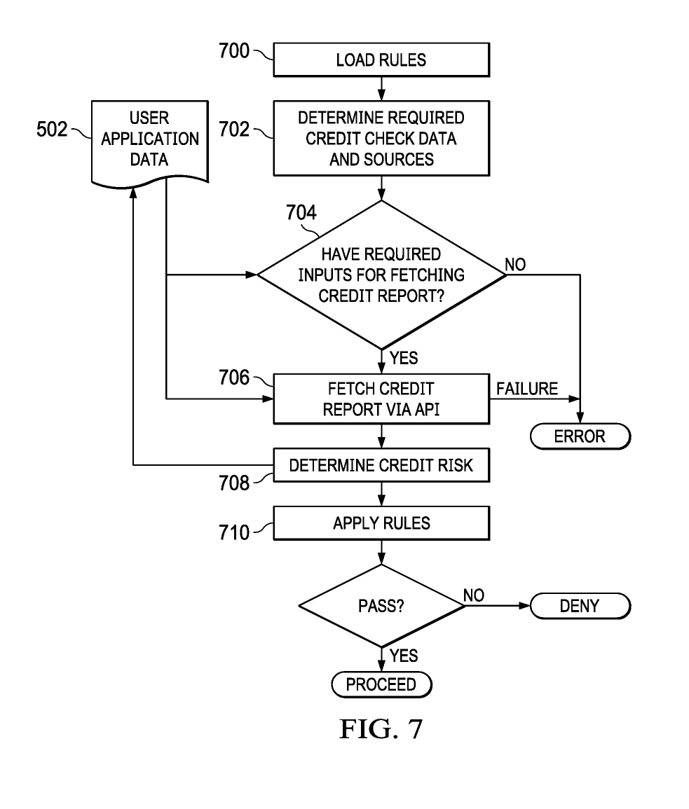

FIG. 7 is a flow chart illustrating one embodiment of a credit check process (step 542). Vehicle data application 150 can load credit check rules 523 and determine the data from information provider systems 120 needed to execute the rules (step 702). This may include determining any data required by a credit risk prediction model. At step 704, vehicle data application 150 determines if the application 502 includes the inputs required to fetch a credit report (or other credit check data) from an information provider system 120, such as a credit reporting agency, or cache. If not, an error can be generated. Vehicle data application 150 may generate a decision response to client application 114 to cause client application 114 to request the additional information necessary to fetch the credit report.

If vehicle data application 150 has the information necessary to fetch the credit report corresponding to the application 502, vehicle data application 150 may fetch the credit report from cache (if available and not stale) or use the API for the credit reporting agency to submit user application data, such as PII, and fetch the credit report (step 706). If a failure occurs while pulling the credit report, vehicle data application 150 may generate an error.

At step 708, vehicle data application 150 applies the credit risk prediction model to determine a credit risk score. The credit risk score for the consumer may be added to application 502. According to one embodiment, the credit risk prediction model may comprise a set of rules that categorize a user into at least one of any number of credit risk bands. In particular, a credit risk prediction model may use information returned in credit report 544 to categorize a user into a credit risk band. For example, a credit risk prediction model may be a set of rules to categorize a user into one of n credit risk bands, where n=20 in the below example, such as:
If FICO 700-710 then credit risk=19
IF FICO 711-720 then credit risk=18
IF FICO 721-730 then credit risk=17
IF FICO 731-740 then credit risk=16
* * *
IF FICO 890-900 then credit risk=0

While, in the above example, the credit risk prediction model comprises a limited set of rules, the credit risk prediction model may be arbitrarily complex and rely on data from additional or alternative sources. The credit risk predication model may comprise a machine learning model trained over sets of data and that becomes increasingly accurate with additional data or adjusts as data trends change.

A credit risk prediction model may contextualize data analysis. For example, one piece of information (or combination thereof) may be analyzed differently depending on the results of analyzing another piece of information (or combination thereof) (e.g., the number of allowable delinquent accounts may be higher if the user's FICO is higher). The data returned by one information provider system 120 (e.g., returned by one credit reporting agency), for example, may be analyzed differently based on the results of evaluating data from another information provider system 120 (e.g., returned by another credit reporting agency).

At step 710, vehicle data application 150 can apply the credit check rules to the credit report or credit risk score. The following provides one example of credit check rules.

If:
FICO>=700 and
Repossessions=0 and
Bankruptcies=0 and
Delinquent Accounts=0
Pass

Else:
Fail

In the foregoing example, the credit check rules directly apply to data from a credit report. In other embodiments, credit check rules may apply conditions to a credit risk score to determine if an application 502 passes the credit check rules. The credit check rules may be complex and rely on data from additional or alternative sources. Failing the credit check rules may result in requesting more information from the user or taking other configured actions.

Returning to FIG. 5, if the application passes credit check step 542, the approval process proceeds. If the application does not pass the credit check rules, vehicle data application 150 can deny the application. Vehicle data application 150 can update the application 502 with the reason for the denial and generate a decision response to client application 114 to cause client application 114 to request additional information or terminate the approval process.

Returning to FIG. 5, at step 552, vehicle data application 150 determines a verified income for the consumer based on application 502 and leveraging information from distributed sources. Vehicle data application 150 can interact with one or more financial institutions, credit reporting agencies, income estimation services (which can be examples of information provider systems 120) or other information to collect information about a user's income and debts to verify income and determine affordability. Automotive data processing system 100 may perform one or more income tests to ensure that a consumer meets minimum income qualifications. As noted above, some of these tests may be performed as part of initial checks 512. Vehicle data application 150 may further apply income verification rules 553 to determine a verified income (represented in the below examples as verified_monthly_income) for the user.

Income verification rules 553, according to one embodiment, may reference an income prediction model that generates a predicted income 556. In accordance with one embodiment, vehicle data application collects self-reported income from a consumer, predicts the consumer's income based on information provided by information provider systems 120 and applies rules/models to the self-reported income and predicted income to determine a verified income.

If there is insufficient application data to determine a verified income, vehicle data application 150 may generate a decision result 558 indicating that the application was not approved. Furthermore, vehicle data application 150 may send a decision response to client application 114 indicating that the application was not approved and the reason the application was not approved. Client application 114 can display one or more pages indicating why the application was not approved and, in some cases, request additional information.

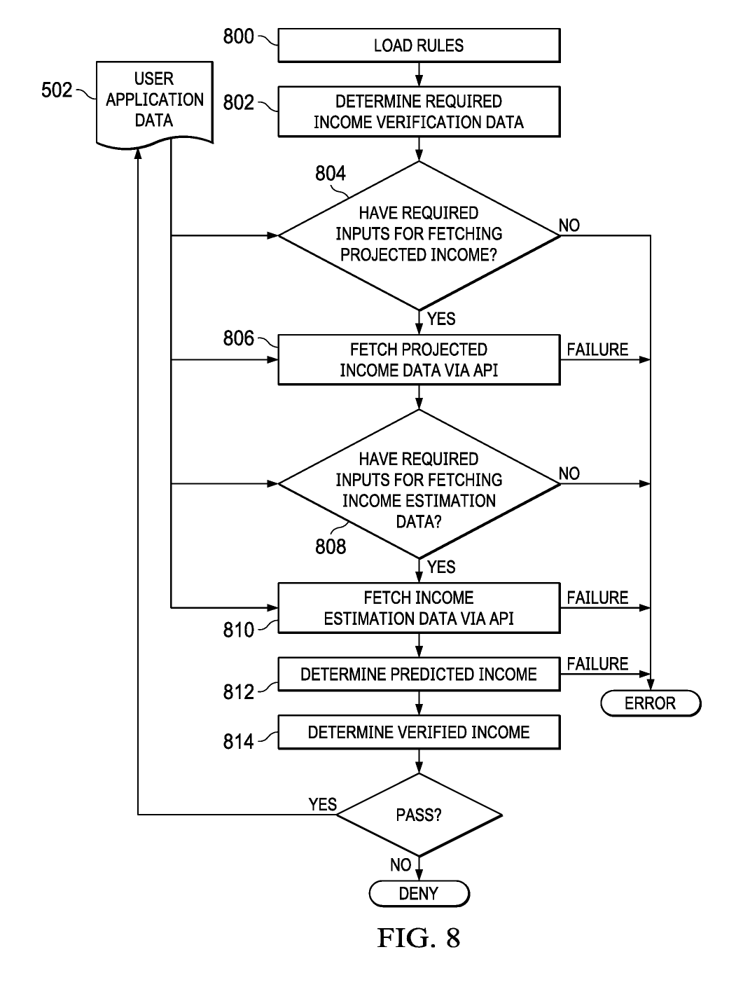

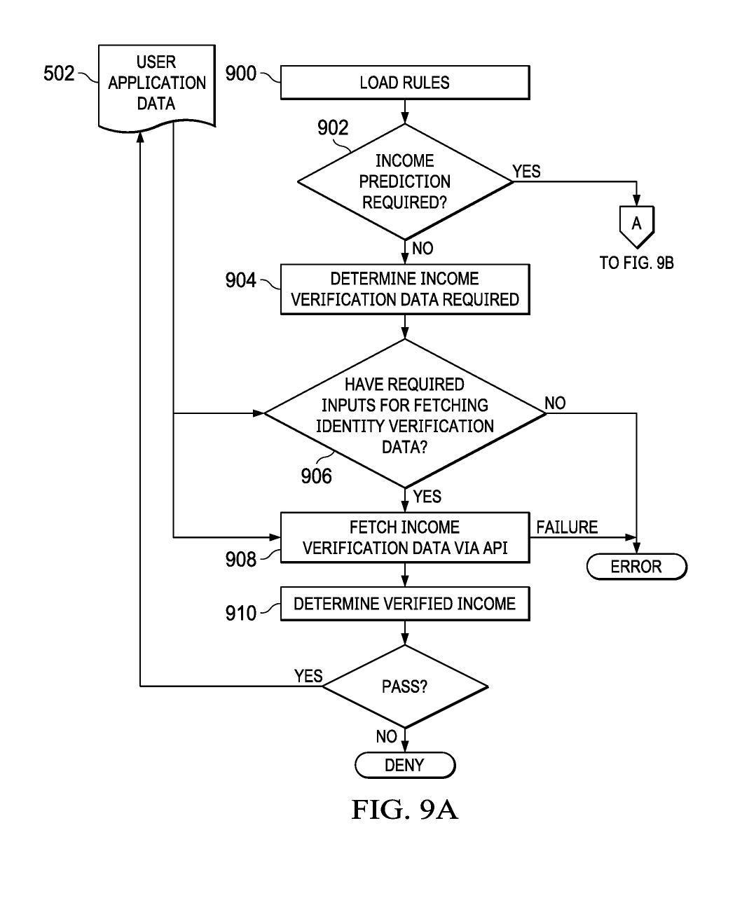

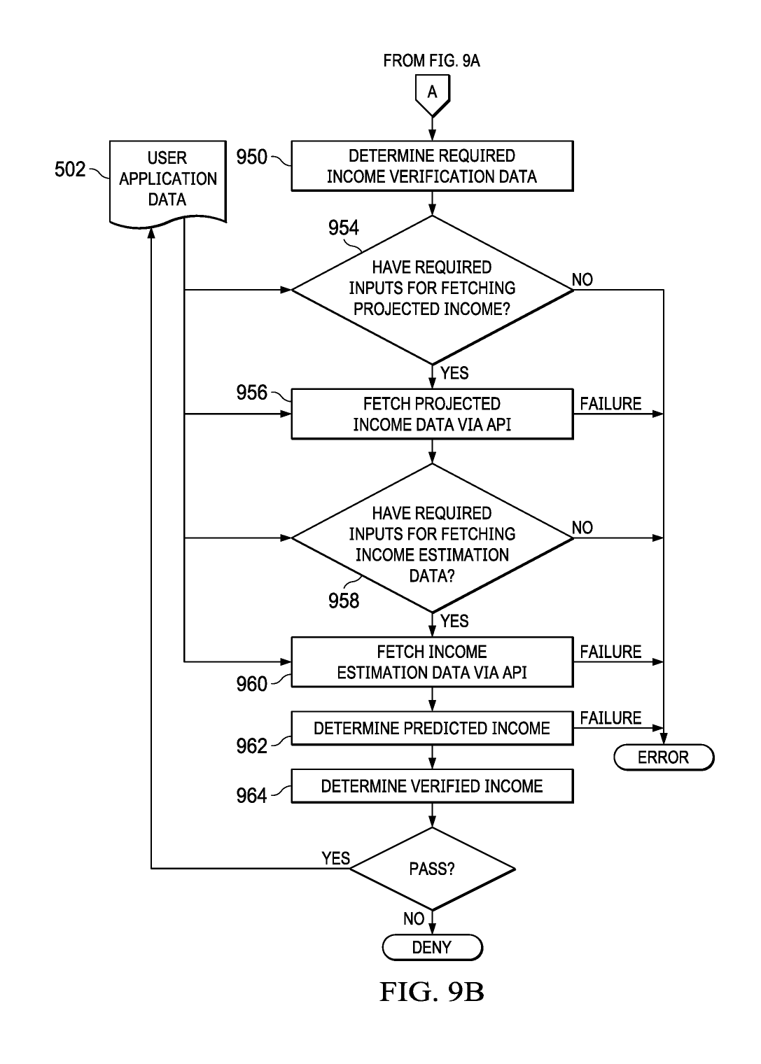

FIG. 8, FIG. 9A and FIG. 9B (FIGS. 9A and 9B are referred to collectively herein as FIG. 9) illustrate example embodiments of income verification (step 552). In these examples, the verified income is determined based on one or more of the self-reported income, an estimated income provided by an income estimation service, a projected income determined from actual financial transactions by the user, and a predicted income generated based on an income prediction model. In this context:
1) estimated income (estimated_income_score) is an income value estimated based on secondary sources of financial information, such as credit reports and other sources of data without requiring access the user's financial accounts. In some embodiments, the information used to determine estimated income may be requested from an information provider system 120 and vehicle data application 150 may estimate the income. In another embodiment, the information provider system 120 (e.g., an income estimation service) may provide the estimated income. For example, Transunion, Inc. of Chicago, Ill., provides income estimation modeling and provides a CreditVision score, which can be used as one example of estimated income (e.g., estimated_income=credit_vision_income_score). As such, vehicle data application 150 can provide information from the application 502 to TransUnion (or other provider) via an API and receive credit information, including a CreditVision score (or other estimated income measure) in response.
2) projected income (projected_income) is an income value projected from analyzing transactions in the consumer's financial account(s). The projected income may be determined by accessing the consumer's bank account and reviewing the transaction records to identify patterns that suggest an income (e.g., deposits occurring on a regular schedule). In some cases, the projected income may be provided by an information provider system 120. For example, Plaid Technologies, Inc. of San Francisco, Calif., provides an API that allows an application (e.g., vehicle data application 150) to access user bank accounts and retrieve transaction information and projected income data. Thus, for example, vehicle data application 150 may connect to a user's bank account using information from application 502 (e.g., credentials provided by or derived for the user, such as a Plaid token) and collect transaction data and projected income using the Plaid service (e.g., projected_income=plaid_income) or other service.

An income prediction model may use self-reported income, an estimated_income, a projected income or other data to determine a predicted income (represented as model_income below). In particular, one embodiment of the income prediction model determines a predicted monthly income (model_income) based on:
1) a projected income score determined from the user's bank account (e.g., the projected_income);
2) an estimated income score determined from an income estimation service (e.g., the estimated_income);
3) high and low income estimations based on the estimated income score determined from the income estimation service.

In one embodiment, the income prediction model determines the predicted income as follows:
if estimated_income_low<=projected_income<=estimated_income_high:
   if estimated_income<=0:
   model_income=0
   else:
   model_income=projected_income
else:
   model_income=estimated_income

The high and low and high income estimations provided can be estimated incomes provided by an income estimation service scaled by a scaling factor (e.g., credit_vision_income_low=credit_vision_income_score*0.9 and credit_vision_income_high=credit_vision_income_score*1.1). The scaling factor may be set by rules, interpolated from the income estimation data (e.g., CreditVision data) or be otherwise determined. In one embodiment, for example, the scaling factors correspond to the standard deviation of CreditVision scores, e.g.:
credit_vision_income_low, credit_vision_income_high
=get_TU_income_sigma(credit_vision_income_score)

According to another example embodiment, the income prediction model determines the predicted income based on the estimated_income, projected_income and an projected_income confidence level determined based on financial transactions associated with the user's bank account specified in the application data 502. Using the example of a Plaid projected_income and Plaid confidence level, the predicted income 556 can be determined as follows:
if projected_income_confidence>c
   model_income=projected_income
else
   model_income=estimated_income
      where projected_income_confidence is a confidence measure of the income projection. The confidence measure can be determined by automotive data processing system 100 or by the income projection service. For example, Plaid provides not only a plaid_income, but also a plaid_confidence, which can be used as projected_income_confidence in one embodiment. ‘c’ is a confidence level threshold configured in automotive data processing system 100. Preferably ‘c’ is >0.7 and more preferably 0.9 or greater.

The income prediction model may be configured to favor projected income over estimated income because the projected income is directly based on actual bank account records of the consumer. However, a substantial variation between the projected income and estimated income or a low confidence in the projected income may indicate that the consumer provided information for a non-primary bank account, the user's financial circumstances have changed (e.g., a raised or reduced income not reflected in the estimated income) or other event has occurred. Therefore, in accordance with one embodiment, the projected income is only used as the predicted income if the projected income is within a statistical range of the estimated income, say one standard deviation, or above a confidence threshold. The statistical range or confidence threshold may be selected based, for example, on business rules or a machine learning model.

While, in the above examples, the income prediction models comprise a limited set of rules, the income prediction models may be arbitrarily complex and rely on data from additional or alternative sources. The income predication model may comprise a machine learning model trained over sets of data and that becomes increasingly accurate with additional data or adjusts as data trends change.

An income prediction model may contextualize data analysis. For example, one piece of information (or combination thereof) may be analyzed differently depending on the results of analyzing another piece of information (or combination thereof). The data returned by one information provider system 120 may be analyzed differently based on the results of evaluating data from another information provider system 120.

With respect to FIG. 8, vehicle data application 150 can load income verification rules 553 (step 800) and determine the data from information provider systems 120 needed to execute the rules (step 802). This may include determining any data required by an income prediction model. For example, if the verified income rule specifies:
verified_monthly_income=min(monthly_self_reported_income,model_income)
   vehicle data application 150 will fetch the data required by the prediction model to determine model_income. Using the above examples of rules-based income prediction models in which the estimated income is a CreditVision score and the projected income is provided by Plaid, vehicle data application 150 will determine that a Plaid report and a TransUnion credit report that includes a CreditVision score are required.

Vehicle data application 150 can provide PII (e.g., user name, user address, user phone number, user email address, date of birth, driver's license number or other PII, financial institution information, such as a Plaid token, or other information) from the application to one or more income projection services and income estimation services, receive responsive income verification data, and apply an income prediction model and income verification rules to income verification data to determine a verified income.

At step 804, vehicle data application 150 determines if the application includes the inputs required to fetch the projected income data from an information provider system 120 or cache (e.g., fetch a Plaid report for the user). If not, an error can be generated. Vehicle data application 150 may generate a decision response to client application 114 to cause client application 114 to request the additional information necessary to fetch the projected income data.

If vehicle data application 150 has the information necessary to fetch the projected income data, vehicle data application 150 can fetch the data from cache (if available and not stale) or use the API for the service providing the projected income data to submit user application data and fetch the projected income data (step 806). As one non-limiting example, vehicle data application 150 can supply a Plaid token to the Plaid service and request a Plaid report associated with the token. If the attempt to fetch the projected income data fails, vehicle data application 150 can generate an error. Vehicle data application 150 may generate a decision response to cause the client application to prompt the user to try again later or take another action.

At step 808, vehicle data application 150 determines if the application includes the inputs required to fetch the income estimation data from an information provider system 120 or cache. If not, an error can be generated. Vehicle data application 150 may generate a decision response to client application 114 to cause client application 114 to request the additional information necessary to fetch the income estimation data.

If vehicle data application 150 has the information necessary to fetch the income estimation data corresponding to the application 502, vehicle data application 150 may fetch the data from cache (if available) or use the API for the service providing the income estimation data to submit application data from application 502 and fetch the income estimation data (step 810). As one non-limiting example, vehicle data application 150 can supply PII from application 502 to retrieve a TransUnion credit report containing a CreditVision score for the user. If the attempt to fetch the income estimation data fails, vehicle data application 150 can generate an error. Vehicle data application 150 may generate a decision response to cause the client application to prompt the user to try again later or take another action.

At step 812, vehicle data application 150 can apply an income prediction model to generate a predicted monthly income (model_income). If an error occurs, vehicle data application 150 may generate a decision response to client application 114 to cause client application 114 to request the additional information necessary to fetch the income estimation data. At step 814, vehicle data application 150 applies the income verification rules 553 to generate a verified income using one or more of the estimated income, projected income or predicted income.

The income verification rules 553 may further include conditions applied to the verified income. For example, rules may specify a threshold verified income, for example:
If:
   verified_monthly_income>income_threshold
   Pass
Else:
   Fail
      where income_threshold is a configurable monthly income threshold, say $3000 or other threshold.

If the application passes the additional verified income checks, if any, the verified income can be added to application 502 and the approval process proceeds. If the application does not pass, vehicle data application 150 can deny the application. Vehicle data application 150 can update the application 502 with the reason for the denial and generate a decision response to client application 114 to cause client application 114 to request additional information or terminate the approval process.

With respect to FIG. 9, vehicle data application 150 can load income verification rules 553 (step 900). In the embodiment of FIG. 9, the income verification rules may specify conditions under which an income prediction is required. For example, verification rules 553 may specify that an income prediction is required if the user failed to pass identity verification step 532 or some other condition is met with respect to the application 502. At step 902, vehicle data application 150 determines whether an income prediction is required. If an income prediction is not required, the method proceeds to step 904. Otherwise, the method proceeds to step 950.

At step 904, vehicle data application 150 can select a first set of income verification rules that do not require an income prediction and determine the data from information provider systems 120 needed to execute the rules (step 904). As an example, a first set of income verification rules may be:
if self_reported_income<estimated_income
   return self_reported_income
else if self>estimated_income * y
   return estimated_income *y
else
   use average(self_reported_income, estimated_income)
      where ‘y’ can be configured in the rules. In this example, ‘y’ may be selected based on any number of considerations. According to one embodiment, ‘y’ may be from 1-3. For example, ‘y’ may be 1.5, 1.75, 2.0 or other factor. In any event, these example rules do not require determining a predicted income, but uses the self-reported income from application 502 and an estimated income from an income estimation service.

Continuing with step 904, vehicle data application 150 can determine that an estimated income is required. Using the example in which the estimated income is a CreditVision score, vehicle data application 150 can determine that a TransUnion credit report that includes a CreditVision score are required.

Vehicle data application 150 will fetch the data required by the income verification rules 553. Using the above examples, vehicle data application can fetch an estimated income score from an information provider system 120 or cache (if available). Vehicle data application 150 can provide PII (e.g., user name, user address, user phone number, user email address, date of birth, driver's license number or other PII, financial institution information) to income estimation services, receive responsive income verification data, and apply the income verification rules to income verification data to determine a verified income.

At step 906, vehicle data application 150 determines if the application 502 includes the inputs required to fetch the income verification data from cache or an information provider system 120. If not, an error can be generated. Vehicle data application 150 may generate a decision response to client application 114 to cause client application 114 to request the additional information necessary to fetch the projected income data.

If vehicle data application 150 has the information necessary to fetch the income verification data, vehicle data application 150 fetch the data from cache (if available and not stale) or use the API for the service providing the income verification data to submit user application data and fetch the income verification data (step 908). As one non-limiting example, vehicle data application 150 can supply PII from application 502 to retrieve a TransUnion credit report containing a CreditVision score for the user. If the attempt to fetch the income verification data fails, vehicle data application 150 can generate an error. Vehicle data application 150 may generate a decision response to cause the client application to prompt the user to try again later or take another action.

At step 910, vehicle data application 150 applies the income verification rules 553 to generate a verified income using one or more of the estimated income, projected income or self-reported income. The verified income can be added to application 502.

If the application passes the additional verified income checks, if any, the verified income can be added to application and the approval process proceeds. If the application does not pass, vehicle data application 150 can deny the application. Vehicle data application 150 can update the application 502 with the reason for the denial and generate a decision response to client application 114 to cause client application 114 to request additional information or terminate the approval process.

Turning to FIG. 9B, vehicle data application 150 can determine a second set of income prediction rules and determine the data from information provider systems 120 needed to execute the rules (step 950). This may include determining any data required by an income prediction model. As an example, a set of income verification rules may specify:
if estimated_income<model_income:
   use self_reported_income
else if self_reported_income>z * model_income
   use model_income * z
else
   use average(self_reported_income, model_income)
      where ‘z’ is configured in the rules. In the foregoing example, ‘z’ may be selected based on any number of considerations. ‘z’, according to one embodiment, is 1-2 (e.g., 1.25, 1.5, 1.75, 2 or other number). From these rules, vehicle data application 150 can determine that a model_income is required. Using the above examples of rules-based income prediction models, the CreditVision score as the estimated_income and the plaid_income as the projected_income, vehicle data application 150 will determine that a Plaid report and a TransUnion credit report with a CreditVision score are required.

Vehicle data application 150 can provide PII (e.g., user name, user address, user phone number, user email address, date of birth, driver's license number or other PII, financial institution information, such as a Plaid token, or other information) from the application to one or more income projection services and income estimation services, receive responsive income verification data, and apply an income prediction model and income verification rules to income verification data to determine a verified income.

At step 954, vehicle data application 150 determines if the application 502 includes the inputs required to fetch the projected income data from cache or an information provider system 120 (e.g., fetch a Plaid report for the user). If not, an error can be generated. Vehicle data application 150 may generate a decision response to client application 114 to cause client application 114 to request the additional information necessary to fetch the projected income data.

If vehicle data application 150 has the information necessary to fetch the projected income data, vehicle data application 150 can fetch the data from cache (if available and not stale) or use the API for the service providing the projected income data to submit user application data and fetch the projected income data (step 956). As one non-limiting example, vehicle data application 150 can supply a Plaid token to the Plaid service and request a Plaid report associated with the token. If the attempt to fetch the projected income data fails, vehicle data application 150 can generate an error. Vehicle data application 150 may generate a decision response to cause the client application to prompt the user to try again later or take another action.

At step 958, vehicle data application 150 determines if the application includes the inputs required to fetch the income estimation data from cache or an information provider system 120. If not, an error can be generated. Vehicle data application 150 may generate a decision response to client application 114 to cause client application 114 to request the additional information necessary to fetch the income estimation data.

If vehicle data application 150 has the information necessary to fetch the income estimation data corresponding to the application 502, vehicle data application 150 may fetch the data from cache (if available and not stale) or use the API for the service providing the income estimation data to submit application data from application 502 and fetch the income estimation data (step 960). As one non-limiting example, vehicle data application 150 can supply PII from application 502 to retrieve a TransUnion credit report containing a CreditVision score for the user. If the attempt to fetch the income estimation data fails, vehicle data application 150 can generate an error. Vehicle data application 150 may generate a decision response to cause the client application to prompt the user to try again later or take another action.

At step 962, vehicle data application 150 can apply an income prediction model to generate a predicted monthly income (model_income). If an error occurs, vehicle data application 150 may generate a decision response to client application 114 to cause client application 114 to request the additional information necessary to fetch the income estimation data. At step 964, vehicle data application 150 applies the income verification rules 553 to generate a verified income using one or more of the estimated income, projected income or predicted income.

If the application passes the additional verified income checks, if any, the verified income can be added to application and the approval process proceeds. If the application does not pass, vehicle data application 150 can deny the application. Vehicle data application 150 can update the application 502 with the reason for the denial and generate a decision response to client application 114 to cause client application 114 to request additional information or terminate the approval process.

The embodiment of FIG. 9 provides the advantage that some users are not required to supply bank account login information or detailed financial transaction data to verify income. For example, if a user's application proceeds to step 904, the user is not required to provide information such as illustrated in FIG. 4G and FIG. 4H to verify income. However, if a user's application proceeds to step 950, the user may be required to provide bank account login information or detailed financial transaction data to verify income.

As can be seen from the foregoing examples of income verification rules and income prediction models, vehicle data application 150 may leverage information from various information provider systems 120 to determine a verified income for the user. While specific examples are provided for understanding, the income verification rules may be complex and rely on data from additional or alternative sources.

Returning to FIG. 5, at step 562 vehicle data application 150 applies affordability rules 563 to determine an affordability score based on a consumer's ability to afford monthly (or other periodic) payments. According to one aspect of the present disclosure, the computer system may facilitate efficient financing approval by approving financing based on the consumer's ability to afford a periodic obligation (e.g., monthly payment) rather than on loan-to-value ratio (LTV). The computer system can apply rules/models (including, in some embodiments, machine learning models) to the consumer's financial data to determine an affordability score that determines a periodic payment that an intermediary (financing provider) will approve for the consumer.

Vehicle data application 150 can interact with one or more financial institutions, credit reporting agencies, income estimation services (which can be examples of information provider systems 120) or other information to collect information about a user's income and debts to verify income and determine affordability. Automotive data processing system 100 may perform one or more income tests to ensure that a consumer meets minimum income qualifications.

In determining affordability, vehicle data application 150 can interact with one or more financial institutions, credit reporting agencies, income estimation services (which can be examples of information provider systems 120) or other information to collect information about a user's income and debts to verify income and determine affordability.

Embodiments of automotive data processing system 100 can determine affordability without relying on LTV. In general, the affordability evaluation can use income and debt information for the consumer to determine how large of a monthly payment the user can afford. The affordability score thus provides a prediction of the amount that the consumer can fairly pay to underwrite a loan on a monthly (or other periodic) basis. The monthly payment determined by the affordability decision may be scaled based on debt obligation.

In accordance with one embodiment, affordability may be based on income, debt-to-income ratio (DTI), payment-to-income ratio (PTI) and other factors. In general, the affordability score determination can be used to determine a maximum monthly payment that does not exceed a maximum PTI and when added to the consumer's current obligations does not cause the obligations do not exceed a maximum DTI. The maximum DTI and PTI may be set by rules, through modeling or through other mechanism.

As part of determining a fair affordable monthly payment, the rules or model used to determine affordability may take into account additional costs associated with a purchased asset. For example, if a consumer is purchasing a vehicle, the affordability score may be calculated to leave room in the consumer's monthly budget for items such as gas and regular maintenance and thus the affordable monthly payment determined for the consumer can be selected to allow the consumer to underwrite the loan while paying for other expected costs associated with the vehicle (e.g., insurance, maintenance, gas).

In accordance with one embodiment then, vehicle data application 150 applies affordability rules 563 to predict the monthly payment a consumer can afford from information provided by information provider systems 120. Thus, the affordability determination can be used to determine that the consumer can pay a maximum of $X a month. As discussed below, this value can be used to filter inventory items such that the user can only purchase items within his or her affordability.

If there is insufficient application data to determine an affordability score, vehicle data application 150 may generate a decision result 568 indicating that the application was not approved. Furthermore, vehicle data application 150 may send a decision response to client application 114 indicating that the application was not approved and the reason the application was not approved. Client application 114 can display one or more pages indicating why the application was not approved and, in some cases, request additional information.

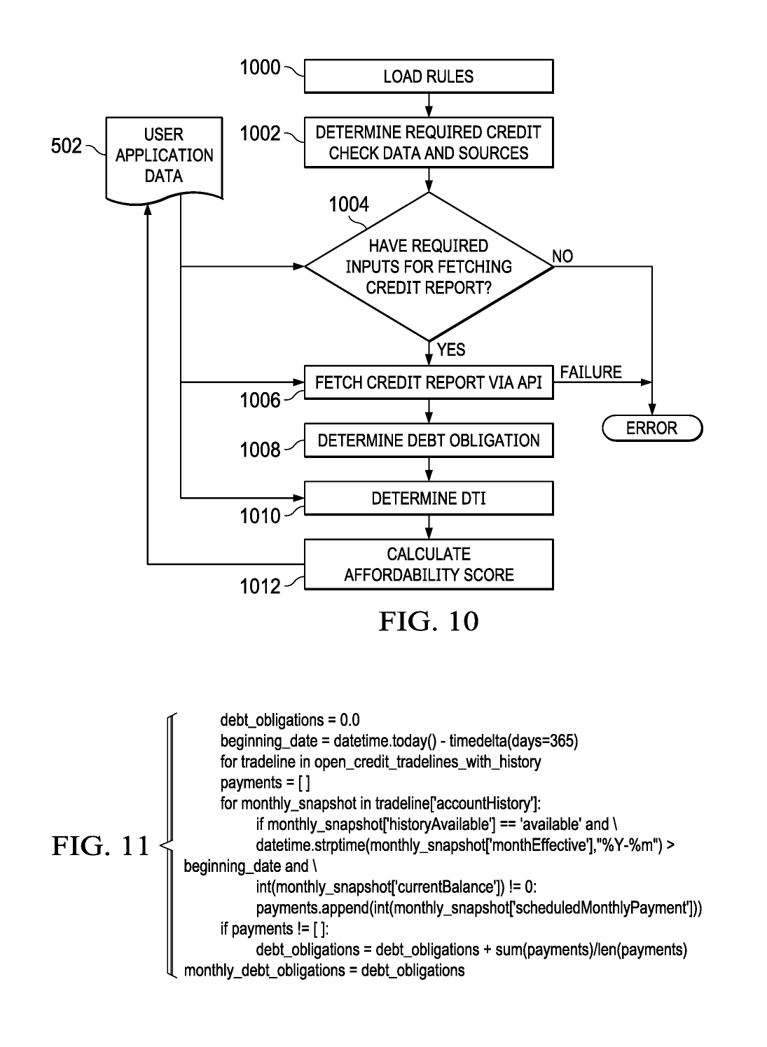

FIG. 10 is a flow chart illustrating one embodiment of an affordability determination (step 562). Vehicle data application 150 can load affordability rules 563 (step 1000) and determine the affordability data from information provider systems 120 needed to execute the rules (step 1002). This may include determining any data required by an income prediction model.

The affordability determination may rely on credit reports from one or more credit reporting agencies. Thus, vehicle data application 150 can be configured to fetch credit report data for a user. As discussed above, a credit report may already have been fetched (e.g., in the credit check or income verification steps). Thus, vehicle data application 150 may fetch the credit report from cache. In other embodiments, vehicle data application 150 can provide PII (e.g., user name, user address, user phone number, user email address, date of birth, driver's license number or other PII, financial institution information or other information) to one or more credit reporting agencies, receive responsive income verification data, and apply an income prediction model and income verification rules to income verification data to determine a verified income.

At step 1004, vehicle data application 150 determines if the application 502 includes the inputs required to fetch a credit report (or other credit check data) from an information provider system 120 or cache, such as a credit reporting agency. If not, an error can be generated. Vehicle data application 150 may generate a decision response to client application 114 to cause client application 114 to request the additional information necessary to fetch the credit report.

If vehicle data application 150 has the information necessary to fetch the credit report corresponding to the application 502, vehicle data application 150 may use the API for the credit reporting agency to submit user application data, such as PII, and fetch the credit report (step 1006). If a failure occurs when pulling the credit report, vehicle data application 150 may generate an error.

At step 1008, vehicle data application 150 determines a debt-to-income ratio based on the credit report and verified_monthly_income associated with the application 502. According to one embodiment, a monthly debt obligation can be determined from a credit report for the user. One example of pseudo-code for determining a monthly debt obligation (monthly_debt_obligations) from a credit report is illustrated in FIG. 11, though other methods may be used.

At step 1010, vehicle data application 150 determines a debt-to-income ratio (DTI) for the user. For example, according to one embodiment, DTI can be determined as follows:
current_dti_ratio=monthly_debt_obligations/verified_monthly_income

At step 1012, vehicle data application 150 applies the affordability rules to determine an affordability score the user (maximum_monthly_payment). According to one embodiment, that maximum monthly payment can be determined as follows:
non_adjusted_max_payment=min(verified_monthly_income*maximum_pti, fair_maximum_monthly_payment_cents)
if ((non_adjusted_max_payment+monthly_debt_obligations)/verified_monthly_income)>maximum_dti:
   maximum_monthly_payment=(maximum_dti−current_dti_ratio)*verified_monthly_income
else:
maximum_monthly_payment=non_adjusted_max_payment
   where:
maximum_PTI is the maximum payment-to-income ratio set for automotive data processing system;
fair_maximum_monthly_payment_cents is a maximum allowable monthly payment set for the automotive data processing system;

maximum_dti is the maximum DTI permitted by the automotive data processing system. In some embodiments, the maximum DTI can be set based on verified statistics, such as those provided by the Bureau of Labor Statistics number on how much individuals pay for personal transportation. If, the maximum DTI will not be exceeded when the non_adjusted_max_payment is added to the consumer's obligations, then the maximum payment for the consumer can be set to the non_adjusted_max_payment.

Vehicle data application 150 may further determine a suggested affordability score. In one embodiment, for example, a suggested monthly payment can be determined based on, for example, a suggested PTI:
suggested_monthly_payment=min(verified_monthly_income * suggested_pti, maximum_monthly_payment)
   where suggested_pti is a suggested PTI set in the vehicle data application 150.

The affordability score may allow the intermediary to loan more than the value of an underlying item being purchased (e.g., a vehicle or other item) can back. For example, based on the affordability score, the intermediary may provide funding to allow a consumer to purchase a vehicle in combination with products that cannot be used as security, such as maintenance contracts, warranties, fuel contracts, etc. Thus, the loan may only be partially secured by an asset, such as a vehicle.

According to one embodiment, automotive data processing system 100 can use information from information provider systems 120 to determine the consumer's DTI based on the consumer's monthly debt obligation and income (e.g., verified income). The monthly debt obligation for a consumer can be determined by, for example, analyzing the consumer's credit report, such as credit report data provided by TransUnion or other credit reporting agency.

In some embodiments, automotive data processing system 100 may include an affordability model configured to set an upper limit on the user's affordability. The affordability model can be trained over sets of data through machine learning and may become increasingly accurate with additional data. The affordability model may contextualize data analysis. For example, one piece of information (or combination thereof) may be analyzed differently depending on the results of analyzing another piece of information (or combination thereof). The data returned by one information provider system 120, for example, may be analyzed differently based on the results of evaluating data from another information provider system 120.

In any event, the intermediary may enter into a contract with the consumer to finance purchasing of goods and services based on the affordability score. In accordance with one embodiment, the intermediary may contract to finance the purchase of illiquid assets or other assets that can be used for security in combination with other goods or services up the an amount such that the consumer's monthly debt obligation under the contract will not exceed the maximum monthly payment, and more preferably, will not exceed the suggested monthly payment, as determined from the affordability analysis. For example, the intermediary may finance the purchase of a vehicle in combination with the purchase of a maintenance contract or warranty. In this example, the value of the vehicle may act as security for a portion of the debt obligation to the intermediary.

As discussed above, embodiments described herein can provide a low friction interface for registration and loan approval. Various steps of the approval process discussed above can be implemented to minimize the amount of time required for approval. For example, automotive data processing system 100 may request information from the various information provider systems 120 simultaneously, thus avoiding the need to wait between each step to obtain information from systems 120 for subsequent steps.

Furthermore, embodiments described herein eliminate much of the delay often associated with seeking financing. Part of the delay introduced by financing stems from the methods by which conventional loans are approved. Conventionally, loan providers use a loan-to-value ratio (LTV) (ratio of the loan to the value of the asset purchased) to approve loans for illiquid assets (or other assets that can act as security). Generally, the value of the asset must be sufficient to secure the entire loan even if the purchase includes items that cannot be secured (e.g., service contracts). As such, the loan approval process requires that a consumer know, prior to applying for financing, the value of the asset being purchased, its price, and their down payment or cap cost reduction. Consequently, financing often does not happen until a consumer and seller agree on a price and down payment/cap cost reduction for an asset (e.g., a consumer and dealer agree on a price for a specific car). Automotive data processing system 100 on the other hand does not require knowledge of which vehicle the user will purchase to approve financing because automotive data processing system 100 can generate an affordability score without using LTV.

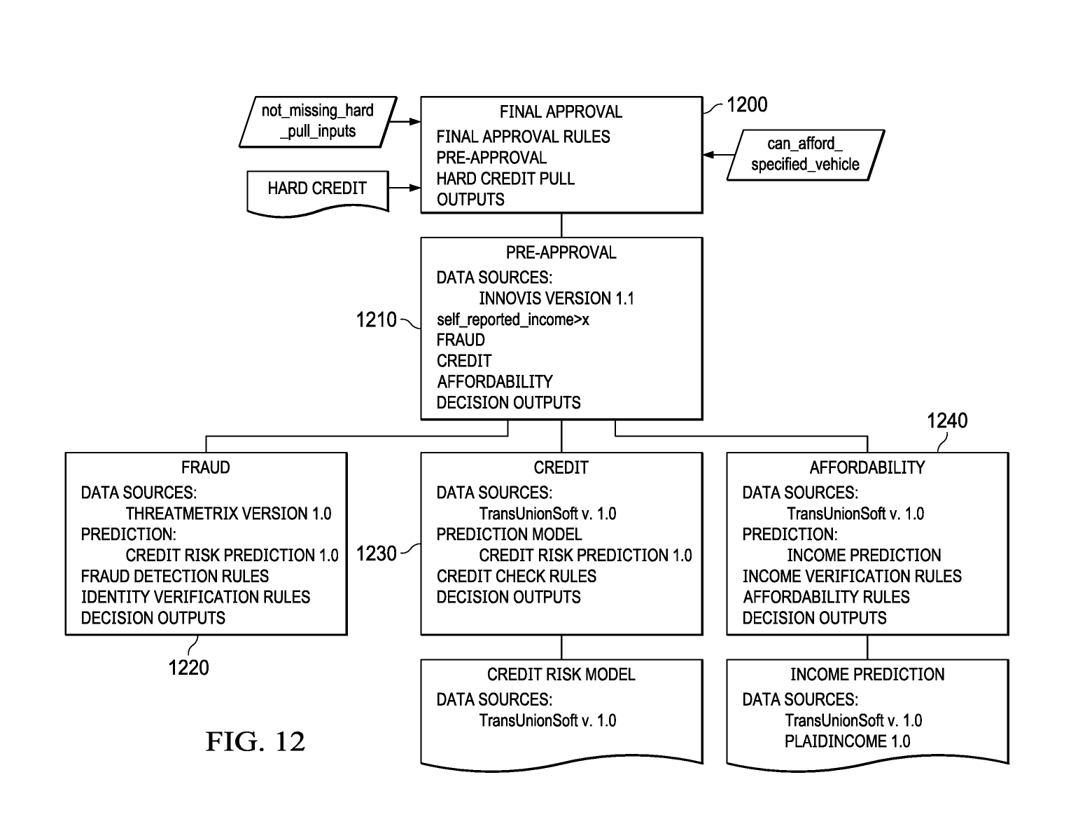

As discussed above, the approval rules 140 (e.g., fraud detection rules 523, identity verification rules 533, credit check rules 543, income verification rules 553 and affordability rules 563) may be implemented as decisions executed by decision service 250. FIG. 12 is a diagrammatic representation of a set of decisions and prediction models according to one embodiment.

In the embodiment depicted, the decision service 250 can execute a final approval decision 1200, pre-approval decision 1210, a fraud decision 1220, a credit check decision 1230 and an affordability decision 1240. The decision service may receive a call to execute any of the decisions. However, a decision may reference one or more sub-decisions. For example, final approval decision 1200 references pre-approval decision and pre-approval decision 1210 references fraud decision 1220, credit decision 1230 and affordability decision 1240. A decision may contain rules applicable to the results of the sub-decisions.

In response to a request for a pre-approval decision (e.g., from user application service 210), the decision service can process the tree beginning at the node for the requested decision and including the sub-decisions, through n number of levels of decisions. Using the example of FIG. 12, the decision service 250, responsive to a request for a pre-approval decision, may execute the sub-decisions in the order that they are referenced in pre-approval decision. According to one embodiment, decision service 200 traverses the tree in a depth-first fashion. Responsive to a request for a final approval decision, which may occur later in the purchase process, the decision service 250 may reprocess the pre-approval along with executing other rules in the final approval decision 1200.

A decision may include a set of decision rules. The decision rules may apply conditions to input data from a user application, the output of a sub-decision, a prediction from a prediction model or data from a data source. For example, pre-approval decision 1210 may include initial checks and a rule that requires an application to pass each sub-decision to pass pre-approval decision. Fraud decision 1220, in the embodiment illustrated includes fraud detection rules and identity verification rules, credit decision 1230 includes credit check rules and affordability decision 1240 includes income verification rules and affordability rules. A decision may also specify the decision outputs, for example, decline codes that are output or scores that are passed.

As discussed earlier, a decision may reference a data source defined by decision service 250. For example, fraud decision 1220 references a data source for Threatmetrix data. In addition, the decisions may reference prediction models. For example, credit decision 1230 references a credit risk prediction and affordability decision references an income prediction. The prediction models may further reference data sources.

The decision service 250 can be configured to walk the tree, determine all the data sources required to approve a consumer and pre-fetch or not data for decisions further in the decision tree based on configuration. For example, responsive to a request for a pre-approval decision, decision service 250 walk the tree comprising pre-approval decision 1210, fraud decision 1220, credit check decision 1230 and approval decision 1240, determine the data sources required for the decisions, including communicating with prediction and modeling service 260 to determine the data sources required for the prediction models referenced by the decisions, and fetch the data sources from data vendor service 270.

In another embodiment, decision service 250 can be configured to wait to fetch a data source until processing a decision or requesting a predication that uses the data source. For example, responsive to a request for a pre-approval request, decision service 250 may execute the pre-approval decision, moving to the fraud decision 1220 prior to the other sub-decisions. If an application does not pass the fraud decision 1220, decision service 250 may return the appropriate decline codes and terminate the process. In this configuration and example, the decision service will not reach the credit decision 1230 and, therefore, will not fetch the data source referenced in credit decision 1230.

In one embodiment, the decision service 250 may be configured to wait to pull certain data, due to processing or financial cost, until the consumer has otherwise passed decisions in the decision tree. For example, because final decision 1200 references the sub-decision 1210 before initiating a hard credit pull, decision service 250 can wait for decision 1210 to be fully executed before pulling hard credit data. In yet another embodiment, data may be pulled based on the amount of time it takes to pull certain types of data.

Furthermore, the data sources, models, etc. loaded at one level of the tree may be available to sub-decisions further down the tree. For example, because preapproval decision 1210 references the data source Innovis Version 1.1, this data source is implicitly available to fraud decision 1220, credit decision 1230 and affordability decision 1240. The sub-decisions may or may not reference the data sources again. By selecting the order of statements in a decision and the arrangement of decisions in a decision tree, the decision engine can be configured to wait to pull certain data, due to processing or financial cost, until the consumer passes earlier decisions.

If a consumer application is approved through the pre-approval process, the application may be enhanced with one or more affordability scores and credit risk scores. FIG. 4I, for example, illustrates an example of an application page displaying an affordability score for a user. According to one embodiment, the user may use the client applications 114 to search and purchase vehicles.

The vehicles made available for purchase through automotive data processing system 100 are screened to determine which ones are priced appropriately to qualify as candidates to be put into system. Automotive data processing system 100 then determines payment schedules for the vehicles. The determination of a payment schedule may depend on a pricing model.

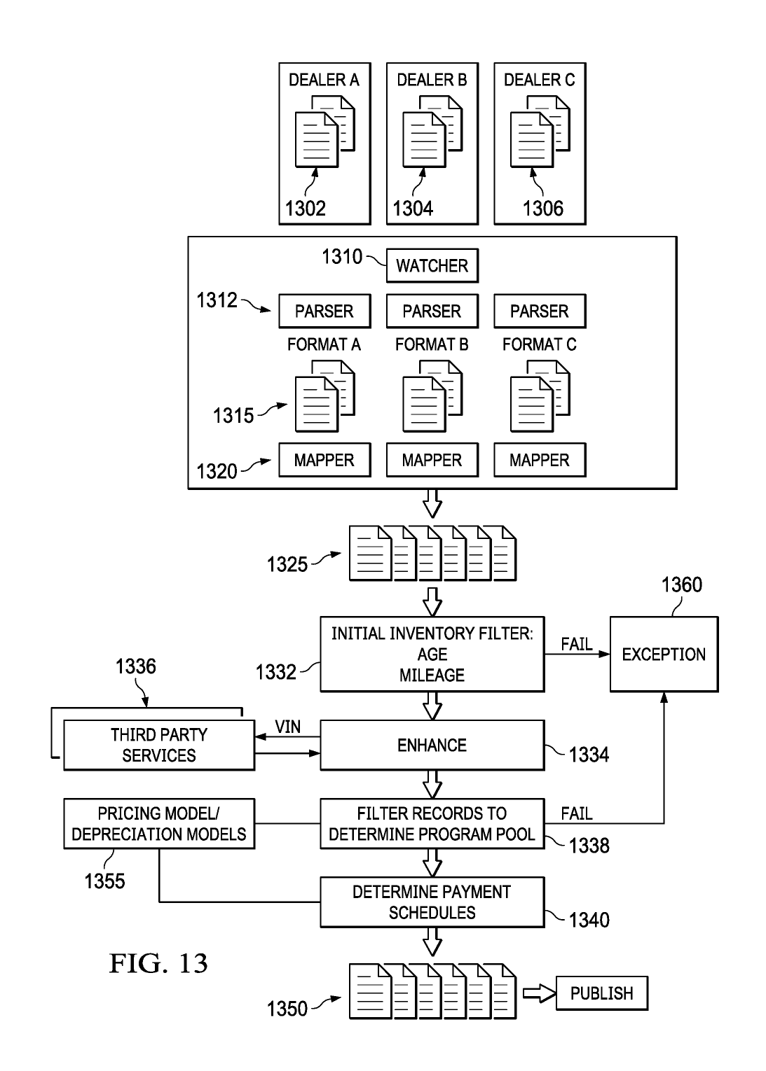

FIG. 13 is a block diagram illustrating one embodiment of inventory processing that may be performed by automotive data processing system 100. More particularly, according to one embodiment, inventory module 164 or inventory service 230 may perform inventory processing.

Automotive data processing system 100 receives inventory feeds from DMS 122, inventory systems 124 or via other channels. For example, automotive data processing system 100 may receive inventory files (such as CSV files) from various dealers uploaded to an FTP site. In other embodiments, automotive data processing system may collect inventory information by making appropriate API calls to a DMS 122 or inventory system 124.

The inventory feeds include inventory data for inventory associated with registered (on boarded) dealers and pricing information. Different dealers or DMS systems, however, may use different data formats. Automotive data processing system 100 can apply rules to extract inventory information from the various feeds and normalize the data into an internal format.

An inventory feed record, which may include information from one or more sources, can include information such as a VIN, segment, manufacturer, model, model year, trim level, engine displacement, drive type, series lifecycle, vehicle condition, geographical region, type of sale, options, color, remaining OEM or CPO warranty coverage, dealer asking price, dealer odometer reading, dealer description of the vehicle. It may be noted that, in some cases, an inventory feed record may only provide a limited amount of information, such as VIN, year/make/model, dealer odometer reading, dealer asking price. As discussed below, the inventory data from an inventory feed may be enhanced with data from other network locations.

Different dealers or DMS systems may use different data formats. Automotive data processing system 100 can apply rules to extract inventory information from the various feeds and normalize the data into an internal format. For each VIN, the automotive data processing system 100 can create a normalized inventory feed record 1350.

In the illustrated example, dealer A uploads inventory files 1302 in a first format to a first FTP site, dealer B provides inventory files 1304 in a second format to a second FTP site and dealer C uploads inventory files 1306 in a third format to a third FTP site. According to one embodiment automotive data processing system 100 can comprise a watcher process 1310 that watches for new inventory feed events, such as a file being uploaded to an FTP site, and initiates a processing job to process the inventory feed records. Thus, processing jobs can begin as soon as an inventory file is uploaded.

Based on watcher 1310 determining that a new inventory file has been uploaded or an inventory feed otherwise received, vehicle data application 150 can read and process the feed. According to one embodiment, vehicle data application 150 can be configured to parse the CSV files (or other input data) to extract inventory feed records for individual vehicles. Therefore, vehicle data application 150 may include parsers 1312 dedicated to each input format and configured to parse out individual inventory feed records 1315 from inventory files. Moreover, vehicle data application 150 can include format mapping modules 1320 configured to map extracted inventory feed records from different dealer formats into inventory records in a normalized internal format. For example, each mapping module may be configured to extract delimited data from CSV records and map the delimited data to normalized fields to create normalized inventory feed records 1325.

Rules may be applied to filter out inventory items for which the asking price is above a particular maximum price, vehicles outside of particular geographic regions or based on other criteria. In particular, automotive data processing system 100 can filter the inventory data to create a program pool of inventory items for which competitive payments that account for deprecation can be accurately established. The inventory rules may include a set of “fair value” filters configured to ensure that for each vehicle in the program pool i) there is sufficiently reliable residual value data for the vehicle for the expected life of an ownership agreement, plus a reasonable margin of error; ii) the vehicle is priced at a point that reasonably reflects fair market value and allows a payment schedule to be established that is competitive; iii) the vehicle remains affordable to the consumer through the predicted life of an ownership agreement; iv) the vehicle is fairly priced to the consumer such that all customers are protected against buying a car that is objectively overpriced and such that the need for negotiation is removed.

To this end, vehicle data application 150 may apply initial inventory filter rules 1332. Initial inventory filter rules 1332 may include rules to filter out records based on a variety of factors. An initial set of filters may filter out inventory records with incomplete or duplicative data or based on selected criteria (such as, but not limited to age, mileage, maximum price). For example, a filter rule can be established to filter out vehicles of greater than 4 model years old or other age limit. As another example, a filtering rule may filter out vehicles based on a maximum mileage threshold, for example, 30,000, 50,000 or other mileage. Different age and mileage caps may be set for different vehicles depending on, for example, the reliability of the vehicle year/make/model, remaining warranty or other factors. As another example, vehicle data application 150 may filter out new vehicles.

For inventory feed records that are not filtered out at step 1332, automotive data system 100 can create an inventory record for the respective vehicle (VIN) or, if an inventory record for the VIN exists in system 100 already, update the inventory record for the vehicle.

At 1334, the automotive data processing system 100 interfaces with one or more distributed information provider systems 120 to enhance the inventory record. For example, automotive data processing system 100 may use APIs to collect relevant data from a number of third party services 1336. Note that each API call may be associated with a staleness check. A particular set of enhanced inventory data is not collected again for a vehicle unless the data is considered stale. When enhanced inventory data is collected for a VIN, the inventory record for a VIN may be updated with the date at which data was collected from the particular service 1336.

According to one embodiment, automotive data system 100 can send a VIN (and some cases additional data) to one or more automotive description service information provider systems 120, receive information associated with each VIN in response and enhance the inventory record for the VIN based on the received information. For each VIN in an inventory feed, automotive data processing system 100 can check when description service data from the automotive description service information provider was last checked (if ever) for that VIN and if the information for that VIN is not stale (e.g., was checked within the last x days by automotive data processing system 100), request the description information from the automotive description service. Automotive description services can provide information such as year, make, model, trim, style, color, technical specifications, standard equipment, installed options for a VIN, stock images for the make/model/trim and other information. One example of an automotive description service is the ChromeData service provided by Autodata, Inc. of Portland, Oreg.

Automotive data processing system 100 can further enhance an inventory record with vehicle history data. According to one embodiment, automotive data processing system 100 may obtain vehicle history reports from a vehicle history information system (which can be an example of an information provider system 120). For example, Carfax, Inc. of Centreville, Va. provides a vehicle history reporting service. As another example, Experian provides the Autocheck vehicle history report service. For each VIN in an inventory feed, automotive data processing system 100 can check when vehicle history data from the vehicle history reporting service was last checked (if ever) for that VIN and if the information for that VIN is not stale (e.g., was checked within the last y days by automotive data processing system 100), request the vehicle history information system.

Automotive data processing system 100 can further enhance a vehicle inventory record with a current value. For example, various third party information provider systems 120 provide trim matching services that provide a current wholesale value based on year/make/model/trim and odometer reading. For example, Manheim Auctions, Inc. of Atlanta, Ga. (“Manheim”) provides current wholesale values for vehicles based on year/make/model/trim and odometer (known in the industry as the Manheim Market Report (MMR)). Manheim can also provide historical wholesale values (2 weeks ago, 4 weeks ago, 2 months ago, 6 months ago, etc.) Similarly, Kelley Blue Book of Irvine, Calif. provides current wholesale values for vehicles. Automotive data processing system 100 can check when wholesale value data from the wholesale pricing system was last checked (if ever) for that VIN and odometer reading and if the information for that VIN and odometer reading is not stale (e.g., was checked within the last z days by automotive data processing system 100), request the wholesale pricing information for that vehicle using, for example, the VIN and current odometer reading from the inventory record.

Based on the enhanced inventory records, automotive data processing system 100 can further filter vehicles to determine vehicles in the program pool. Examples of additional fair value filters that can be applied include, by way of example:

Model/trim: A wholesale pricing system may not have a current value for a particular year/make/model/trim. Vehicles for which the wholesale pricing system does not return a current value can be filtered out. Furthermore, automotive data processing system 100 can filter out a vehicle if there is insufficient data to match the vehicle to a pre-determined residual value curve (discussed below).

Vehicle history: Vehicles may be filtered based on vehicle history. Rules can be applied to the vehicle history information to exclude vehicles. Rules may be established to exclude vehicles based on, for example, accidents, airbag deployment, structural damage, branded title or other title marks, odometer info or other items.

Price: In some embodiments, vehicles can be filtered based on price. The intermediary may only wish to offer vehicles that are priced near fair market value at sale. As such, rules may be established to filter out vehicles that, according to the rules, are over-priced. Price filtering may be based, for example, on wholesale value. In one embodiment, for example, automotive data processing system may filter out vehicles that exceed the wholesale value for the vehicle configuration (e.g., make/model/year/options/mileage, etc.) by a specified dollar or percentage cap.

A rule can be established such the vehicles must be priced within a set % cap (e.g., 110-120% or other percentage) or dollar value of a trusted price index such as “above [average condition] MMR” price or other wholesale values indicated for the vehicle configuration (“above MMR” is a metric known in the industry that considers vehicle condition in the valuations). The price filter helps ensure that each vehicle is priced close to the residual value model (or other model) for that vehicle at the beginning and that consumers are not overpaying for vehicles. In addition, a price filter may be applied to filter out vehicles that are priced too low compared to a trusted index.

In another embodiment, the vehicle year/make/model/trim, odometer reading can be input into a pricing model (discussed below) to determine a current value (0 term) based on the pricing model to determine a model-based current value. Rules can be implemented to filter out vehicles that are not within thresholds (percentage or dollar value) of the model-based current price.

In accordance with one embodiment, records that do not meet the filter criteria applied at 1332 and 1338 can be added to a queue of exceptions 1360. These exceptions may be made available to a dealer so that the dealer understands why a vehicle failed to be placed in the program pool. For example, vehicles offered by a dealer that exceed the price limit set for the price filter but otherwise pass the filtering rules (the “price excluded set”) can be displayed to dealer in the dealer portal. The maximum price allowed by the price filter may also be displayed for each vehicle. The dealer can see their price and the maximum price allowed by the filter for each vehicle and may be given the option to “Set Price To Max” to set the price on any particular vehicle or their entire price excluded set to the corresponding maximum price. Vehicles set at maximum filter price can be included in the next update.

A number of the above-referenced filters may be applied to pre-filter inventory before accepting the inventory into the system or before displaying an inventory item to a consumer. Additional filters may also be applied to post-filter inventory records after inventory records have entered the system. For example, in one embodiment, automotive data processing system 100 may obtain a more detailed vehicle history report when a user selects a particular vehicle and filter the vehicle based on the additional vehicle history report information. In one embodiment, automotive data processing system may obtain additional vehicle history report information from the Autocheck service and apply rules to remove a vehicle based on one or more of title issues, deployed airbag, major accident, auction notes, exterior/weather/fire/water damage, theft, repossession or other items.

According to one embodiment then, the inventory records stored by automotive data processing system 100 can include inventory records that passed the pre-filters and have not been eliminated by a post-filter and inventory records that passed all the pre-filters except price and have not been eliminated by a post-filter.

At 1340, automotive data processing system 100 is configured to apply payment models/depreciation models 1355 to determine initial and monthly payments for vehicles in a program pool where the payments are selected to achieve desired metrics. In accordance with one embodiment, the payments may be selected to allow the user to return a vehicle at any time while still being viable for the intermediary. The initial payment and monthly payment can be determined in a manner that does not require any information about a consumer. Consequently, these values can be pre-determined for vehicles before the vehicles are presented to a consumer and can be used by automotive data processing system 100 to pre-populate ownership agreements or other documents. An inventory record 1350 can thus be enhanced with one or more payment schedules for a vehicle.

Filters can be reapplied or payment schedules determined again responsive to underlying data changes. For example, if the inventory record odometer reading for a vehicle changes, automotive data system 100 can re-determine the current price for the vehicle and reapply the various filters to determine if the vehicle still qualifies to be in the program pool. As another example, automotive data processing system 100 may periodically recheck third party services 1336 for data changes, such as changes to the wholesale value.

At step 1352, the automotive data system 100 can publish an inventory record for a vehicle to a front-end. Publication may include copying the inventory record to a different data repository that is accessible by a front-end system. The inventory record, when published, can include base start fees and monthly payments for multiple credit risk bands and mileage bands.

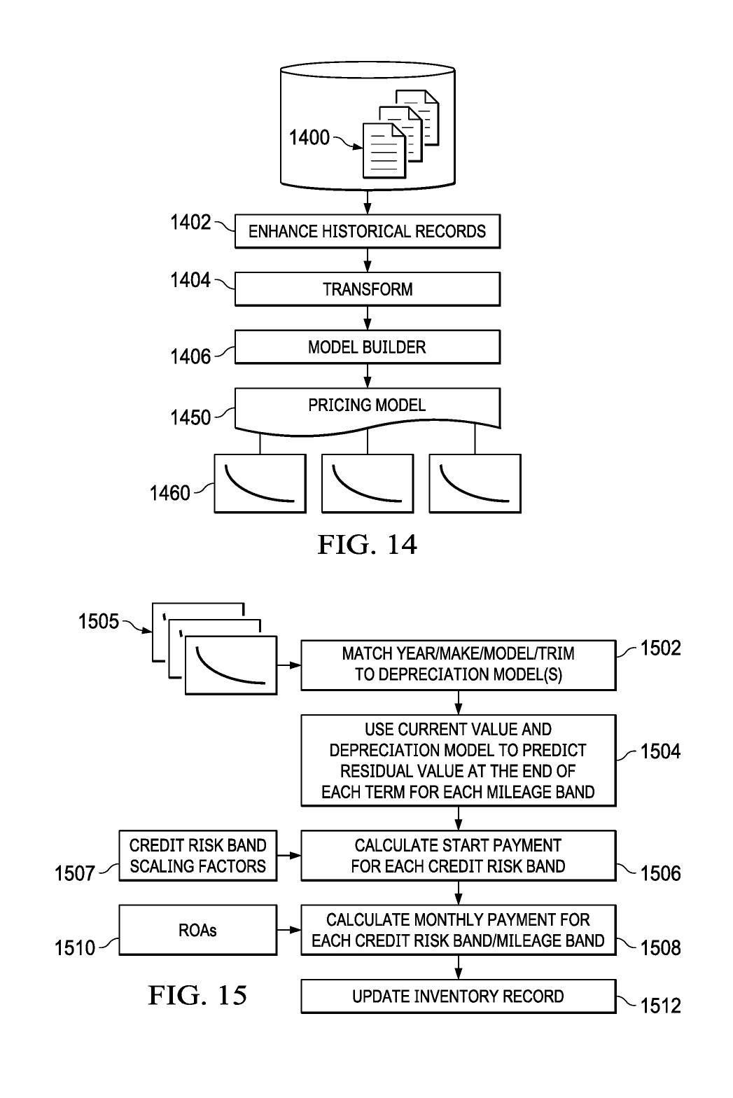

FIG. 14 is a block diagram of one embodiment of a process for developing a pricing model and depreciation curves. The determination of payment schedules may rely on a pricing model 1450 (a residual value model) that can be used to predict secondary market depreciation rates, on a unit level, based on select model specific, usage, industry, and macroeconomic variables, examples of which are provided below. Through machine learning and training, the particular variables of interest (including potentially different or additional variables) and weights can be determined.

According to one embodiment, model 1450 may be a regression coefficient model. The dependent variable of model 1450, may be a year/make/model/trim expected secondary market sale price at a target duration and mileage band (for example, expressed as a percentage of current market value). Examples of independent variables include, but are not limited to: i) vehicle variables-segment, make, model, model year, trim, engine displacement, drive type, series life cycle, vehicle condition, geographic region, type of sale, options, color, remaining OEM or CPO warranty coverage; ii) usage variables-annual mileage, disposal, sales month, months in service; iii) industry variables-new vehicle registrations, fleet penetration, rental penetration; iv) macroeconomic variables-GDP, unemployment, interest rates, secondary market seasonality, household disposable income, fuel prices, CPI, Mannheim Used Vehicle Value Index by Mannheim.

Model 1450 can be trained on a set of historical data 1400. According to one embodiment, historical auction transaction data may be used. The auction transaction data is non-aggregated data that includes information regarding the date, year, make, model, trim, mileage, sales price and other information for individual vehicles sold at auction. For example, a residual value model may be trained using auction data from the National Automobile Dealers Association (NADA) of Tysons, Va. In some cases, the auction transaction data can be enhanced with data from other sources (1402).

The historical data may be transformed (1404) into a form that can be ingested by a model builder 1406. For example, text data may be mapped to numerical data and other transformations applied. The historical data may be input into a model builder, such as the open source scikit-learn (sklearn) tool to generate a pricing model 1450.

The pricing model can be periodically retrained on new data from a third party provider or internal data collected by automotive data processing system 100 over time. As such, the residual value determination may thus become increasingly accurate with additional data and adjust to changing trends.

The residual value model may contextualize data analysis. For example, one piece of information (or combination thereof) may be analyzed differently depending on the results of analyzing another piece of information (or combination thereof).

As described above, the dependent variable may be a year/make/model/trim expected secondary market sale price at a target duration (1 month, two month, etc.) and mileage band (estimate for vehicle driven an average of 10,000 miles a year, 12,500 miles a year, etc.). Thus, the model can be used to develop depreciation models 1460. Each depreciation model may correspond to a year/make/model/trim and mileage band. For example, the system may generate a depreciation curve (a depreciation model) for a default mileage band (say 10,000 miles-a-year) and excess mileage may addressed by contractual terms (excess mileage fees). In other embodiments, vehicle data application 150 determines the depreciation curves for each mileage band supported. For example, for a specific year/make/model/trim vehicle data application 150 can determine 10,000 mile-a-year depreciation curve, a 12,500 mile-per-year curve, etc., up to a maximum mileage band supported by the system 100. Depreciation curves are not generated for vehicle configurations (year/make/model/trim) for which there was insufficient data input to build the model 1450 (e.g., less than a certain number of records in historical data 1400 or based on other metric). As discussed above, if a depreciation curve is not available for a year/make/model/trim in an inventory record, the inventory record can be filtered out (step 1338).

The pricing model parameters and depreciation models 1460 (e.g., the curve coefficients, intercepts or other data defining the depreciation curves) may be stored. It can be noted that, in many cases, depreciation for a year/make/model/trim/average usage is often linear (a steady percentage), at least while a vehicle is less than a particular age and mileage (usually about 7 years and 100,000 miles) and the inventory filter rules can be selected so that the vehicles in the program pool are in and likely to stay in the region in which depreciation ratio is linear. Thus, the depreciation model 1460 for a year/make/model/trim and mileage band may be a simple percentage in some embodiments.

The residual value model 1450 can be periodically retrained on new data from a third party provider or internal data collected by automotive data processing system 100 over time. As such, the residual value determination may thus become increasingly accurate with additional data.

The residual value model may contextualize data analysis. For example, one piece of information (or combination thereof) may be analyzed differently depending on the results of analyzing another piece of information (or combination thereof).

The payment schedule for a vehicle may be determined in a variety of manners. According to one embodiment, the payment schedule is selected so that the combination of start fee and monthly payments stay ahead of the depreciation curve for the vehicle. The payment schedule may also be selected based on other considerations.

FIG. 15 is a flow chart illustrating one embodiment of determining base payment schedules for a vehicle. In the embodiment of FIG. 15, the payment schedule for a vehicle is determined on a unit economics model based on particular metrics, discussed below. At step 1502, the year/make/model/trim is determined and the appropriate depreciation model(s) 1505 loaded (for example, one or more depreciation models 1460 developed from the machine learning pricing model 1450). At step 1504, a depreciation model is applied to the current value of the vehicle to determine the predicted value of the vehicle at the end of each term out to a configured term (e.g., the value at the end of month 1, month 2, month 3 etc. to say 72 months or other maximum term). The estimated residual values for each term can be determined for each mileage band. In one embodiment, the current value is the MMR value for the VIN or other trusted index value of wholesale value. In another embodiment, the current value may be determined from a machine learning model, such as pricing model 1450 (e.g., using 0 term).

The data processing system determines one or more base start fees for the vehicle. For example, the base start fee may be 5% (or other percentage) of the dealer's asking price for the vehicle. The base start fee may be adjusted up or down based on credit risk band. According to one embodiment, credit scores may be categorized into credit risk bands and each credit risk band assigned a scaling factor. As such, at 1506, the data processing system may load a set of scaling factors 1507 for credit risk bands. For example, a first credit risk band corresponding to riskier credit scores, may be assigned a factor of 2, high credit scores (an example of a second credit risk band) may be assigned a factor of 0.5 and credit risk bands in between may be assigned factors between 0.2 and 2. In this example, automotive data processing system 100 determines a range of start fees (one for each credit risk band) from 1% of dealer asking price to 10% of dealer asking price. In another embodiment the base start fee is determined along with the monthly payments (step 1508) as a simple multiple of the monthly payments.

At 1508, automotive data processing system 100 determines the base monthly payments for the vehicle. The base monthly payments for the vehicle are determined based metrics. According to one embodiment, return-on-asset (ROA) hurdles 1510 can be set for various terms (e.g., 6 months, 12 months, 18 months, etc.). Moreover, different ROA hurdles can be set for different credit risk bands. For example, the 6, 12 and 18 month ROA hurdles for a higher credit risk band may be higher than the 6, 12 and 18 month ROA hurdles for a lower credit risk band. According to another embodiment, the same ROA hurdles are used regardless of credit risk band. The base monthly payments and/or start fee can be adjusted such that the start fee and monthly payments achieve an ROA hurdle or set of ROA hurdles. For example, the system can start at a default monthly payment amount, say $0, and add a $1 until all the ROA hurdles are met.

The ROA calculation can be performed according to methods known or developed in the art with actual or assumed cost of funds. According to one embodiment, the ROA for a term “t” can be calculated as follows:

$${ROA}_{term} = \frac{{\sum }_{t = 1}^{t = term} {returns}_{t}}{{\sum }_{t = 1}^{t = term} asset {value}_{t}}$$

The foregoing is based on the following monthly balance sheet items for the particular vehicle for each month:
1) asset value: predicted value of asset at term t as predicted from the residual value prediction models (e.g., depreciation models).
2) returns: expected cash flows associated with the vehicle (net income on the vehicle). The cash outflows can include direct costs associated with the particular vehicle items. The cash outflow may include items such as the cost of money, payments made by the intermediary to finance the vehicle or other cash outflows specific to the vehicle. The cash outflow each month may include an amount that models or predicts the risk that the user will default in that month. For example, if it is predicted that there is 0.1% chance that a vehicle will be reposed in any given month and the cost of a repossession is $1000, then a cash outflow can include a $1 fee for the month. Other predicted losses may be included in the cash outflows. In some cases, there are direct costs that are passed directly to the consumer, such as dealer doc fees and other fees. Such costs may be included in the model, but may be ignored as they will have a directly corresponding and equal cash inflow.

In the first month, the cash inflow from the base start fee, the first monthly payment and the cash outflow from the payment to the dealer and other costs associated with the purchase can be represented. Each month can include the monthly payment for vehicle. Moreover, for any given return month, it can be assumed that the vehicle will be sold for the predicted residual value and the monthly cash flow for a term can include the cash flow for the hypothetical sale of the vehicle at that term (e.g., ROA₆ can assume the vehicle is returned and sold in month six). The predicted residual value can be calculated by applying the depreciation model to the current value determined for the vehicle.

For example, automotive data processing system may be configured with ROA hurdles as follows: 6 months 0%, 12 months 0.5%, 18 months 1% (the values are provided by way of example). The base monthly payments can be adjusted until the payments yield ROA₆>=0, ROA₁₂>=0.5, ROA₁₈>=1. As discussed above, the ROA hurdles may depend on credit risk band.

As discussed above, the ROA goals may vary based on credit risk band. As such vehicle data application 150 can determine a fee schedule for each credit risk band. Moreover, as will be appreciated, the predicted residual value for a vehicle at a given term will depend on expected depreciation, which, in turn, depends on expected usage (mileage band). According to one embodiment then, vehicle data application 150 determines the payments to reach the ROA goals for each credit risk band/mileage band combination. For a credit risk band and mileage band, if the ROA determination for a term results in an ROA of less than the ROA hurdle for that term, the monthly payments (or start fee) can be increased until the ROA at that term is at least meets the ROA hurdle. This process can be repeated until the monthly payment schedule meets all of the ROA hurdles. The payment schedule that meets all the ROA hurdles for each credit risk band/mileage band combination may be stored in the inventory record for the VIN.

In addition or in the alternative, an “expected ROA” can be predicted for a given payment schedule. The expected ROA can be determined by multiplying the probability that a consumer will return a car in any given term by the predicted ROA for that term (for a vehicle, mileage band and credit risk band) and summing the results, e.g.,

$${ROA}_{expected} = {\sum }_{t = 1}^{final} ( {ROA}_{t} * {Prob}_{t} )$$

where final can be a configurable number to account for the fact, that at some point, the probability of returns occurring becomes insignificantly small.

The Probₜ represents the probability of a consumer returning a vehicle in a given month of the ownership agreement and may be based on a probability distribution that represents the probability that a consumer will return a vehicle in a given month. In one embodiment, for example, if it is believed that the mean hold time for vehicles will be 18 months and that returns will generally follow a Poisson distribution, automotive data processing system can determine Probₜ for each month according to a Poisson distribution. It can be noted that the Poisson distribution is provided by way of example and other distributions may be used. The probability distribution may be selected based on business rules or according to a model trained over returns data collected by automotive data processing system 100. As the system gains actual customer data on return timing, more accurate predictive models can be built concurrently to model projected vehicle return timing. A payment schedule may be determined so that the ROA_{expected} meets particular ROA hurdles.

At step 1512, automotive data processing system 100 can update the inventory record with the base start fee(s) and monthly payments. For example, if there are 20 credit risk bands and 10 mileage bands defined, the automotive data processing system 100 can determine 20 adjusted base start fees (step 1506) and 200 monthly payment schedules (step 1508) and store the start fees and monthly payment schedules in the inventory record for the vehicle.

The base monthly payments may be adjusted to account for other factors. In some cases, the intermediary may add additional goods and services. For example, it may be desirable to include insurance, a maintenance contract or warranty with each vehicle. The prices for these products may be predetermined for a year/make/model/trim and mileage. Thus, in some embodiments, the vehicle data application 150 may look up the cost of included add-ons (or request the cost from a third party information provider system 120) and add the cost of the required add-on (e.g., maintenance contract, warranty or other items) to the base monthly payment. Thus, the monthly payments stored in the inventory record may be adjusted to include payments for required add on products. In other embodiments, the base monthly payments and payments for the required add-ons are maintained separately, but combined before being surfaced to the user and for purposes of searching inventory that meets an affordability score.

According to one embodiment, a user may search and purchase inventory items (e.g., vehicles) via data processing system 100. A portion of the data needed to populate an ownership agreement may be determined by data processing system 100 relatively early in the purchase process. For example, the price, base initial payment or base monthly payments for a vehicle are known when the consumer selects a vehicle of interest. Items such as the consumer name, dealer name, VIN number, vehicle description, initial payment, monthly payment and other information may be pre-populated in the ownership agreement and other documents (e.g., maintenance contracts, disclosures) by data processing system 100. Accordingly, the consumer may, in some embodiments, view an initial or final copy of the ownership agreement before going to the dealership.

Some items included in the ownership agreement or other documents, such as options and F&I products, may be selected by the dealer via the dealer portal or consumer via client application 114 and can be added to the documents when the selections are made. In some cases, F&I products can be offered by the intermediary to the customer directly through the application, wherein certain key products will be added by default (like a warranty/service contract) while others can be opt-in.

In addition, some items in the ownership agreement may have to be verified by the dealer or consumer at the time of sale. As a particular example, an inventory record for a vehicle being purchased may only have an estimate of mileage or have the mileage from when the vehicle arrived at the dealership but not the actual mileage at time of sale, which may include mileage from test drives, etc. after the vehicle arrived at the dealer. The dealer may, therefore, have to update the mileage for the vehicle at the time of sale.

The ownership agreement or other documents may be updated as new information becomes available (e.g., such as the consumer selecting F&I products), the dealer verifies mileage, or the purchase process progresses. For example, if the user decides not to purchase a particular vehicle, but indicates through client application 114 interest in a different vehicle at the same dealership, the data processing system 100 can populate the ownership agreement or other documents with the information for the new vehicle of interest.

The documents, in some embodiments, may be associated by data processing system 100 with the user profile of the consumer so that the documents can be accessed by the consumer or dealer through their association with the consumer profile. In some embodiments, an activation code, discussed below, may act as a link to a set of documents associated with the consumer.

It can be noted that, in some embodiments, data processing system 100 can provide the consumer with access to electronic copies of all the documents that are required for a purchase. If the consumer is presented with other documents by the dealer, the consumer will be alerted to the fact that the transaction requires heightened scrutiny.

From the consumer perspective, steps of the purchase process including, for example, searching inventory, selecting a vehicle of interest, reviewing documents and executing documents (with potentially some documents that must be executed by hand) can all be done through a mobile device interface (e.g., as provided by client application 114).

Furthermore, unlike traditional systems in which there is no or little communication between client computer systems and the dealer systems, the client computing devices 110 can, in some embodiments, communicate with the dealer portal through, for example, API services provided by data processing system 100. The consumer can, for example, accept or reject the ownership agreement or portions thereof through his or her mobile device. The documents can be dynamically updated based on interactions by the dealer and consumer.

As a transaction progresses, information associated with the transaction may be pushed to the client application 114 and dealer portal. For example, information about a vehicle, pictures of the vehicle, add-ons plus the price of each item to be purchased can be pushed to client application 114 (e.g., in an “order review” interface) so that the consumer can approve/reject particular items (or the transaction) via the client application 114. Changes to a purchase through the dealer portal or client application 114 (e.g., such as adding or rejecting add-ons) can be synchronized by data processing system 100. Thus, there may be back-and-forth communication between client application 114 and the dealer portal as the purchase order evolves.

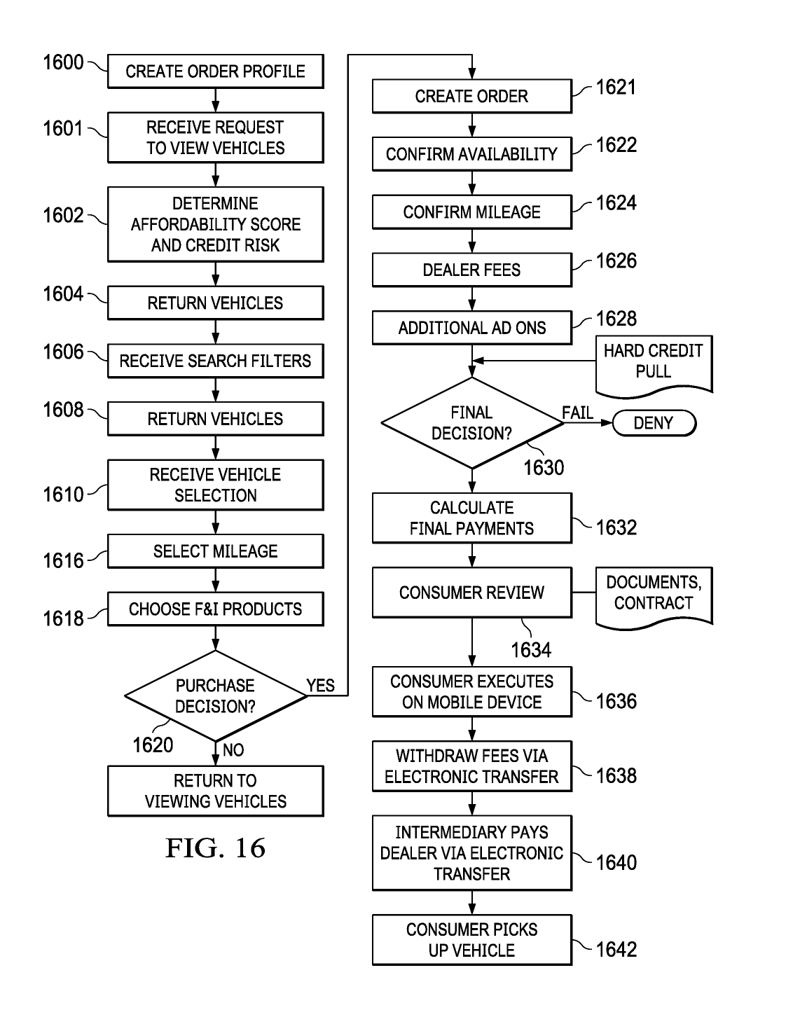

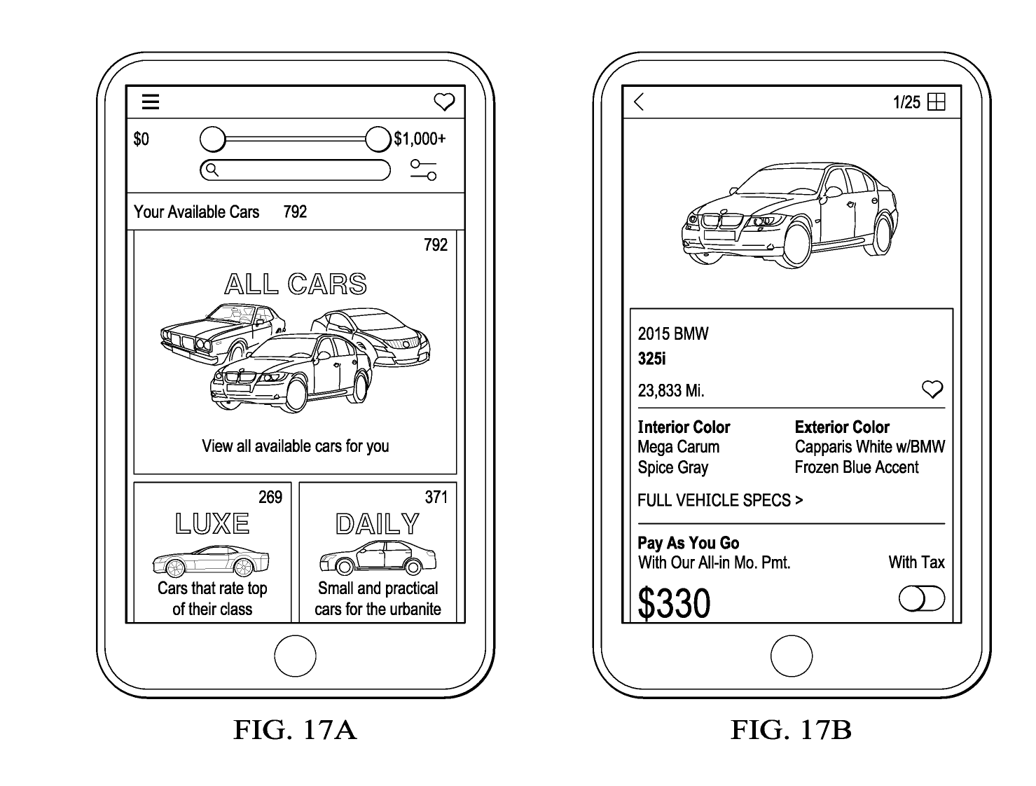

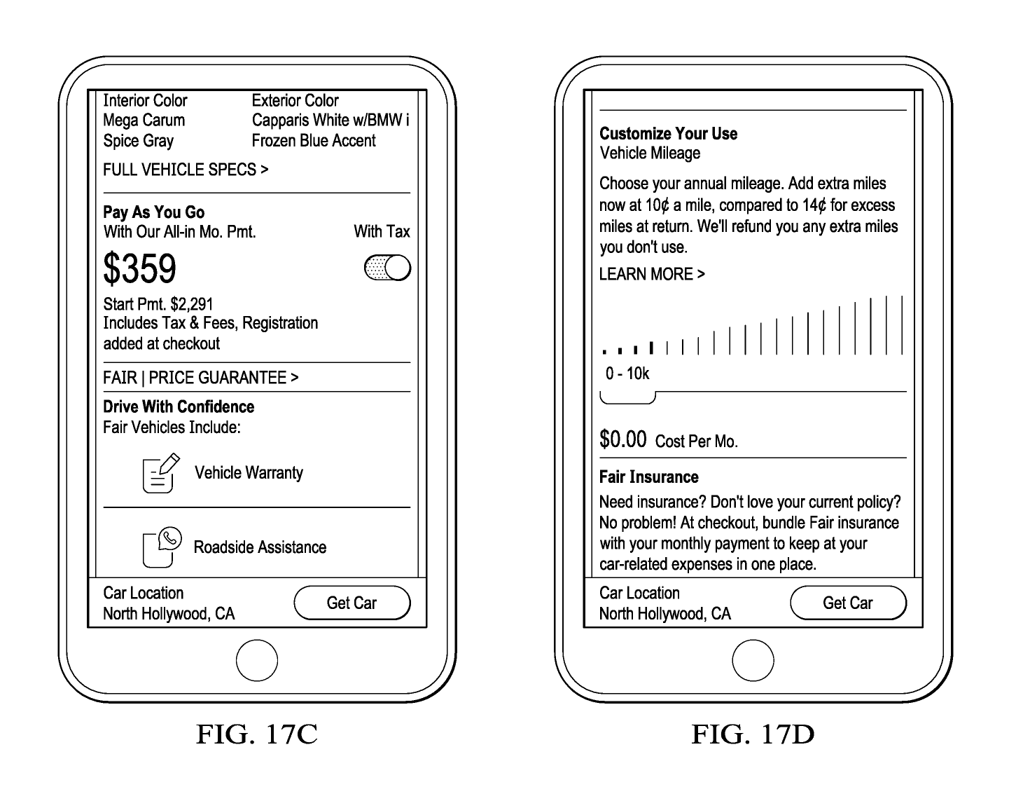

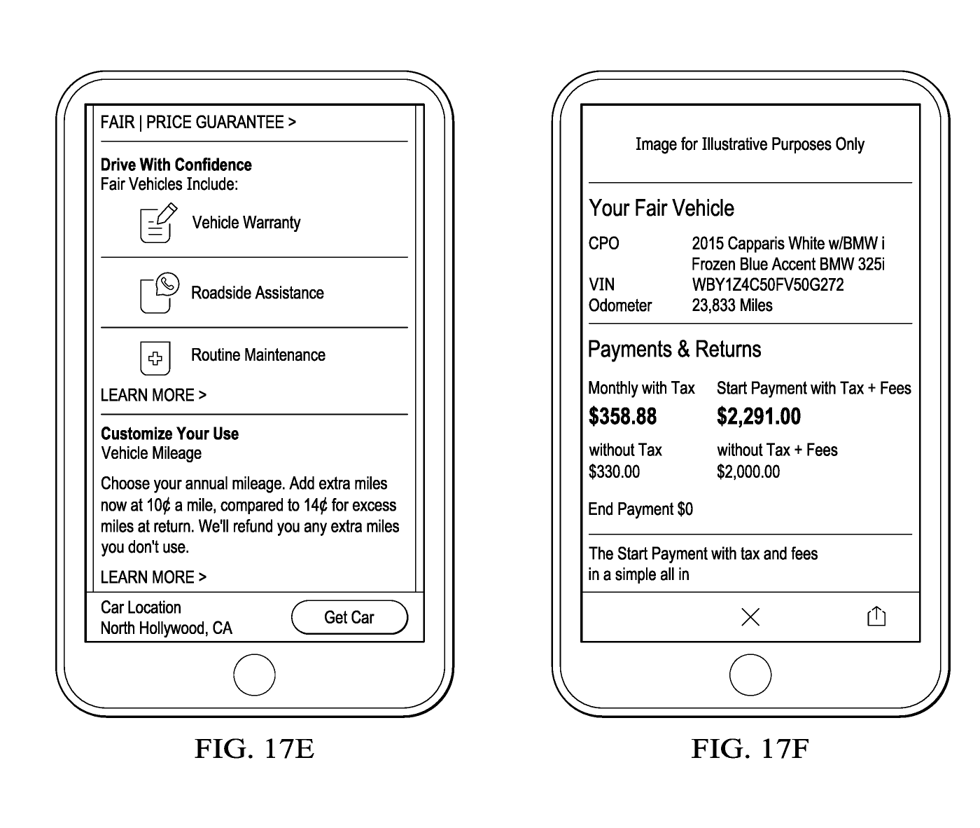

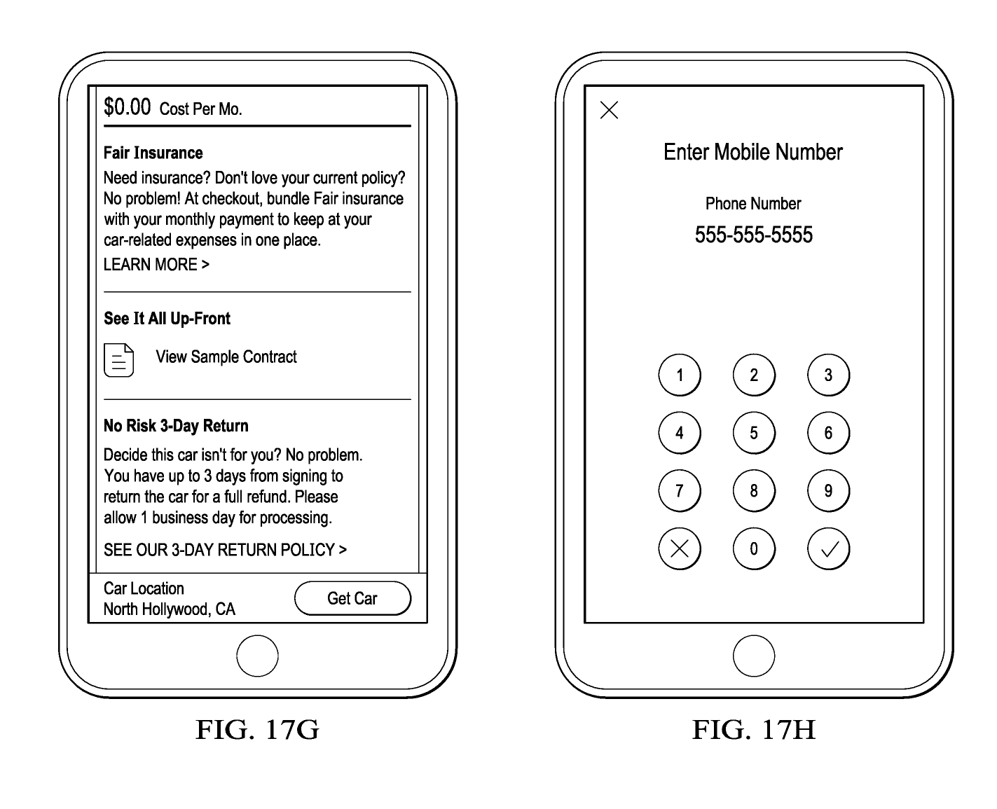

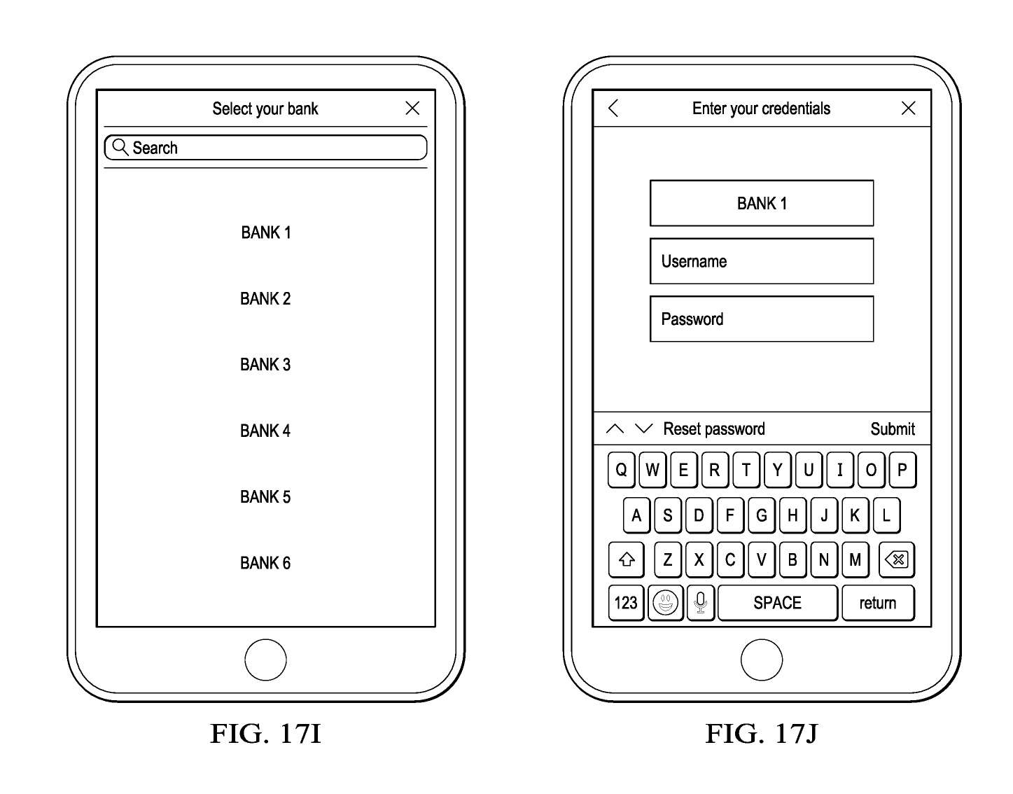

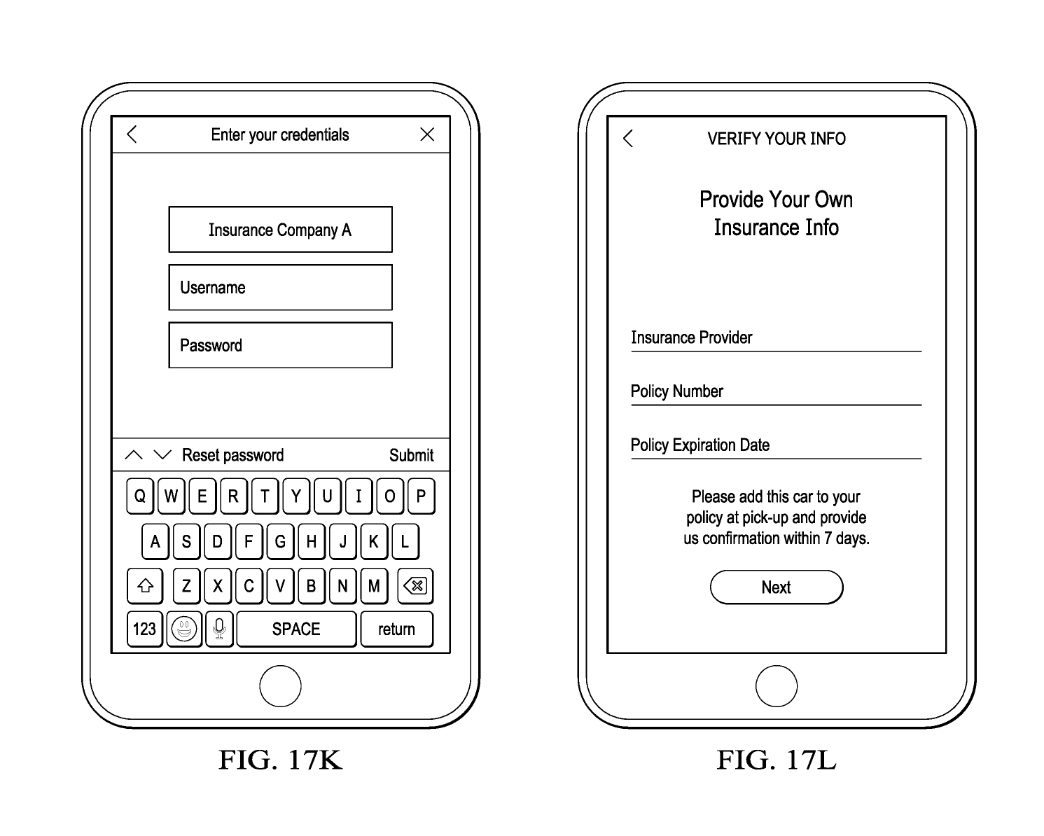

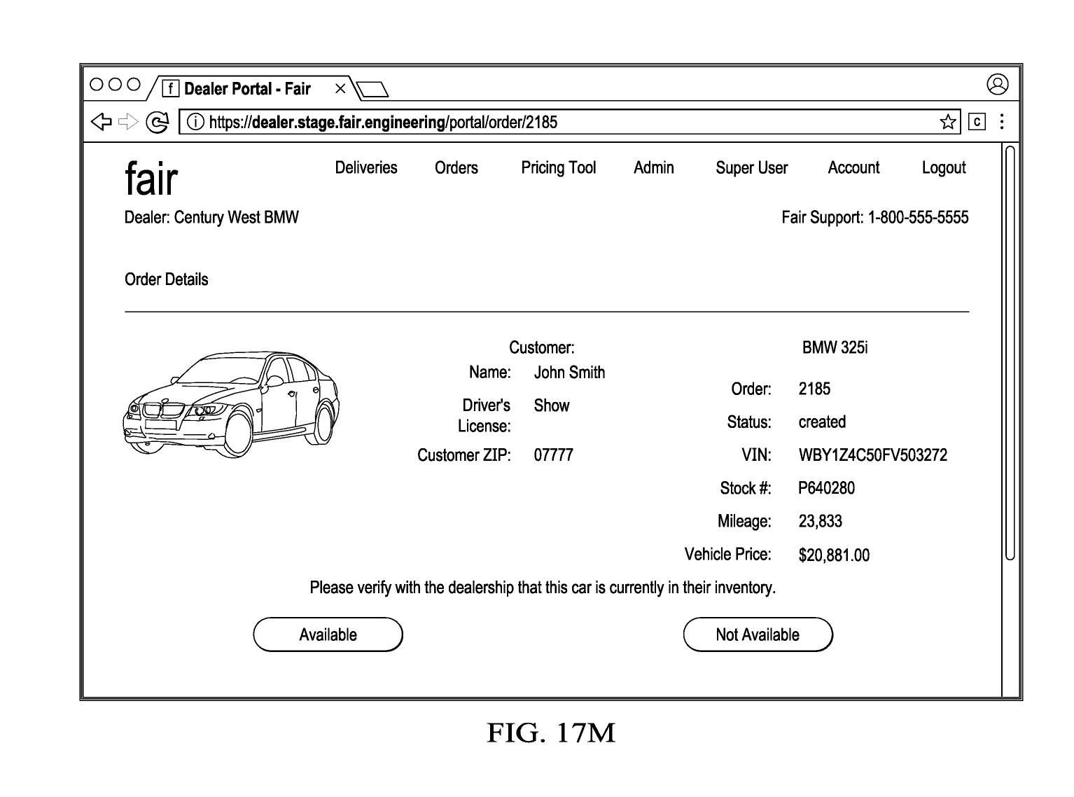

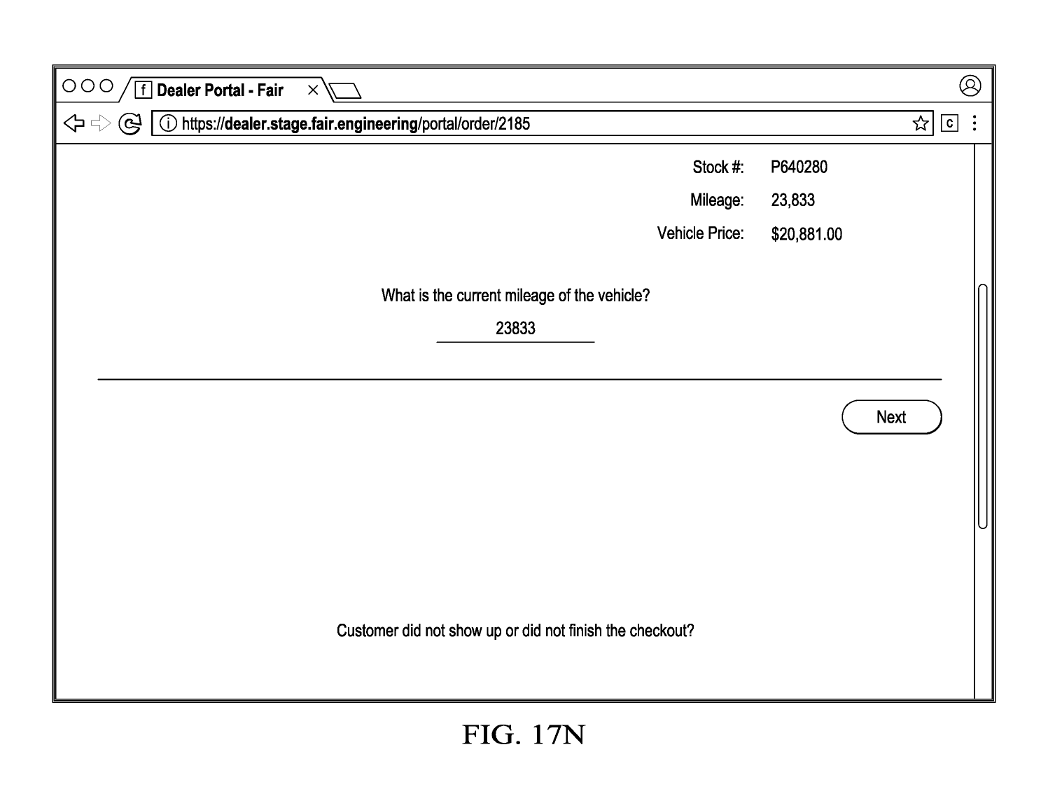

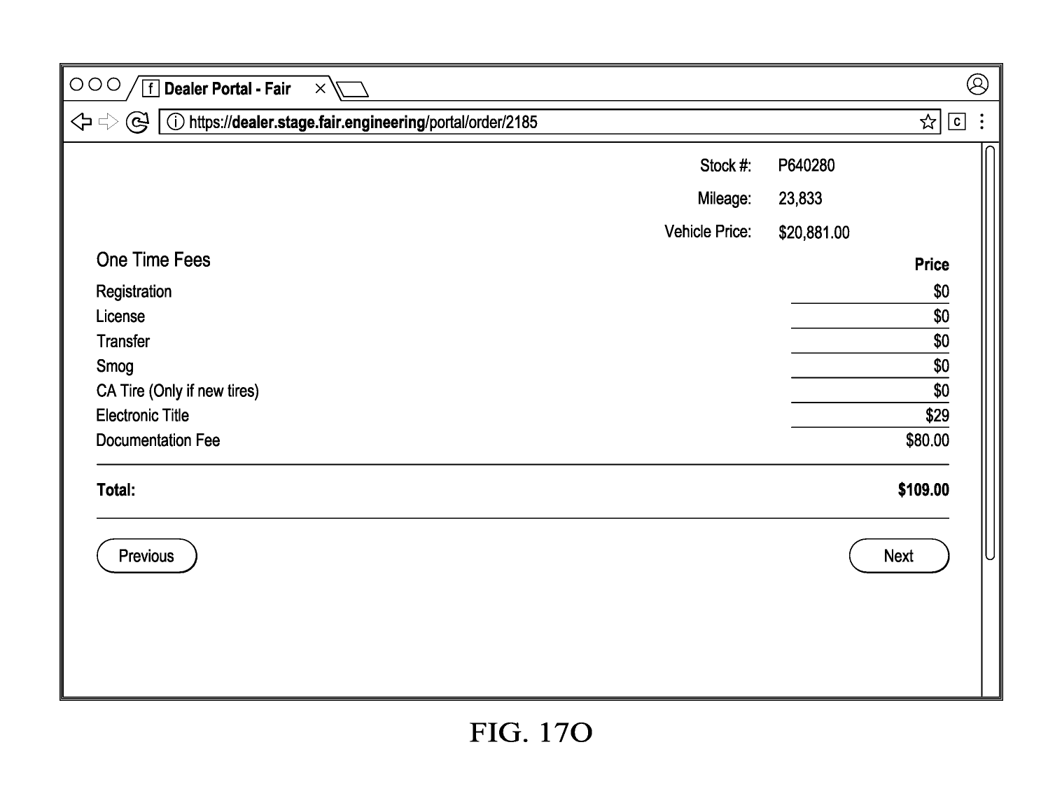

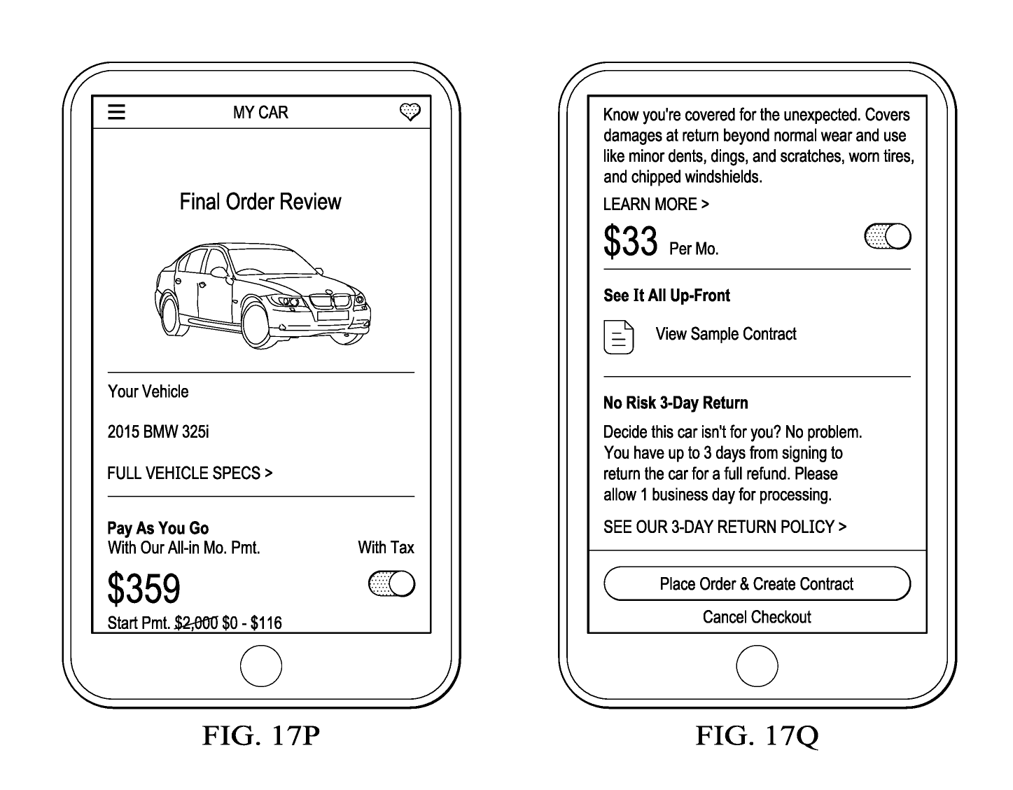

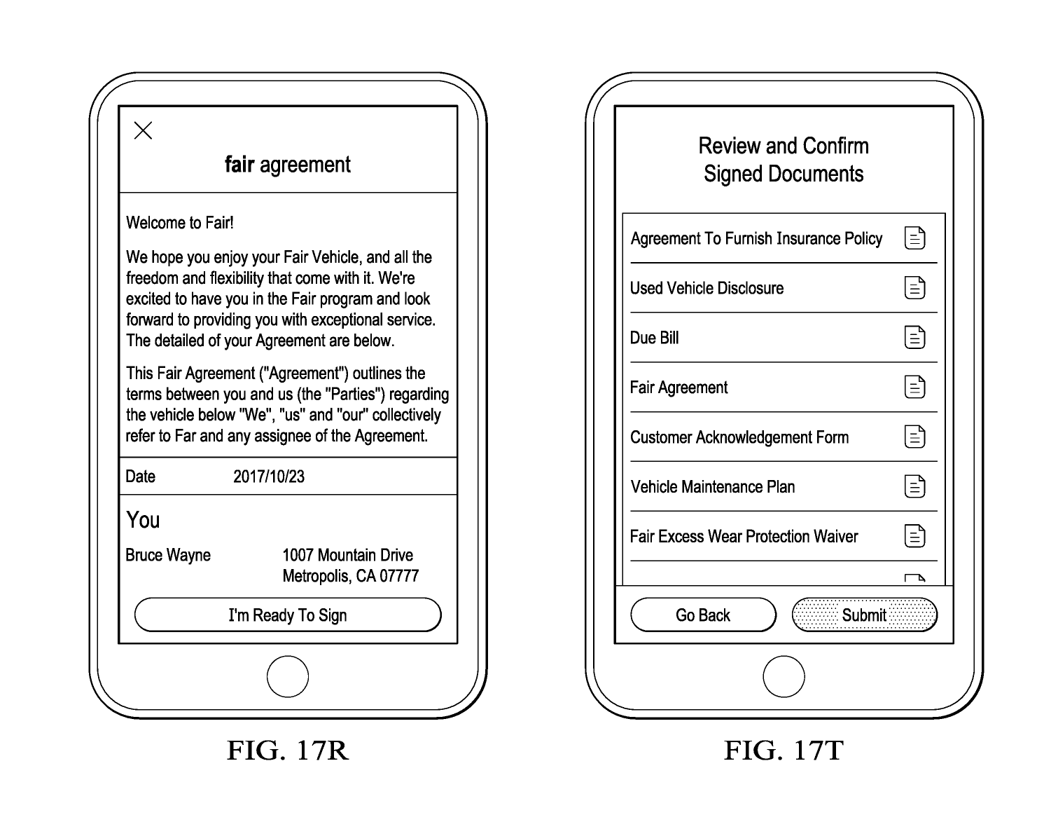

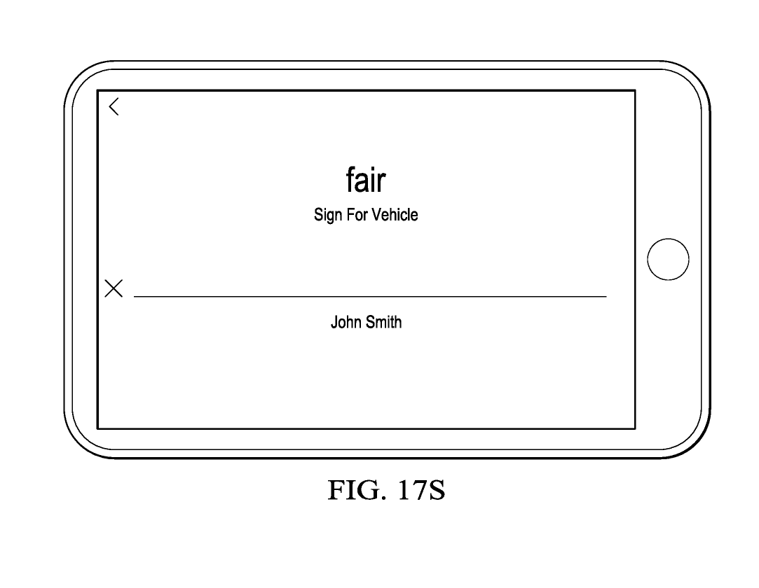

With reference to FIG. 16, one embodiment a method for performing a transaction is illustrated. FIGS. 17A-17T illustrate examples of application pages at a mobile application and a dealer portal for providing and receiving information associated with a transaction.

Automotive data processing system 100 creates an order profile when a user application is approved to track the purchase process after pre-approval (step 1600). In one embodiment user application service 210 notifies order service 220 that an application has been approved and passes consumer context information (application data) to order service 220. Order service 220 creates the order profile associated with the user to associate customer information with vehicle information and track context of an approved user's interactions with application 150. The order profile may include a variety of attributes, including encrypted PII, the consumer's affordability score and credit risk score and other information. As a consumer browses inventory and selects vehicle, information from the inventory record and other information regarding the selected vehicle may be added to the order profile.

At step 1601, automotive data processing system 100 can receive a request from a consumer to view vehicles (e.g., based on a user interaction in a GUI, such as by selecting the “Find My Ride” virtual button in FIG. 4I.) Automotive data processing system 100 searches its program pool for eligible vehicles based on affordability score. Automotive data processing system 100 may also search its program pool for eligible vehicles based on the user's credit risk score. Accordingly, automotive data processing system 100 can determine the affordability score and credit risk score associated with the consumer (step 1602). In some implementations, the affordability score and credit risk score may be included in the request from client application 114. In other embodiments, vehicle data application 150 augments a request from client application 114 with the affordability score or credit risk score. According to one embodiment, when a request to view vehicles is received, interface proxy service 204 routes the request to order service 220 and order service 220 augments the request with consumer context information from the order profile. In particular, order service 220 can augment the request with the affordability score and credit risk score received from user application service 210 and pass the augmented request to inventory service 230 as part of a search request.

At step 1604, automotive data processing system 100 identifies a set of eligible vehicles for a consumer based on the consumer's affordability score, the monthly payment for each vehicle and other factors, such as geography or other factors. In one embodiment, automotive data processing system 100 identifies the eligible vehicles as those vehicles having a base monthly payment (e.g., an adjusted base monthly payment) for a default mileage band (say 10,000 miles) and corresponding to the consumer's credit risk score that is less than the consumer's affordability score. If the base monthly payment is not adjusted with the payments for the required add-on products in the inventory record, the inventory service may make this adjustment when searching for eligible vehicles. In the embodiment of FIG. 2, inventory service 230 may return the results to order service 210 and order service can return the results to client application 114 via interface proxy service 204. In any case, automotive data processing system 100 can return inventory record information for the eligible vehicles including, for example, the adjusted base monthly payment for a default mileage band and, in some embodiments, corresponding to the consumer's credit risk and other information (step 1604). In the example of FIG. 17A, there are 792 available eligible vehicles for the consumer.

The consumer may provide consumer filter parameters to filter the set of eligible vehicles by various factors such as new/used, make, model, trim, options, odometer reading, year, vehicle location or other factors. The automotive data processing system 100 can receive the filter parameters (step 1606), search the inventory records of the eligible vehicles and return inventory record data for the vehicles meeting the filter criteria (step 1608). For example, if a consumer who has been approved for a payment of $1,062 a month indicates that he or she is searching for inventory in San Francisco, Calif., automotive data processing system 100 can present the consumer (e.g., through client application 114) with program pool vehicles within 25 miles (or other geographic region) of San Francisco that have a base monthly payment of $1062 or less for the credit risk band corresponding to the consumer and a default mileage band.

When vehicles are displayed to the consumer the vehicles may be sorted based on lowest initial fee, best value (price relative to fair market value (e.g., “above [average condition] MMR”)) such that more fairly priced vehicles are listed first. This can further incentivize dealers to price vehicles as low as possible to the benefit of consumers. Vehicles can also be sorted by best payment, which helps drive customers to cars that depreciate less aggressively and therefore lend themselves to a lower payment than similarly priced cars that depreciate more aggressively.

The vehicles presented may be filtered by the maximum approved monthly payment or the suggested approved monthly payment for the consumer. In another embodiment, the automotive data processing system 100 may apply a scaling factor such that automotive data processing system 100 will present the consumer with vehicles that have a monthly payment < or =maximum approved payment*scaling factor (e.g., $400*0.7). The scaling factor may be selected to help ensure that the consumer can afford additional products, such as maintenance contracts, and expected additional expenses (gas, insurance, etc.). In any event, at this point, the consumer can view actual inventory from the dealers that fall within that individual's affordability as determined by automotive data processing system 100.

In addition or in the alternative, automotive data processing system may geofence inventory based on GPS coordinates provided by client application 114. Based on the GPS coordinates or other information, automotive data processing system 100 can determine that a consumer is at a particular dealer and only present vehicles associated with that dealer to the consumer. Thus, for example, if at step 1620, the consumer indicates via client application 114 that he or she is not interested in a particular vehicle automotive data processing system 100 can present to the consumer other vehicles at the same dealership that meet the affordability and consumer filter requirements.

The consumer may select a vehicle from the set of eligible vehicles from the program pool (step 1610). According to one embodiment, interface proxy service 204 can receive a request from client application 114, forward the request to order service 220, order service 220 can augment the request with consumer context data, such as affordability score and credit risk score, and forward the augmented request to inventory service 230. Order service 220 may also access a table of tax rates (e.g., based on postal code in the order profile) and determine a tax rate. In another embodiment, order service 220 may determine a tax rate from an information provider system 120. Order service 230 can augment the request with a tax rate.

Inventory service 230 returns additional vehicle detail data for the requested vehicle to order service 220. The vehicle detail data may include the array of payment schedules corresponding to the user's credit risk, for different mileage bands. The array of payments may include the base monthly payment adjusted to include payments for required monthly add-ons (e.g., warranty, maintenance contract, etc.) The vehicle detail data can include the payments both with and without the tax rate applied. Order service 220 can store the responsive data returned by inventory service 230 in the order profile and return the vehicle detail data to client application 114 via interface proxy service 204.

In FIG. 17B, the consumer has selected a particular vehicle with a base monthly payment of $330. The monthly payment initially displayed to the user corresponds to the user's credit risk band and a default mileage band (e.g., 10,000 miles a year). Further, in the embodiment illustrated, the monthly payment includes a portion for an included insurance policy, maintenance policy and warranty.

The user may be provided with controls to adjust order payment parameters. As illustrated in FIG. 17C, the user can select to view the price with taxes. As another example, while the user may be shown a monthly payment based on a default mileage band, the user may be provided with controls to change the mileage band. For example, FIG. 17D illustrates an example in which the user is provided with a slider to adjust mileage band (step 1616). It can be noted that, in some embodiments, the payment schedule for each mileage band may be provided to client application 114 when the user selects the particular vehicle. Thus, adjusting the slider of FIG. 17D may not require a call to the server. However, if the user selects to preview documents, the current setting can be sent to automotive data processing system 100. In another embodiment, a call can be made to automotive data processing system 100 each time the slider is adjusted. This will cause automotive data processing system 100 to return updated monthly payment based on the user's credit risk band and the selected mileage band.

As another example, the user may be given the option to selection various optional products (step 1618). As discussed above, the cost of insurance, maintenance contract, warranty or other items may be included in the monthly payment for the vehicle. For example, FIG. 17E illustrates that the vehicle comes with a vehicle warranty, roadside assistance and routine maintenance. In another embodiment, F&I products can be offered directly through the application 114 to the customer at a competitive rate. The user may be presented with F&I products that are available for purchase when the user selects a vehicle of interest. The user may be given the option to select these products through mobile application 114 in a shopping cart fashion or may be able to exclude certain products. This may occur before the consumer goes to the dealer.

According to one embodiment, the intermediary may negotiate terms of maintenance contracts or warranties with providers such that, unlike traditional maintenance contracts/warranties, the contracts/warranties may be month-to-month allowing the consumer to return the vehicle without unused term on the contract/warranty. The dealer can be paid an incentive upfront for the sale of such products and the intermediary may also add a monthly mark-up atop its underwriting cost. However, the total mark-up to the end customer can be notably less than an average dealer premium represents on traditional F&I products, such that the economics are distributed in a more economically advantageous way to the customer, while still properly incentivizing the dealer and intermediary. As F&I products, such as warranties/service contracts and others, can be added by default into the monthly payment where applicable, dealer penetration may improve notably, justifying a smaller mark-up by increasing sales penetration.

The selection of F&I products may affect the monthly payment. Whether included in the base monthly payment or provided as an add-on option, any contracts that are sold with the vehicle may be limited to contracts that are month-to-month, rather than fixed term. As such the consumer will not be stuck with, for example, a fixed term maintenance contract even if he or she wishes to return a vehicle early. In any event, in some implementations, the consumer rather than the dealer may control adding F&I products to the transaction and, in some cases, there may be no dealer interaction on F&I products through the data processing system.

At any point, the user may select to preview a purchase agreement. Because the start fee and monthly fees have been pre-calculated, the system may populate a preview version of the contract. Some items, such as registration fees or other fees entered by the dealer may be left empty at this point. According to one embodiment, in response to the user selecting to preview a purchase agreement, the automotive data processing system 100 can send the information to be included in the preview to a document service.

According to one embodiment, interface proxy service 204 can route a request to preview an agreement to order service 220. Because order server maintains a current state with the consumer information and vehicle data for the vehicle being currently viewed, order service 220 can forward the request, along with order profile data, to document service 224. The order profile may be forwarded as, for example, a structured JSON document such that the document service 224 can populate portions of a contract template with data from the order profile.

The document service can be configured to populate an HTML template or PDF template and provide the populated template to application 114 for viewing by the user. It can be noted, however, that some of the information may still be encrypted. FIG. 17F illustrates a user viewing a portion of the agreement populated with the monthly payment with taxes and the start payment with taxes and fees, though not all fees are included at this point.

When a user makes a final purchase decision for a vehicle (step 1620) all the information about the vehicle, including the initial payment and monthly payment should be known by automotive data processing system 100. The user may indicate a purchase decision—a decision to proceed with the purchase of a particular vehicle—such as by clicking “Get Car” in the example interface of FIG. 17G. The user may enter contact information to allow automotive data processing system 100 to contact the user when the vehicle is ready for pickup (FIG. 17H).

The user may be asked to perform several additional steps. For example, the user may be asked to link to his or her bank account for payment purposes (see e.g., FIGS. 17I-17J) and provide insurance information if insurance was not purchased through automotive data processing system 100 (see e.g., FIGS. 17K-17L).

When the user indicates a purchase decision (e.g., step 1620), automotive data processing system 100 can create an “order” to capture the information about the transaction from the current context (e.g., vehicle information, financing information, consumer information or other information in the order profile for the user)(step 1621). The order may be managed as an object. The order may be associated with a contract package that includes any document digitally generated for the order. Automotive data system 100 may include an order state machine that tracks the status of the order and documents in the contract package.

Automotive data processing system 100 can notify the dealer of the order via a dealer portal, email or other communications channel. The dealer may access an order and take various actions. FIG. 17M illustrates an embodiment of a dealer portal in which dealer can indicate whether the vehicle that is subject to an order is still available (step 1622). In addition, the dealer can verify the odometer reading of the vehicle as illustrated in the example embodiment of FIG. 17N (step 1624). If the odometer reading is different than what was included in the inventory record for the vehicle, the automotive data processing system 100 can notify the consumer (e.g., via application 114) and determine if the monthly payment or start fee have changed. As illustrated in the example of FIG. 17O, the dealer may also specify certain fees that will be added to the initial payment, such as registration, license, transfer, smog, title, document or other fixed fees (step 1626). The dealer may also be provided the opportunity to provide various additional pieces of information. The user may be provided the ability to add additional add-ons, such as insurance, through the dealer. The various dealer inputs may be provided to the document service and the document service can generate digital documents using the inputs. The documents may be added to the contract package for the order.

When the dealer has finished entering dealer provided information, the consumer can be notified via application 114 and can perform a final order review (FIG. 17P). The user may also be given the opportunity to add additional F&I products (step 1628). In the example of FIG. 17Q, for example, the user has selected to add on additional wear and tear protection.

When the terms of purchase are finalized (vehicle selected, additional products added), the consumer can indicate that the order is finalized via application 114 (for example, by selecting “Place Order and Create Contract”). Responsive to a signal to finalize an agreement based on user interaction in a GUI of client application 114, automotive data processing system 100 can make a final approval decision (step 1630). If the user fails the final decision, the purchase may be denied. If the final decision is passed, the purchase can proceed.

In general, the final approval decision can involve doing a hard credit pull. Automotive data processing system 100 may apply rules/models to the hard credit report data for the consumer to make a make a final credit check determination using hard pull credit data before the consumer and dealer finalize a transaction. In some embodiments, the final approval decision may include re-running pre-approval rules, as illustrated in FIG. 12, for example, in which final approval decision 1200 references the pre-approval sub-decision 1210. In one embodiment, order service 220 receives the request for final approval and makes a call to decision service 250 and requests a final approval decision from decision service 250.

The automotive data processing system 100 can calculate the final initial or monthly payments (step 1632), populate a final copy of the ownership agreement and other documents and provide the contract package for viewing by the user through the client application (step 1634).

The documents included in the contract package may include a variety of documents related to purchase of a vehicle, including, but not limited to an ownership agreement, an ach authorization to allow bank withdrawals, a due bill stating the amount due at signing (initial fee), used vehicle disclosure, agreement to furnish insurance policy (if insurance was not purchased through automotive data processing system 100), buyers guide, excess wear and tear contract (if excess wear and tear protection was purchased), vehicle warranty documents, vehicle maintenance plan, roadside assistance documents, insurance agreement if the user selected to purchase insurance through the automotive data processing system 100) or other documents.

The user may be given the option of approving the transaction on his or her mobile device. In particular, the information for the order is digitized into an electronic document and sent to the application 114. Thus, if the consumer is satisfied, final documents can be pushed to application 114. FIG. 17R illustrates, for example, a portion of a final contract provided to the user via application 114. The user can select “I'm Ready to Sign” (FIG. 17R) and be presented with an interface to allow the user to insert a digital signature (see, FIG. 17S). The digital signature may be applied to multiple documents in the contract package including, but not limited to, an ownership agreement, agreements for add on products, disclosure documents and any other documents requiring the consumer's signature. For example, the signature and pdf documents can be provided to an e-contracting service which can apply the signature to the pdfs in the contract package. In one embodiment, the SMART SIGN service by eOriginal of Baltimore, Md. may be used, though other e-signature services may be used in other embodiments. The consumer is provided the opportunity to review each of these electronic signed documents in application 114 and submit the signed documents. FIG. 17S, for example, displays a list of documents in the contract package, including signed documents. If the user is satisfied with the documents, the user can submit the documents.

Thus, the consumer can execute the ownership agreement and other documents on his or her mobile device (step 1636). In some cases, all the documents may be executed digitally. Thus, the entire purchasing experience, in some embodiments, may be done digitally without pen and paper. In most cases there should be no documents that require a wet signature by the consumer, as the intermediary can sign any DMV forms that require wet signature, and the dealer may be able to sign on the intermediary's behalf through a Power of Attorney. The consumer may also cancel the transaction directly from his or her mobile device.

Upon acceptance by the consumer, automotive data processing system can withdraw the initial fee from the consumer's bank account (step 1638) and initiate transfer of funds from the intermediary's bank to the dealer's bank to provide the funds to the dealer to pay for the vehicle (e.g., via electronic transfer) (step 1640). The user can then pick up the vehicle (step 1642).

Thus, from the consumer's perspective, one embodiment of purchase process can include: 1. Customer downloads app; 2. Customer scans driver's license and confirms info; 3. Customer is fully-approved with no credit impact; 4. Customer picks car on which they are pre-qualified; 5. Dealer confirms vehicle availability; 6. Consumer picks desired add-ons; 7. Customer signs all forms in app; 8. Intermediary fully executes all forms electronically; 9. Consumer reviews signed documents and submits signed documents. 10. Customer picks up vehicle. Thus, the consumer's only direct interaction with the dealer is to pick up the vehicle. The consumer can thus purchase a vehicle from any location from which the consumer's device 110 has internet access or other network access to automotive data processing system 100.

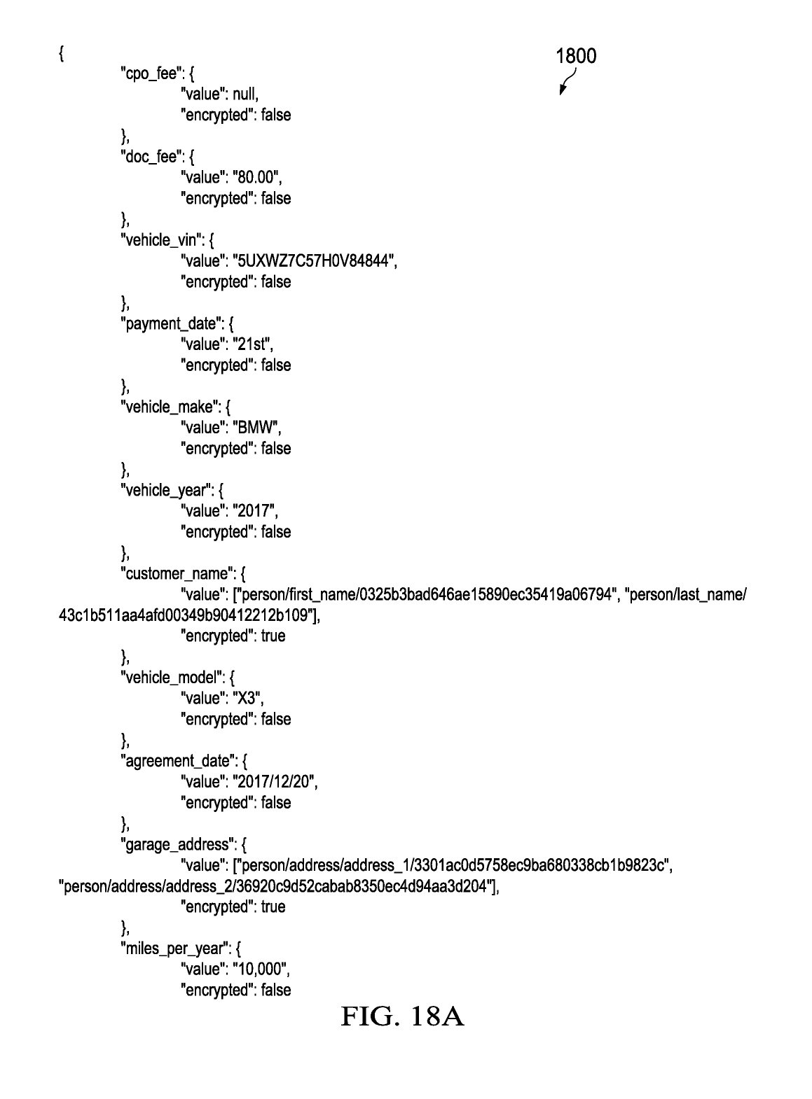

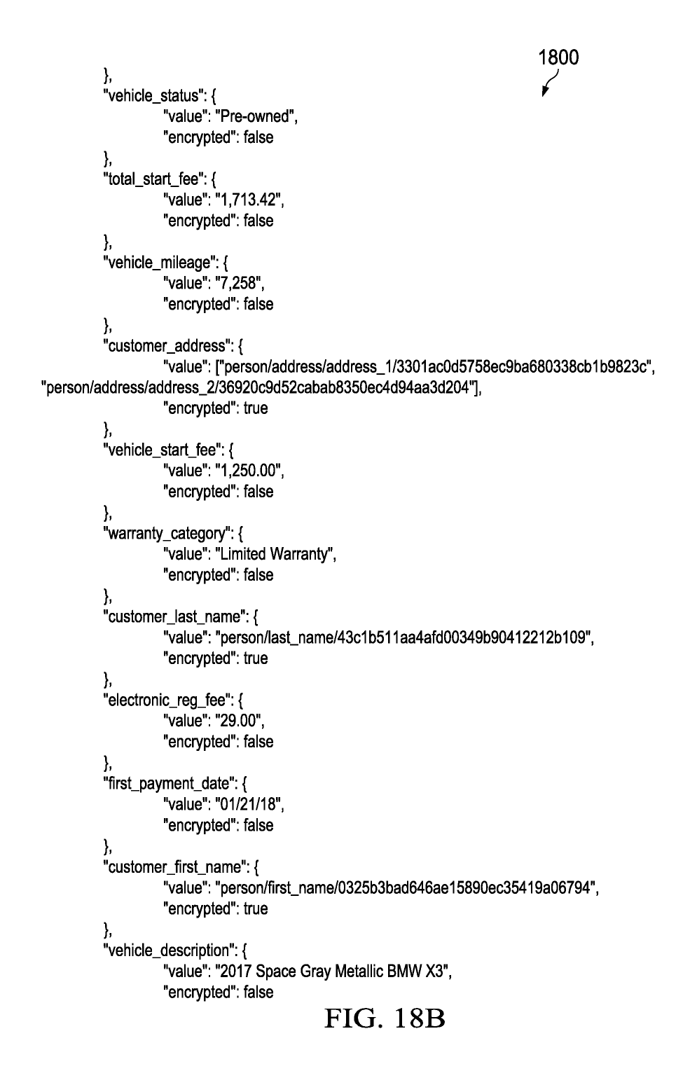

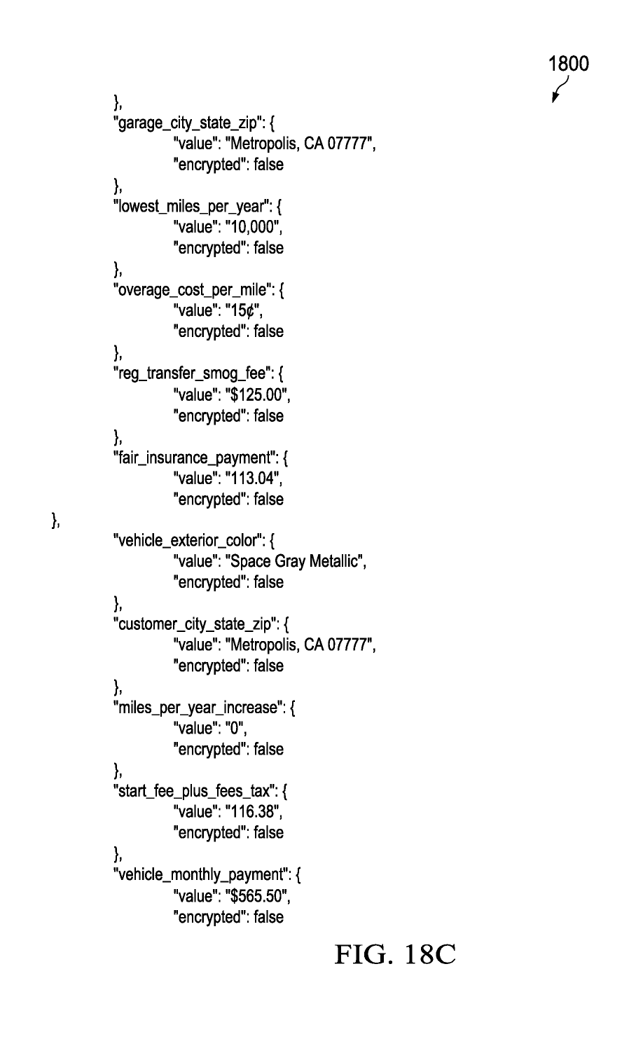

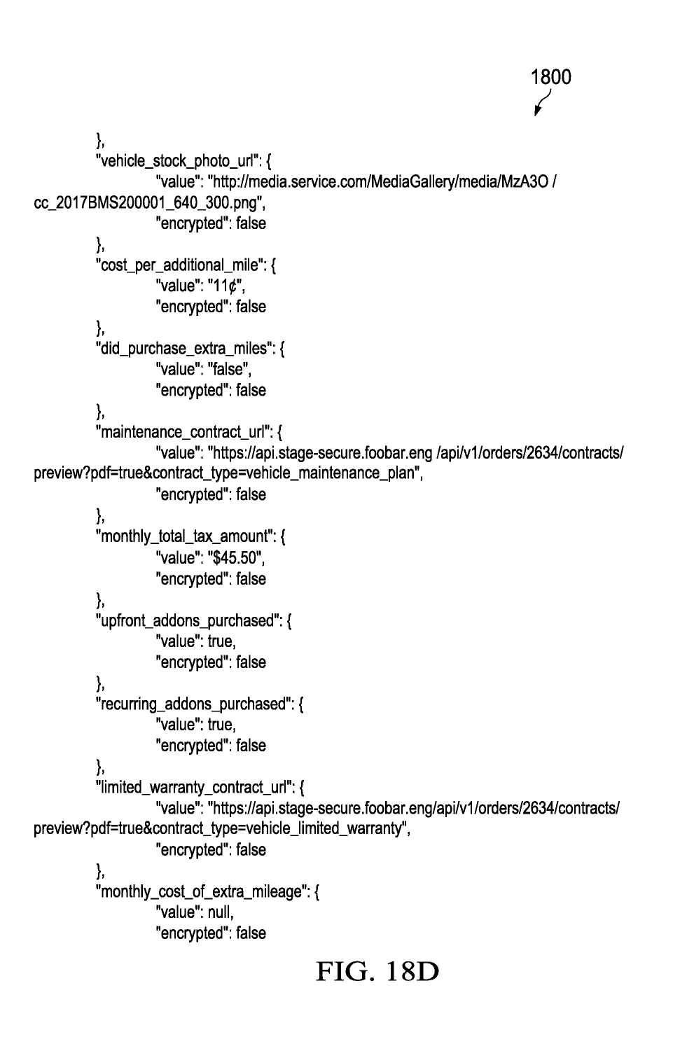

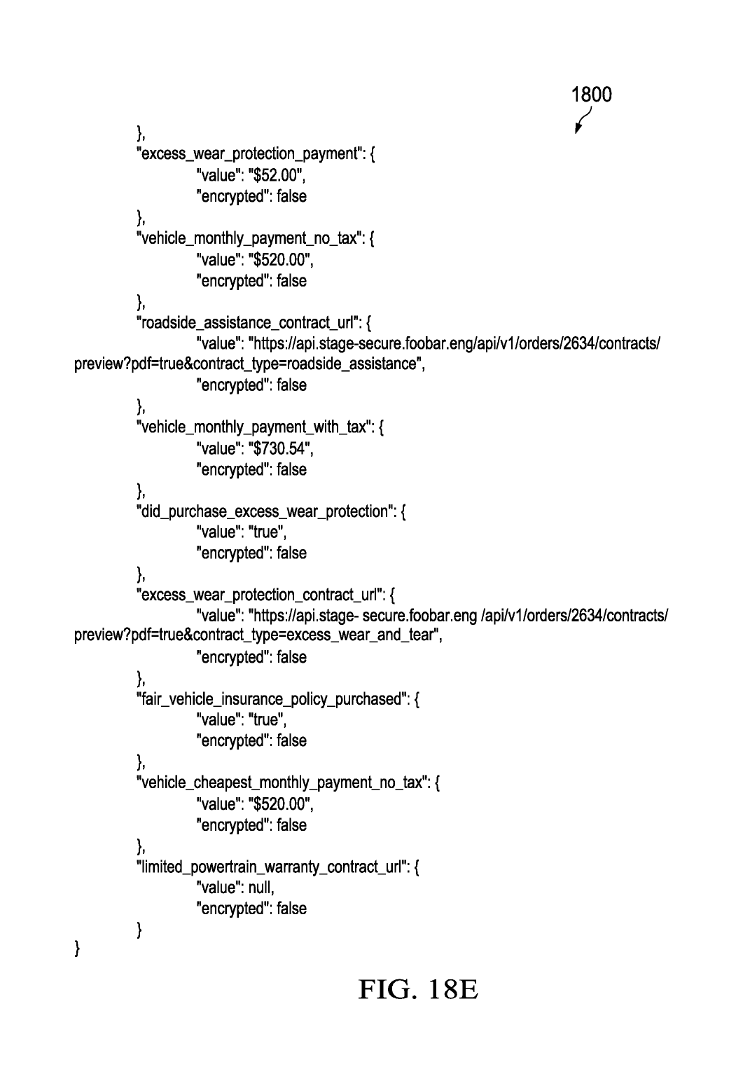

With reference to FIGS. 18A-18E, one embodiment of a structured JSON document 1800 with example values that can be sent from an order service 220 to a document service is illustrated. Note that the document of FIGS. 18A-18E represents a complete order. For a preview, a number of fields may be null, such as the doc. fee and other order data entered by the dealer and fields corresponding to selections not yet made by the user. The attributes and values included in document 1800 are provided by way of example only.

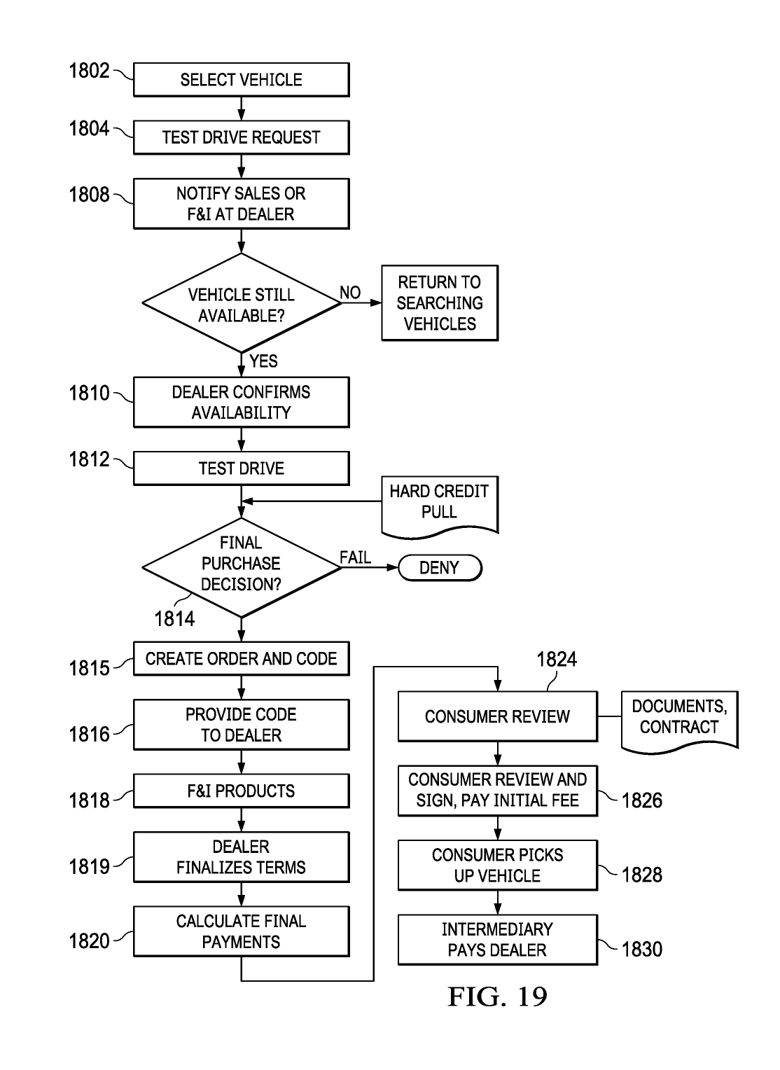

With reference to FIG. 19, FIG. 19 illustrates another embodiment of a method for a purchase process that may be implemented via a data system, such as a vehicle data system 100. A user may search eligible vehicles and select an eligible vehicle of interest (step 1802) as discussed above. When the consumer identifies a vehicle of interest, he or she may request a test drive (step 1804) through client application 114. Vehicle data system 100 can send a test drive notification to the dealer associated with the vehicle of interest (step 1808). However, since inventory processing may occur as a batch process on a periodic basis (e.g., nightly), there is some chance that the vehicle selected by the consumer is no longer available. Accordingly, in response to being notified of a test drive request (or otherwise being notified of interest in a vehicle), the dealer can respond to vehicle data system 100 (e.g., via the dealer portal) or to the consumer to notify vehicle data system 100 or consumer whether the vehicle is still available. If the vehicle is not available, vehicle data system 100 can notify the consumer through client application 114 and the consumer can continue search for another vehicle of interest. If, on the other hand, the dealer confirms availability (step 1810), the consumer can schedule a test drive through vehicle data system 100 (step 1812) or with the dealer by another channel.

If the consumer is satisfied with the vehicle after the test drive (or without a test drive) the consumer or dealer can notify vehicle data system 100 of purchase decision. Responsive to a signal to finalize an a decision based on user interaction in a GUI of client application 114 or dealer interaction in a dealer system, automotive data processing system 100 can make a final approval decision (step 1814). In some embodiments, vehicle data system 100 may apply rules/models to the hard credit report data for the consumer to make a make a final credit determination before the consumer and dealer finalize a transaction. Making the final approval decision may include re-running a pre-approval decision.

If the user fails the final decision, the purchase may be denied. If the final decision is passed, the purchase can proceed and vehicle data system 100 can create an “order” to capture the information about the transaction from the current context (e.g., vehicle information, financing information, consumer information or other information in the order profile for the user)(step 1815). An activation code may also be generated and associated with the order.

Vehicle data system 100 may provide a number of mechanisms to provide a dealer with access to data specific to the transaction. According to one embodiment, vehicle data system may assign an activation code to the consumer where the activation code is associated with the consumer's profile at vehicle data system 100. The activation code may comprise a QR code, barcode, numeric code, URL or other code that can be used to uniquely identify the transaction. The dealer can be provided with the activation code (step 1816).

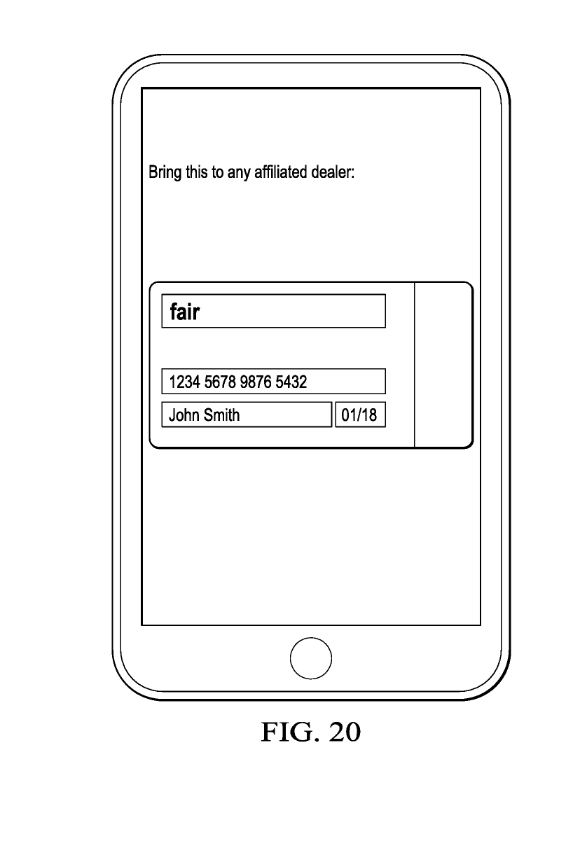

The activation code may be provided to the consumer and the consumer can show the activation code to the dealer so that the dealer can enter the activation code through the dealer portal to access information associated with the transaction. According to one embodiment, the activation code may be implemented as a virtual card that can be added to a mobile wallet of a mobile device. When the consumer arrives at the dealer, the consumer may present the virtual card to pay for the vehicle and any add-ons selected (up to the approved financing amount). FIG. 20, for example, illustrates an example embodiment of an application page in a client application 114 displaying a virtual card with an activation code.

In addition or in the alternative, vehicle data system 100 may send the activation code or other information directly to the dealer (e.g., via email, making the activation code available in a notification at the dealer portal or otherwise providing the activation code to the dealer) such that the dealer can use the activation code in the dealer portal to access information needed to complete the transaction. For example, in one embodiment, vehicle data system 100 can push the activation code, vehicle identification information and identification information for a consumer to the dealer when vehicle data system 100 notifies the dealer of a test drive request. Vehicle data system 100 may provide information, such as the photo of the consumer's driver's license or other PII, so that the dealer can confirm that the consumer present to test drive or purchase the vehicle is in fact the consumer registered with vehicle data system 100.

In response to an activation code signal from the dealer portal indicating that the dealer has input or selected the activation code, vehicle data system 100 may push information associated with the transaction to the dealer portal. Such information may include, for example, information about the consumer, information about the vehicle, documents, or information for display in an order review interface. In one embodiment, the dealer may be provided with information about the consumer such as the maximum or suggested approved monthly payment, maximum approved financing amount, PII or other information used to complete a transaction.

In some embodiments, a vehicle selected by the consumer is associated with the activation code or the consumer's profile such that, when the dealer enters or selects the activation code, the dealer can be provided with information regarding the vehicle. In another embodiment, the dealer may enter or select the activation code and enter the VIN number or other information associated with the transaction through the dealer portal.

Based on the VIN number and consumer associated with the activation code, vehicle data system 100 may present vehicle information and options to the dealer through the dealer portal to allow the dealer to select add-ons (discussed below).

Vehicle data system 100 may provide a notification to the consumer through client application 114 that the dealer has entered the activation code. Vehicle data system 100 may also push information associated with the transaction to client application 114, such as information about the vehicle, add-ons, price and other information.

Various F&I products may be purchased with a vehicle. As discussed above, for example, it may be desirable to include a maintenance contract or warranty with each vehicle. In some embodiments, the cost of the maintenance contract, warranty or other items may be included in the monthly payment for the vehicle. Whether included in the monthly payment or provided as an add-on option, any contracts that are sold with the vehicle may be limited to contracts that are month-to-month, rather than fixed term. As such the consumer will not be stuck with, for example, a fixed term maintenance contract even if he or she wishes to return a vehicle early.

In another embodiment, the dealer may be given the option through the dealer portal to sell the consumer additional approved products, such as warranties/maintenance contracts (e.g., if not already included in the vehicle payment structure), wheel and tire protection, extended mileage, options and other products (step 1818). In some embodiments, vehicle data system 100 may limit the products that a dealer can add to a purchase to a set of curated products that the intermediary has approved for sale.

Vehicle data system 100 may limit the products that the dealer can add, or that a consumer can select, for the vehicle purchase based on the consumer's maximum or suggested affordability score. For example, if vehicle data system determines that a consumer has a maximum affordable payment of $400 a month and the consumer has selected a vehicle with a payment of $300 a month, vehicle data system 100 can limit the dealer to selling a product or combination of products such that the total monthly payment is <=$400. In addition or in the alternative, vehicle data system 100 may limit the additional products that can be added to the purchase such that the vehicle payment makes up at least a minimum percentage of the monthly payment. In some cases, the dealer may be shown in the dealer portal the affordability scores for the consumer so that dealer can best select additional products to offer to the consumer.

Client application 114, in some embodiments, may be connected to the dealer portal through, for example, API services provided by vehicle data system 100. As add-ons are selected/rejected by the dealer or consumer, vehicle data system 100 can push information to the dealer portal and client application to update the dealer portal and client application 114 interface to reflect the current state of the transaction (e.g., to show selected vehicle and add-ons and current price/payment schedule based on selected vehicle and add-ons).

Vehicle data system 100 may automatically populate documents to account for the F&I products selected by the user or added by the dealer.

When the terms of purchase are finalized (vehicle selected, additional products added), the dealer can indicate that the deal is finalized via the dealer portal (step 1819). The vehicle data system 100 can calculate the final initial or monthly payments (step 1820), populate a final copy of the ownership agreement and other documents and present the ownership agreement and other documents required for the purchase to the consumer through the client application (step 1824).

The user may be given the option of approving the transaction on his or her mobile device. If the consumer is satisfied, final documents can be pushed to application 114 and the consumer can execute the ownership agreement and other documents on his or her mobile device (step 1826). In some cases, all the documents may be executed digitally. Thus, the entire purchasing experience, in some embodiments, may be done digitally without pen and paper. Documents that require a wet signature, if any, can be printed by the dealer for signature by the consumer. In most cases there should be no documents that require a wet signature by the consumer, as the intermediary can sign any DMV forms that require wet signature, and the dealer may be able to sign on the intermediary's behalf through a Power of Attorney. The consumer may also cancel the transaction directly from his or her mobile device.

Upon acceptance by the consumer, vehicle data system can withdraw the initial fee from the consumer's bank account. The consumer can pick up the vehicle (step 1828) and the data processing system can initiate transfer of funds from the intermediary's bank to the dealer's bank to provide the funds to the dealer to pay for the vehicle (e.g., via electronic transfer) (step 1830).

Thus, from the consumer's perspective, one embodiment of purchase process can include: 1. Customer downloads app; 2. Customer scans driver's license and confirms info; 3. Customer is fully-approved with no credit impact; 4. Customer picks car on which they are pre-qualified and requests test drive; 5. Dealer confirms vehicle availability; 6. Customer visits and test drives cars; 7. Salesperson enters activation code into dealer portal on their phone or computer to confirm vehicle and deal information and their commitment to sell; 8. Customer picks all desired add-ons; 9. Customer signs all forms in app; 10. Dealer countersigns all forms in portal; 11. Intermediary fully executes all forms electronically; 12. Customer drives off.

Embodiments described herein not only overcome the deficiencies of prior computer systems, but also facilitate “micro-ownership.” With micro-ownership, the consumer may pay an initial, larger fee, and lower fixed monthly payments. Under an ownership agreement, the consumer may make monthly payments, but unlike with a lease, the consumer has the flexibility to return the vehicle when he or she no longer wishes to pay for the vehicle. Since a consumer can return the vehicle at any time, micro-ownership can eliminate default. And, unlike rental contracts that have terms typically limited to 30 days, the ownership agreement does not have to be renewed continually.

The computer system facilitates this type of ownership through the application of rules/models to inventory items to select inventory items that are priced close to their wholesale values at the start of the agreement and determine payments for the inventory items that meet particular metrics (e.g., an ROA hurdle or other metric) so that the ownership agreement can be viable for an intermediary providing financing without requiring a fixed term.

The payments for a vehicle may be based on residual value models which incorporate assumptions regarding miles per year and vehicle condition. As such, the ownership agreement may require the consumer to maintain the vehicle, maintain insurance on the vehicle or take other actions so that the vehicle should not depreciate more rapidly than predicted when the initial and monthly payments were determined. The consumer may also have the option of purchasing additional miles-per-year at the time of sale. Within certain limits, though, the consumer may return a purchased vehicle without further obligation.

In some embodiments, depreciation curves are only determined for a single mileage band (e.g., 10,000 mi/year). Moreover, the residual value rules/models used to determine payments on the vehicle may be based on this mileage band (e.g., 10,000 mi/year). A user who drives more than that can be given the option (by the dealer or through the application) to purchase an additional mileage allowance. The cost of additional mileage may vary by vehicle based on the associated depreciation models. In some embodiments, the ownership agreement may provide for a refund of all or a portion of unused additional mileage at cost. In addition, even if depreciation curves are determined for multiple mileage bands and the user can select a band, the user may be able to purchase excess mileage if he or she believes she will exceed the mileage band that the user selected.

In one embodiment, the additional mileage allowance can be prorated and if all of the prorated additional mileage allowance is not used, the consumer can be refunded for any unused miles down to the original, default mileage in the system. For example, if the base mileage is 10,000 mi/year, the consumer purchases an additional 5,000 mi/year and customer then returns the car and ends the contract after 6 months and after having driven only 4,000 mi., the consumer can be refunded for the pro-rated mileage allotment. For example, the customer can be refunded for 2,500 mi., e.g.,
10,000 default mi+5,000 purchased mi=15,000 mi/year
Years driven=6 mo/12 mo=½ year
Miles allowed=½*15,000=7,500 mi
Miles driven=4,000 mi
Excess Miles Bought=7,500−4,000=3,500 mi
Max Refund: Miles bought−Base Miles=7,500−5,000=2,500 mi
Refund: Lesser of Excess Miles Bought and Max Refund=2,500 mi

In any event, the ownership agreement may provide for additional payments at vehicle return if the vehicle is returned with excessive mileage, excessive wear and tear, evidence of accidents, etc. Therefore, further obligations may exist when the consumer returns the vehicle if the vehicle has excessive mileage or wear and tear or exhibits evidence of an accident.

According to some embodiments, the vehicle initial payment and monthly payment (plus mileage allowance) are selected to allow the consumer to return the vehicle at any time, within limits and with sufficient notice, without further obligation. The ownership agreement may include terms, for example, that require minimum maintenance and repairs, etc. such that owner may have some remaining obligation if the vehicle is returned in poor condition. Furthermore, the owner may have to pay for mileage that goes beyond a base mileage (e.g., 10,000 mi/year), extended mileage allowance purchased by the owner or mileage band selected by the consumer.

When the owner decides to return a vehicle, the owner will bring the vehicle back to the selling dealer, or to another location mutually agreed upon with the intermediary. Prior to return, the intermediary may send a mobile inspector to meet the owner at a location convenient to the owner where the vehicle can be inspected to have wear and tear or damage assessed. As long as there is not excessive mileage, wear and tear, damage, etc., the consumer can walk away from the vehicle.

An ownership agreement may thus specify a start payment with tax and fees and a monthly payment with tax. The ownership agreement may include a variety of clauses, including, but not limited to:
A mileage clause by which the consumer agrees to pay for excess mileage over the base mileage or mileage band selected by the user.
Insurance clause requiring the user to maintain insurance on the vehicle.
Wear and tear clause so that the consumer is responsible for all excess wear charges on the purchased vehicle, subject to any wear and tear protection the consumer purchased.
Maximum payment term setting a term at which the consumer no longer has to make monthly payments (e.g., six years, seven years) or other term.
Notice period requiring that the consumer provide a minimum notice that the user is ending the agreement and returning the vehicle to a dealer (e.g., requiring five days' notice or other notice) that consumer is terminating the agreement.
Limited use clause limiting the use of the vehicle. For example, the owner agreement may have a clause that the vehicle can only be used for personal, family or household use. As another example, the agreement may limit use to on-road or well-maintained surfaces. The agreement may also prohibit sub-leasing the vehicle.
Payments clause regarding the consumer's obligation to pay for the vehicle and any optional products selected in the purchase process. The agreement may also include clauses regarding late payment, payment of excessive wear and tear and other payments for which the consumer may be obligated.
Vehicle return clause governing the proper procedure to return the vehicle.
Maintenance clause requiring the consumer to properly maintain the vehicle. The agreement may further include clauses that require the consumer to maintain proof of maintenance (receipts etc.) and produce the proof at the request of the intermediary.
Limitations on the accessories or modifications that the consumer can make to the vehicle and limitations on removing accessories and modifications once made. For example the agreement may allow for approved accessories such as window tinting, roof racks and cargo carriers, security systems, bed liners, tow hitches and accessories that match standard manufacturer specifications, but prohibit other accessories or modifications.
Insurance clause requiring that the consumer maintain a minimum level of insurance, such as full coverage policy, and that the consumer produce proof of insurance on request.
Clauses regarding responsibility for tax, title and registration including for example specifying the party holding the title and the party to which the vehicle will be registered. In one embodiment, the vehicle may be registered to the consumer while the intermediary holds title.
Clauses apportioning risk of vehicle loss due to theft, government seizure, natural disaster or other events.
Cancellation period clause setting a period in which the user can return the vehicle and receive a refund.

A template may hold all the clauses for an ownership agreement. The data processing system can generate an ownership agreement from the template, populating fields specific to a purchase with order data to generate a preview of an ownership agreement or final ownership agreement in real time.

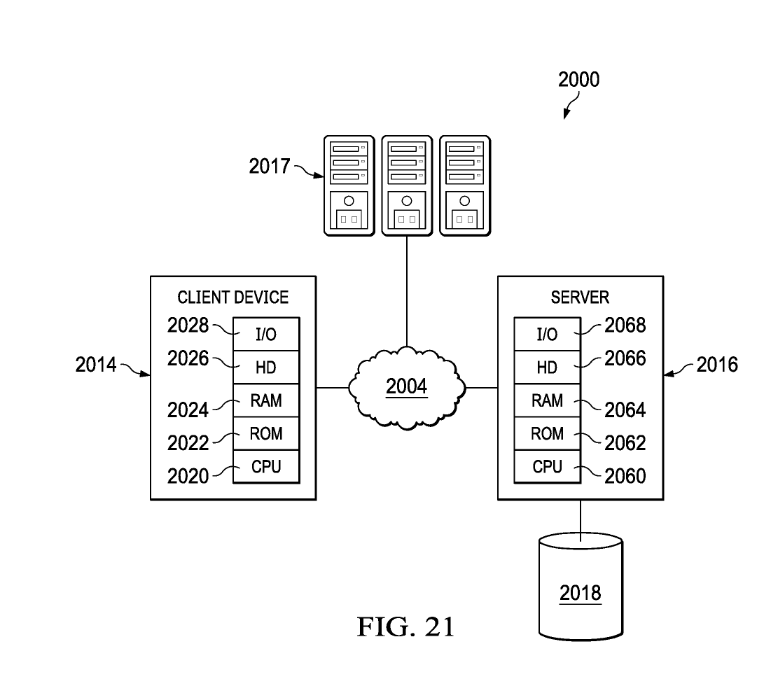

FIG. 21 depicts a diagrammatic representation of a distributed network computing environment where embodiments disclosed can be implemented. In the example illustrated, network computing environment 2000 includes network 2004 that can be bi-directionally coupled to a client computing device 2014, a server system 2016 and one or more third party system 2017. Server system 2016 can be bi-directionally coupled to data store 2018. Network 2004 may represent a combination of wired and wireless networks that network computing environment 2000 may utilize for various types of network communications known to those skilled in the art.

For the purpose of illustration, a single system is shown for each of client computing device 2014 and server system 2016. However, a plurality of computers may be interconnected to each other over network 2004. For example, a plurality client computing devices 2014 and server systems 2016 may be coupled to network 2004.

Client computer device 2014 can include central processing unit (“CPU”) 2020, read-only memory (“ROM”) 2022, random access memory (“RAM”) 2024, hard drive (“HD”) or storage memory 2026, and input/output device(s) (“I/O”) 2028. I/O 2028 can include a keyboard, monitor, printer, electronic pointing device (e.g., mouse, trackball, stylus, etc.), or the like. In one embodiment I/O 2028 comprises a touch screen interface and a virtual keyboard. Client computer device 2014 may implement software instructions to provide a client application configured to communicate with an automotive data processing system. Likewise, server system 2016 may include CPU 2060, ROM 2062, RAM 2064, HD 2066, and I/O 2068. Server system 2016 may implement software instructions to implement a variety of services for an automotive data processing system. These services may utilize data stored in data store 2018 and obtain data from third party systems 2017. Many other alternative configurations are possible and known to skilled artisans.

Each of the computers in FIG. 21 may have more than one CPU, ROM, RAM, HD, I/O, or other hardware components. For the sake of brevity, each computer is illustrated as having one of each of the hardware components, even if more than one is used. Each of computers 2014 and 2016 is an example of a data processing system. ROM 2022 and 2062; RAM 2024 and 2064; HD 2026, and 2066; and data store 2018 can include media that can be read by CPU 2020 or 2060. Therefore, these types of memories include non-transitory computer-readable storage media. These memories may be internal or external to computers 2014 or 2016.

Portions of the methods described herein may be implemented in suitable software code that may reside within ROM 2022 or 2062; RAM 2024 or 2064; or HD 2026 or 2066. The instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A networked system comprising:
a server computer coupled to a network, the server computer comprising a processor and set of computer instructions stored on a non-transitory computer readable medium, the server computer coupled to a data store storing a set of approval rules, a set of application programming interfaces (APIs) specifically configured for a set of remote information provider systems and a set of vehicle inventory records for a plurality of vehicles, each vehicle inventory record comprising a pre-calculated payment schedule associated with a corresponding vehicle from the plurality of vehicles, the set of computer instructions executable to:
based on an enhanced set of personally identifiable information about a user included in user application data received from a mobile application, retrieve information provider data from a the set of information provider systems using the APIs;
based on the user application data, information provider data and approval rules, determine an affordability score representative of periodic payments for which the user is approved;
determine eligible vehicles for the user, the eligible vehicles having a payment schedule with periodic payments that are less than the affordability score, and return a list of eligible vehicles to the mobile application;
receive, from the mobile application, an indication of a purchase decision with respect to a selected vehicle from the eligible vehicles;
provide, via a dealer portal for a dealer associated with the selected vehicle in the vehicle inventory record for the selected vehicle, access an order corresponding to the purchase decision, the order comprising vehicle information for the selected vehicle and consumer information, the dealer portal configured to allow the dealer to update order data;
automatically generate an electronic document for electronic execution, the electronic document comprising the updated order data, and send the electronic document to the mobile application;
receive an electronic signature from the mobile application;
based on receiving the electronic signature from the mobile application, initiating an electronic transfer of funds;
a mobile device comprising the mobile application, the mobile application executable to:
provide a low friction user interface to allow a user to input an image of an identification document and a limited set of personally identifiable information and financial information;
enhance the limited set of personally identifiable information with personally identifiable information extracted from the image of the identification document to create an enhanced set of personally identifiable information;
send the enhanced set of personally identifiable information and financial information and request approval of a user application comprising the user application data.

2. The system of claim 1, wherein the set of computer instructions are further executable to:
based on the request to approve the user application, access the approval rules, determine the information provider data to which the approval rules apply and a subset of the information provider data to retrieve from each of the set of information provider systems; and
for each of the set of information data provider systems, request the corresponding subset of information provider data determined for that information data provider system using the API specifically configured for that information data provider system and based on the user application data received from the mobile application.

3. The system of claim 1, wherein the approval rules are organized in a decision tree that defines the corresponding subset of information provider data required at each level of the decision tree and the set of computer instructions are executable to walk the tree and determine the information provider data.

4. They system of claim 4, wherein the set of computer instructions are executable to wait until executing the approval rules corresponding to a level of the tree to request the corresponding subset of information provider data specified for the approval rules for that level of the tree.

5. The system of claim 1, wherein the approval rules comprise an identity verification check and the information provider data comprises identity verification data retrieved from an identity verification service, the identify verification data indicating if one or more pieces personally identifiable information from the enhanced set of personally identifiable information appears in at least one name or address database.

6. The system of claim 1, wherein the approval rules comprise a credit check and the information provider data comprises a credit report.

7. The system of claim 1, wherein the mobile application is further executable to:
interface with a remote identification verification service to send the image of the identification document to the remote identification services and receive the personally identifiable information extracted from the image of the identification document;
map the personally identifiable information extracted from the image of the identification document to editable fields in the user interface to allow the user to edit the personally identifiable information extracted from the image of the identification document,
receive edited personally identifiable information input in a field of the editable fields, wherein the limited set of personally identifiable information is enhanced with the edited personally identifiable information.

8. The system of claim 1, wherein the affordability score is not dependent on a vehicle value.

9. The system of claim 1, wherein data store further stores a plurality of depreciation curves, each depreciation curve corresponding to a year/make/model/trim of vehicle and the set of computer instructions are further executable to:
receive a first set of inventory feed records, each inventory feed record in the first set of inventory feed records comprising a vehicle identification number (VIN), dealer price and mileage;
filter the first set of inventory feed records to a second set of inventory feed records corresponding to vehicles having year/make/model/trim for which a depreciation curve is stored in the data store;
for each vehicle in the second set of inventory feed records:
determine a corresponding depreciation curve from the plurality of depreciation curves based on the year/make/model/trim of the vehicle;
determine a current value of the vehicle;
determine a residual value of the vehicle at each of a plurality of terms by applying the corresponding depreciation curve to the current value;
calculate a payment schedule for the vehicle based on the residual values of the vehicle and a unit economics model;
store the payment schedule as the pre-calculated payment schedule for the vehicle in an inventory record for the vehicle.

10. The system of claim 9, wherein calculating the payment schedule for a vehicle comprises calculating a payment schedule for each of a plurality of mileage bands and for a plurality of credit risk bands.

11. The system of claim 10, wherein calculating the payment schedule for each of a plurality of mileage bands and for a plurality of credit risk bands comprises calculating the payment schedule so that a plurality of ROA hurdles are met.

12. The system of claim 9, wherein the server computer further comprises:
a machine learning regression model having independent variables representing features of vehicles and having a dependent variable that indicates an expected value of a vehicle, wherein the set of computer instructions are executable use the regression model to determine the depreciation curves.

13. The system of claim 1, wherein the electronic document comprises a micro-ownership agreement with no fixed term.

14. A computer program product comprising a non-transitory computer readable medium storing a set of computer instructions executable to perform a computer-implemented method comprising:
based on an enhanced set of personally identifiable information about a user included in user application data received at a server computer from a mobile application, accessing approval rules, determining information provider data from a the set of information provider systems to retrieve to apply the approval rules, and obtaining by the server computer the information provider data using a set of APIs, the set of APIs comprising an API specific to each information provider system in the set of information provider systems;
based on the user application data, information provider data and approval rules, determining by the server computer an affordability score representative of periodic payments for which the user is approved;
accessing, by the server computer, a set of vehicle inventory records for a plurality of vehicles, each vehicle inventory record comprising a pre-calculated payment schedule associated with a corresponding vehicle from the plurality of vehicles;
determining, by the server computer, eligible vehicles for the user, the eligible vehicles having a payment schedule with periodic payments that are less than the affordability score, and returning a list of eligible vehicles to the mobile application;
receiving, at the server computer, from the mobile application, an indication of a purchase decision with respect to a selected vehicle from the eligible vehicles;
providing, via a dealer portal for a dealer associated with the selected vehicle in the vehicle inventory record for the selected vehicle, access an order corresponding to the purchase decision, the order comprising vehicle information for the selected vehicle and consumer information, the dealer portal configured to allow the dealer to update order data;
automatically generating an electronic document at the server computer for electronic execution at the mobile application, the electronic document comprising the updated order data, and sending the electronic document to the mobile application;
receiving an electronic signature for the electronic document from the mobile application;
based on receiving the electronic signature from the mobile application, initiating an electronic transfer of funds;
providing by a mobile application at a mobile device, a low friction user interface to allow a user to input an image of an identification document and a limited set of personally identifiable information and financial information;
enhancing the limited set of personally identifiable information with personally identifiable information extracted from the image of the identification document to create an enhanced set of personally identifiable information;
sending the enhanced set of personally identifiable information and financial information to the server computer and requesting approval of a user application comprising the user application data.

15. The computer program product of claim 14, wherein the set of computer instructions are further executable to perform, at the server computer:
based on the request to approve a user application, accessing the approval rules, determining the information provider data to which the approval rules apply and a subset of the information provider data to retrieve from each of the set of information provider systems; and
for each of the set of information data provider systems, request the corresponding subset of information provider data determined for that information data provider system using the API specifically configured for that information data provider system and based on the user application data received from the mobile application.

16. The computer program product of claim 14, wherein the approval rules are organized in a decision tree that defines the corresponding subset of information provider data required at each level of the decision tree and the set of computer instructions are executable to perform, at the server computer, walking the tree and determine the information provider data.

17. They computer program product of claim 16, wherein the set of computer instructions are executable to perform: waiting until executing the approval rules corresponding to a level of the tree to request the corresponding subset of information provider data specified for the approval rules for that level of the tree.

18. The computer program product of claim 14, wherein the approval rules comprise an identity verification check and the information provider data comprises identity verification data retrieved from an identity verification service, the identify verification data indicating if one or more pieces personally identifiable information from the enhanced set of personally identifiable information appears in at least one name or address database.

19. The computer program product of claim 14, wherein the approval rules comprise a credit check and the information provider data comprises a credit report.

20. The computer program product of claim 14, wherein the computer-implemented method further comprises:
the mobile application interfacing with a remote identification verification service to send the image of the identification document to the remote identification services and receive the personally identifiable information extracted from the image of the identification document;
mapping the personally identifiable information extracted from the image of the identification document to editable fields in the user interface of the mobile application to allow the user to edit the personally identifiable information extracted from the image of the identification document;
receiving edited personally identifiable information input in a field of the editable fields, wherein the limited set of personally identifiable information is enhanced with the edited personally identifiable information.

21. The computer program product of claim 14, wherein the affordability score is not dependent on a vehicle value.

22. The computer program product of claim 14, wherein the computer-implemented method further comprises the server computer:
storing a plurality of depreciation curves, each depreciation curve corresponding to a year/make/model/trim of vehicle;
receiving a first set of inventory feed records, each inventory feed record in the first set of inventory feed records comprising a vehicle identification number (VIN), dealer price and mileage;
filtering the first set of inventory feed records to a second set of inventory feed records corresponding to vehicles having year/make/model/trim for which a depreciation curve is stored in the data store;
for each vehicle in the second set of inventory feed records:
determining a corresponding depreciation curve from the plurality of depreciation curves based on the year/make/model/trim of the vehicle;
determining a current value of the vehicle;
determining a residual value of the vehicle at each of a plurality of terms by applying the corresponding depreciation curve to the current value;
calculating a payment schedule for the vehicle based on the residual values of the vehicle and a unit economics model;
storing the payment schedule as the pre-calculated payment schedule for the vehicle in an inventory record for the vehicle.

23. The computer program product of claim 13, wherein calculating the payment schedule for a vehicle comprises calculating a payment schedule for each of a plurality of mileage bands and for a plurality of credit risk bands.

24. The computer program product of claim 23, wherein calculating the payment schedule for each of a plurality of mileage bands and for a plurality of credit risk bands comprises calculating the payment schedule so that a plurality of ROA hurdles are met.

25. The computer program product of claim 14, wherein the computer-implemented method further comprises:
the server computer maintaining a machine learning regression model having independent variables representing features of vehicles and having a dependent variable that indicates an expected value of a vehicle and determining the depreciation curves using the machine learning regression model.

26. The computer program product of claim 14, wherein the electronic document comprises a micro-ownership agreement with no fixed term.
